(19) United States
(12) Patent Application Publication
(10) Pub. No.: US 2026/0367251 A1
(43) Pub. Date: Nov. 19, 2026

(54) PERCEPTION SYSTEM, PERCEPTION METHOD, AND PERCEPTION APPARATUS

(71) Applicant: Sony Semiconductor Solutions Corporation, Kanagawa (JP)

(72) Inventors: Kazutoshi KITANO, Kanagawa (JP); Kousuke TAKAHASHI, Kanagawa (JP); Yuusuke KAWAMURA, Kanagawa (JP)

(73) Assignee: Sony Semiconductor Solutions Corporation, Kanagawa (JP)

(21) Appl. No.: 18/997,517

(22) PCT Filed: Jul. 21, 2023
(86) PCT No.: PCT/JP2023/026751

§ 371 Date: Jan. 22, 2025

(30) Foreign Application Priority Data
Jul. 29, 2022 (JP) 2022-122137

(51) Int. Cl. G01S 17/86; G01S 17/58; G01S 17/89

(52) U.S. Cl. CPC G01S 17/86; G01S 17/58; G01S 17/89

(57) ABSTRACT

A perception system according to an embodiment includes: a sensor unit; a reception unit; and an output unit. The sensor unit includes a first sensor and a second sensor, the first sensor configured to output velocity point cloud data including a plurality of points, each point having velocity information and time-point information, the second sensor configured to output inertial measurement data. The reception unit receives the velocity point cloud data and the inertial measurement data output from the sensor unit. The output unit outputs sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.

### FIELD

The present disclosure relates to a perception system, a perception method, and a perception apparatus.

### BACKGROUND

In order to achieve autonomous operations of a mobile body such as a robot, it is necessary to simultaneously perform estimation of the self-position and perception of surrounding environment. Therefore, the autonomous operations of the mobile body require an external environment sensor that perceives the surrounding environment and an internal environment sensor that perceives the self-motion.

Typically used internal environment sensors for measuring self-motion include an inertial sensor and a wheel encoder for odometry. In addition, typically used external environment sensors for the perception of the surrounding environment include a Laser Imaging Detection and Ranging (LiDAR) system and a camera. The LiDAR, which is capable of detecting the Doppler velocity, can also be used as a sensor for odometry by performing appropriate data processing. For example, Patent Literatures 1 and 2 disclose a technique of using a Laser Imaging Detection and Ranging (LiDAR) system capable of detecting the Doppler velocity to detect a surrounding environment for self-position estimation.

### CITATION LIST

### Patent Literature

Patent Literature 1: US 2020/0292706 A
Patent Literature 2: US 2020/0400821 A
Patent Literature 3: WO 2019/239566 A

### SUMMARY

### Technical Problem

Meanwhile, there are conditions in which it is difficult to acquire information related to the motion of a mobile body from a surrounding environment acquired by an external environment sensor mounted on the mobile body. For example, the conditions include a case where the surrounding environmental structure is a simple structure in the moving direction, a case where features in the environmental structure included in the field of view of the sensor is insufficient (degeneracy condition), or a case where a large number of moving objects exist around the mobile body.

Under such conditions of the surrounding environment, it is difficult to detect and perceive the self and the plurality of surrounding mobile bodies with high precision using an external environment sensor such as a LiDAR or a camera mounted on the mobile body so as to grasp the position and orientation of the self and the surrounding moving objects.

An object of the present disclosure is to provide a perception system, a perception method, and a perception apparatus capable of acquiring a self-position and orientation of a mobile body and a surrounding environment with higher precision.

### Solution to Problem

For solving the problem described above, a perception system according to one aspect of the present disclosure has a sensor unit including a first sensor and a second sensor, the first sensor configured to output velocity point cloud data including a plurality of points, each point having velocity information and time-point information, the second sensor configured to output inertial measurement data; a reception unit configured to receive the velocity point cloud data and the inertial measurement data output from the sensor unit; and an output unit configured to output sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.

### BRIEF DESCRIPTION OF DRAWINGS

FIG. 1 is a block diagram schematically illustrating a configuration example of a signal processing system according to an embodiment.

FIG. 2 is a block diagram illustrating a configuration of an example of a perception system according to an existing technology.

FIG. 3 is a block diagram illustrating a configuration of an example of a light detection and ranging sensor according to an existing technology.

FIG. 4 is a block diagram illustrating a configuration of an example of a SLAM processing unit according to an existing technology.

FIG. 5 is a schematic diagram for describing a case where degeneracy or a dynamic environment change occurs in point cloud scan matching according to an existing technology.

FIG. 6 is a schematic diagram illustrating an example of a static environment in which an environment includes no moving object.

FIG. 7A is a schematic diagram illustrating an example of a dynamic environment in which an environment includes one moving object.

FIG. 7B is a schematic diagram illustrating an example of a dynamic environment in which an environment includes a plurality of moving objects.

FIG. 8A is a schematic diagram for illustrating scan matching in a case where an environment includes no moving object according to an existing technology.

FIG. 8B is a schematic diagram for illustrating scan matching in a case where an environment includes a moving object according to an existing technology.

FIG. 9 is a schematic diagram schematically illustrating a velocity measurement technique applicable to a mobile body.

FIG. 10 is a schematic diagram illustrating characteristics of an example of a laser Doppler velocimeter, a Doppler radar, an IMU, a wheel sensor, an optical flow sensor, and an FMCW-LiDAR sensor.

FIG. 11 is a block diagram illustrating a basic configuration example of a perception system according to each embodiment of the present disclosure.

FIG. 12 is a block diagram illustrating a configuration of an example of a light detection and ranging sensor according to each embodiment.

FIG. 13 is a schematic diagram schematically illustrating an example of a scan pattern of a transmission light signal according to the embodiment.

FIG. 14A is a schematic diagram schematically illustrating another example of the scan pattern of the transmission light signal.

FIG. 14B is a schematic diagram schematically illustrating still another example of the scan pattern of the transmission light signal.

FIG. 15 is a schematic diagram for describing a case where degeneracy or a dynamic environment change occurs in point cloud scan matching according to each embodiment.

FIG. 16A is a schematic diagram illustrating an example in which a self moves and an environment includes a plurality of moving objects according to the embodiment.

FIG. 16B is a schematic diagram for illustrating motion estimation of a moving object according to the embodiment.

FIG. 17 is a block diagram illustrating a configuration of an example of a perception system according to a first embodiment.

FIG. 18 is a schematic diagram schematically illustrating velocity point cloud correction processing according to the embodiment.

FIG. 19A is a block diagram illustrating a hardware configuration of an example of a perception system applicable to the first embodiment.

FIG. 19B is a schematic diagram illustrating an example in which Ethernet is applied as an interface related to data transmission between units, applicable to the first embodiment.

FIG. 20 is a diagram illustrating an example of an architecture of a signal processing unit according to the first embodiment.

FIG. 21 is a flowchart of an example illustrating transmission light signal detection processing in the light detection and ranging sensor, applicable to the first embodiment.

FIG. 22 is a schematic diagram for illustrating a transmission light signal transmitted by a light transmission/reception unit, applicable to the first embodiment.

FIG. 23 is a schematic diagram for illustrating determination processing on a reception light signal according to the first embodiment.

FIG. 24 is a schematic diagram illustrating an example of data output in a case where the light detection and ranging sensor according to the first embodiment performs scanning with a raster scan pattern.

FIG. 25 is a schematic diagram for illustrating a frame definition applicable to the embodiment.

FIG. 26A is a schematic diagram for illustrating an output timing of each data by a sensor unit according to the first embodiment.

FIG. 26B is a schematic diagram for illustrating an output timing of each data by the sensor unit according to the first embodiment.

FIG. 27 is a schematic diagram illustrating an example of an output rate of each data according to the first embodiment.

FIG. 28 is a schematic diagram illustrating an example of a data structure of FMCW-LiDAR data and IMU data output from the sensor unit 10 according to the first embodiment.

FIG. 29 is a flowchart of an example illustrating processing by the signal processing unit according to the first embodiment.

FIG. 30 is a flowchart of an example illustrating processing related to point cloud correction in the signal processing unit according to the first embodiment.

FIG. 31 is a flowchart illustrating an example of correction processing of a velocity point cloud frame of a stationary object in the signal processing unit according to the first embodiment.

FIG. 32 is a schematic diagram illustrating an example of output data by the light detection and ranging sensor according to the first embodiment.

FIG. 33 is a schematic diagram illustrating a definition of coordinates of an emission point, applicable to the first embodiment.

FIG. 34 is a schematic diagram illustrating each emission point and an object as viewed from a light detection and ranging sensor.

FIG. 35 is a schematic diagram illustrating an overall flow of processing related to point cloud correction in the signal processing unit according to the embodiment.

FIG. 36 is a schematic diagram for defining a coordinate system and each variable.

FIG. 37 is a block diagram illustrating a configuration of an example of a perception system according to a first modification of the first embodiment.

FIG. 38 is a block diagram illustrating a configuration of an example of a perception system according to a second modification of the first embodiment.

FIG. 39 is a block diagram illustrating a configuration of an example of a perception system according to a third modification of the first embodiment.

FIG. 40 is a block diagram illustrating a configuration of an example of a perception system according to a second embodiment.

FIG. 41 is a flowchart of an example illustrating processing by the signal processing unit according to the second embodiment.

FIG. 42 is a block diagram illustrating a configuration of an example of a perception system according to a third embodiment.

FIG. 43 is a flowchart of an example illustrating processing by the signal processing unit according to the third embodiment.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Hereinafter, embodiments of the present disclosure will be described in the following order.
1. Outline of technology according to present disclosure
   1-1. Comparison with existing technology
      1-1-1. Configuration example of existing technology
      1-1-2. Outline of processing using existing technology
   1-2. Velocity measurement technique applicable to mobile body
   1-3. Specific examples of technology according to embodiment of present disclosure
      1-3-1. Basic system configuration according to each embodiment of present disclosure
      1-3-2. Outline of processing according to each embodiment of present disclosure
2. First embodiment according to present disclosure
   2-1. Specific example of configuration according to first embodiment
      2-1-1. Signal processing unit
         2-1-1-1. Library section
         2-1-1-2. Application section
      2-1-2. System configuration
   2-2. Processing according to first embodiment
      2-2-1. Measurement technique applicable to first embodiment
      2-2-2. Data structure example according to first embodiment
      2-2-3. Details of processing according to first embodiment
      2-2-4. Point cloud correction processing according to first embodiment
      2-2-5. Effects of first embodiment
   2-3. First modification of first embodiment
   2-4. Second modification of first embodiment
   2-5. Third modification of first embodiment
3. Second embodiment according to present disclosure
4. Third embodiment according to present disclosure

### 1. Outline of Technology According to Present Disclosure

First, the technology according to the present disclosure will be schematically described.

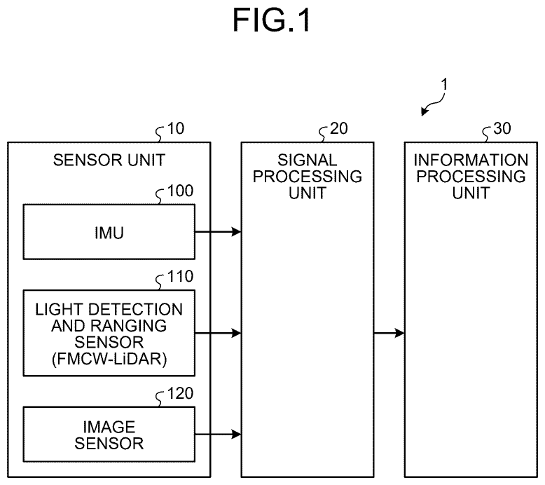

FIG. 1 is a block diagram schematically illustrating a configuration example of a perception system according to an embodiment. In FIG. 1, a perception system 1 includes a sensor unit 10, a signal processing unit 20, and an information processing unit 30.

The sensor unit 10 includes an inertial measurement unit (IMU) 100, a light detection and ranging sensor 110, and an image sensor 120. The IMU 100 includes, for example, a triaxial acceleration sensor, a triaxial angular velocity sensor, and a triaxial geomagnetic sensor, and outputs inertial measurement data (hereinafter, appropriately referred to as IMU data) obtained by these sensors. The light detection and ranging sensor 110 is a sensor that performs ranging using light, and the embodiment employs Frequency Modulated Continuous Wave-Laser Imaging Detection and Ranging (FMCW-LiDAR), a method that performs ranging using frequency modulated continuous laser light. The image sensor 120 is typically a camera, images a subject, and outputs image data including information of red (R), green (G), and blue (B), for example. The image sensor 120 can be omitted.

In FIG. 1, the signal processing unit 20 receives input of data including: IMU data output from the IMU 100 of the sensor unit 10; FMCW-LiDAR data output from the light detection and ranging sensor 110; and image data output from the image sensor 120. The signal processing unit 20 performs signal processing based on the input IMU data, the FMCW-LiDAR data, and the image data. The signal processing unit 20 performs signal processing based on each data and generates, for example, map information, a velocity point cloud of each of a stationary object and a moving object, motion meta-information indicating motion of the moving object, and image meta-information related to an image in a region of interest. The signal processing unit 20 outputs the generated information to the information processing unit 30.

The information processing unit 30 performs predetermined processing in accordance with each piece of information output from the signal processing unit 20. The processing performed by the information processing unit 30 in accordance with each piece of information output from the signal processing unit 20 is not particularly limited. For example, in a case where the perception system 1 is applied to an autonomously operating robot (mobile body), the information processing unit 30 may perform drive control of the robot based on map information or the like. Furthermore, for example, in a case where the perception system 1 is applied to a control system of a monitoring camera, the information processing unit 30 may perform notification or the like based on motion meta-information or image meta-information.

Furthermore, the information processing unit 30 may transmit an instruction related to signal processing to the signal processing unit 20. The signal processing unit 20 may control processing for the output of the sensor unit 10 in accordance with this instruction. In addition, the signal processing unit 20 may control the operations of the sensors (the IMU 100, the light detection and ranging sensor 110, and the image sensor 120 in the sensor unit 10 in accordance with this instruction. Note that the information processing unit 30 may be implemented by applying a configuration as a typical computer including a central processing unit (CPU), memory, a storage device, and the like.

In this manner, the perception system 1 according to the embodiment can output various data based on the measurement result by the FMCW-LiDAR, making it possible to further universally utilize the measurement result of the FMCW-LiDAR.

### 1-1. Comparison with Existing Technology

Here, in order to facilitate understanding, measurement processing according to an existing technology will be schematically described.

### 1-1-1. Configuration Example of Existing Technology

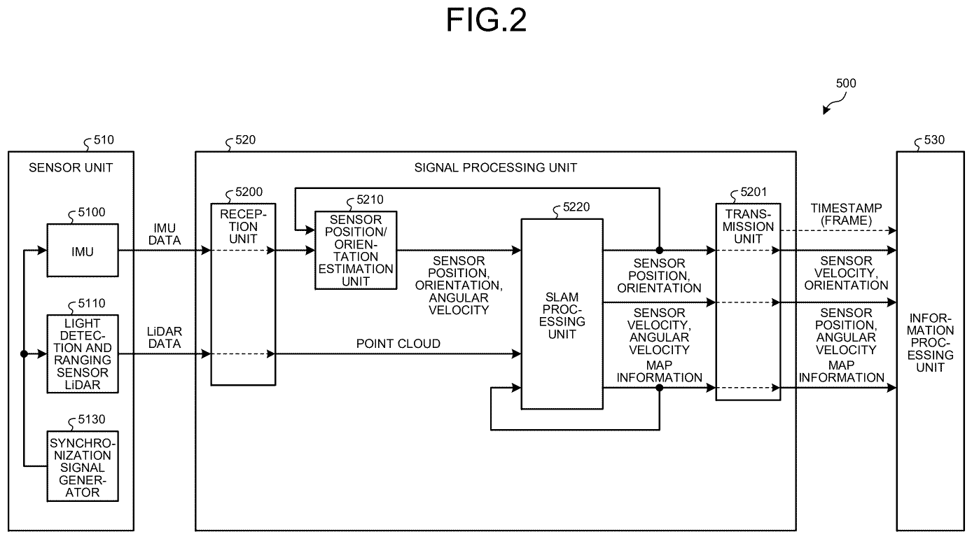

FIG. 2 is a block diagram illustrating a configuration of an example of a perception system according to an existing technology.

In FIG. 2, a perception system 500 includes a sensor unit 510, a signal processing unit 520, and an information processing unit 530. The sensor unit 510, the signal processing unit 520, and the information processing unit 530 each correspond to the sensor unit 10, the signal processing unit 20, and the information processing unit 30 described with reference to FIG. 1, respectively.

The sensor unit 510 includes an IMU 5100, a light detection and ranging sensor 5110, and a synchronization signal generator 5130. The IMU 5100 is equivalent to the IMU 100 described above, and includes a triaxial acceleration sensor, a triaxial angular velocity sensor, and a triaxial geomagnetic sensor, and outputs sensor data obtained by each of these sensors as IMU data.

The synchronization signal generator 5130 generates a synchronization signal. The synchronization signal may be a pulse of a predetermined period. The synchronization signal generator 5130 supplies the generated synchronization signal to the IMU 5100 and the light detection and ranging sensor 5110. Operation and data output timing of each of the IMU 5100 and the light detection and ranging sensor 5110 are controlled in synchronization with the supplied synchronization signal.

The light detection and ranging sensor 5110 is a sensor that performs ranging using light, and in an existing technology, laser imaging detection and ranging (LiDAR) that performs ranging using laser light is applied. With LiDAR, for example, pulsed laser light is scanned and emitted in a predetermined angular range, and ranging is performed based on a difference between a reception timing of the reflected light and a transmission timing of the emitted light. In LiDAR, for example, a ranging result can be obtained as a point cloud including points each having three-dimensional coordinates. The light detection and ranging sensor 5110 outputs the ranging result including the point cloud as LiDAR data.

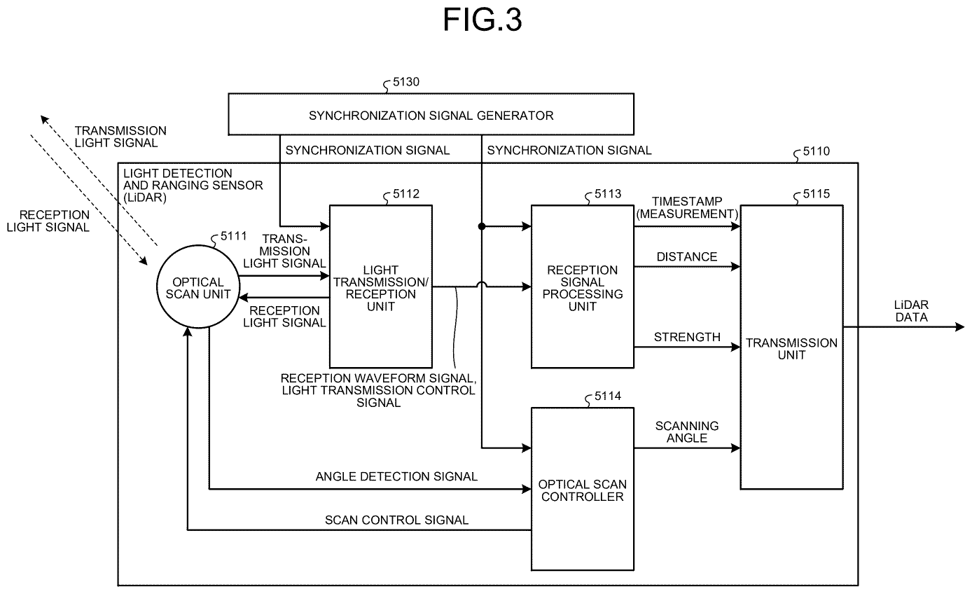

FIG. 3 is a block diagram illustrating a configuration of an example of the light detection and ranging sensor 5110 according to an existing technology. In FIG. 3, the light detection and ranging sensor 5110 includes an optical scan unit 5111, a light transmission/reception unit 5112, a reception signal processing unit 5113, an optical scan controller 5114, and a transmission unit 5115.

The light transmission/reception unit 5112 includes: a light transmission unit that generates a transmission light signal transmitted from the optical scan unit 5111 described below; a transmission light controller that controls the transmission light generated by the light transmission unit; and a light reception unit that receives (receives) a reception light signal from the optical scan unit 5111.

In the light transmission/reception unit 5112, the light transmission unit includes: a light source such as a laser diode for performing oscillation of laser light which is transmission light; an optical system for emitting light oscillated by the light source; and a laser output modulator for driving the light source, for example. The light transmission unit uses the light source to perform light oscillation in accordance with the light transmission control signal supplied from the transmission light controller, and emits a transmission light signal. The transmission light signal is sent to the optical scan unit 5111.

In the light transmission unit, the transmission light controller generates a pulse signal using pulses at predetermined time intervals, for example. Based on the pulse signal, the transmission light controller generates a light transmission control signal being a modulation synchronization timing signal to be input to the laser output modulator included in the light transmission unit. The transmission light controller generates the light transmission control signal as a signal synchronized with the synchronization signal supplied from the synchronization signal generator 130. The transmission light controller passes the generated light transmission control signal to the light transmission unit and a reception signal processing unit 5113 to be described below.

In the light transmission/reception unit 5112, the light reception unit includes: for example, a light receiver that receives a reception light signal (performs light reception) from the optical scan unit 5111; and a drive circuit that drives the light receiver. For example, the light receiver can be implemented by applying a configuration combining a condenser lens and a light receiving element such as a photodiode. The light reception unit further includes a light combiner that combines the reception light received from the scan unit with the local oscillator light transmitted from the light transmission unit. When the received light is reflected light from the target of the transmission light, the received light is to be a signal delayed from the local oscillator light in accordance with the distance to the target. The light transmission/reception unit 5112 passes a signal corresponding to the reception light to the reception signal processing unit 5113 as a reception waveform signal.

The reception signal processing unit 5113 performs predetermined signal processing on the reception waveform signal passed from the light transmission/reception unit 5112, the processing performed in synchronization with the synchronization signal supplied from the synchronization signal generator 130, and acquires a distance to the object and a strength of the reception light signal. The reception signal processing unit 5113 adds a timestamp generated in synchronization with the synchronization signal to the acquired distance and velocity, and passes the data with the timestamp to the transmission unit 5115. The timestamp here is a timestamp related to measurement, indicating the timing at which the transmission light signal has been transmitted by the light transmission/reception unit 5112, and is generated and added for each measurement.

The optical scan controller 5114 generates a scan control signal for controlling scanning of the transmission light signal in the optical scan unit 5111. At this time, the optical scan controller 5114 generates the scan control signal so that the scanning of the transmission light signal is synchronized with the synchronization signal supplied from the synchronization signal generator 130. The optical scan controller 5114 may generate a scan control signal for performing scanning in a predetermined scanning range, or may generate a scan control signal in accordance with scan control information transmitted from a control communication unit 230 described below.

In addition, the optical scan controller 5114 receives an angle detection signal indicating a scanning angle of the transmission light signal from the optical scan unit 5111. The optical scan controller 5114 passes information indicating the scanning angle to the transmission unit 5115 based on the received angle detection signal.

The optical scan unit 5111 transmits a transmission light signal sent from the light transmission/reception unit 5112, the transmission being performed at an angle according to a scan pattern corresponding to the scan control signal supplied from the optical scan controller 5114, and receives light incident from the angle, and outputs the light as a reception light signal. In the optical scan unit 5111, the scanning mechanism of the transmission light signal can be implemented by applying a biaxial mirror scanner, for example. In this case, the scan control signal is, for example, a drive voltage signal applied to each axis of the biaxial mirror scanner.

In addition, the optical scan unit 5111 detects angles in the horizontal direction and the vertical direction at which the transmission light signal is transmitted, and outputs an angle detection signal indicating the detected angle.

The transmission unit 5115 transmits the point cloud based on the distance and the strength passed from the reception signal processing unit 5113 and the scanning angle passed from the optical scan controller 5114 to the signal processing unit 520, as LiDAR data. At this time, the transmission unit 5115 adds the timestamp passed from the reception signal processing unit 5113 to each point of the point cloud and transmits the data with the timestamp to the signal processing unit 520.

In FIG. 2, the signal processing unit 520 includes a reception unit 5200, a sensor position/orientation estimation unit 5210, a SLAM processing unit 5220, and a transmission unit 5201.

The reception unit 5200 receives the IMU data and the LiDAR data transmitted from the sensor unit 510. The reception unit 5200 passes the received IMU data to the sensor position/orientation estimation unit 5210, and passes the LiDAR data to the SLAM processing unit 5220.

The sensor position/orientation estimation unit 5210 estimates the position, orientation, and angular velocity of the IMU 5100 (sensor unit 510) based on the IMU data passed from the reception unit 5200. The sensor position/orientation estimation unit 5210 passes the estimated position, orientation, and angular velocity to the SLAM processing unit 5220.

The SLAM processing unit 5220 creates map information using the Simultaneous Localization And Mapping (SLAM) technology based on the sensor position, orientation, and angular velocity passed from the sensor position/orientation estimation unit 5210 and the LiDAR data passed from the reception unit 5200, that is, the point cloud.

SLAM is a technology of simultaneously performing localization (self-position estimation) and environmental map creation. In the SLAM, the self-position is estimated using data of an internal environment sensor, for example, IMU data, or odometry data obtained by a wheel encoder that measures rotation of a wheel of a mobile body, for example. In SLAM, for example, a surrounding environment is detected by an external environment sensor such as LiDAR, so as to simultaneously execute update of a self-position in an environmental map and update of the environmental map.

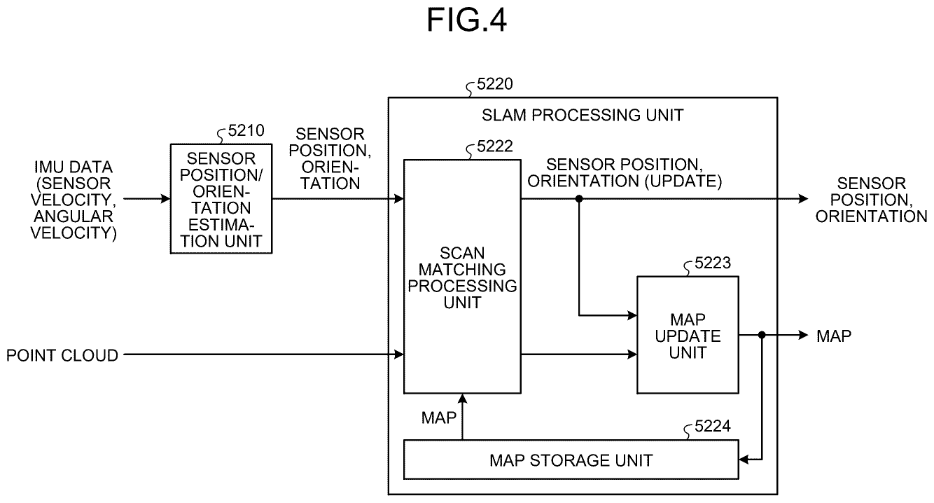

FIG. 4 is a block diagram illustrating a configuration of an example of the SLAM processing unit 5220 according to an existing technology. In FIG. 4, the SLAM processing unit 5220 includes a scan matching processing unit 5222, a map update unit 5223, and a map storage unit 5224.

In the SLAM processing unit 5220, for example, the map update unit 5223 creates, in an initial state, a reference map using the point cloud at the initial sensor position and orientation. The map update unit 5223 may use, for example, an occupancy grid map that divides a space and holds the occupancy of each grid. Based on the line connecting each detection point in the point cloud passed from the reception unit 5200 via the scan matching processing unit 5222 and a map, the map update unit 5223 calculates the space occupancy of each grid point and creates the map.

Based on the map generated up to the previous time stored in the map storage unit 5224 and the current point cloud passed from the reception unit 5200, the scan matching processing unit 5222 performs point cloud scan matching using the previous sensor position/orientation estimated by the sensor position/orientation estimation unit 5210 as reference, and searches for the sensor position/orientation at which the matching between the map and the point cloud is optimized. The scan matching processing unit 5222 may apply, for example, a matching processing algorithm using Iterative Closest Point (ICP) to the matching processing using the point cloud scan matching.

The scan matching processing unit 5222 passes the sensor position and orientation updated by the search to the map update unit 5223 and together with this, outputs the updated sensor position and orientation from the SLAM processing unit 5220. In addition, the scan matching processing unit 5222 passes the updated sensor position/orientation to the sensor position/orientation estimation unit 5210.

Based on the updated sensor position and orientation passed from the scan matching processing unit 5222, the map update unit 5223 integrates and connects the point cloud passed from the reception unit 5200 via the scan matching processing unit 5222 to the map so as to create an environmental map. The map update unit 5223 outputs map information indicating the created environmental map from the SLAM processing unit 5220 and together with this, stores the map information in the map storage unit 5224.

In FIG. 2, the transmission unit 5201 transmits information output from the SLAM processing unit 5220, specifically, the information indicating the sensor position and orientation, the information indicating the sensor velocity and the angular velocity, and the map information, to the information processing unit 530. At this time, the transmission unit 5201 may add, for example, a timestamp indicating the time-point when the measurement by the light detection and ranging sensor 5110 is performed, to each piece of information and pass the information to the information processing unit 530.

### 1-1-2. Outline of Processing Using Existing Technology

Next, an outline of processing according to the above-described existing technology will be described. First, a problem referred to as degeneracy in point cloud scan matching according to the existing technology will be described.

In the existing technology, in a case where the surrounding environmental structure is simple or monotonous in the movement direction, in a case where the environmental structure included in the sensor field of view is insufficient, or the like, there will be a state referred to as degeneracy or degeneration (hereinafter, referred to as degeneracy). With the occurrence of degeneracy, in a case where the information by the external environment sensor such as the light detection and ranging sensor 5110 is compared with reference information using processing such as scan matching, the matching becomes indefinite, leading to an increase in errors in the self-position/orientation estimation.

Therefore, in a case where the degeneracy occurs, the self-position/orientation is estimated using motion estimation by the internal environment sensor such as the IMU 5100 or the wheel encoder, that is, using the odometry technology, instead of using the external environment sensor.

The odometry technique is a technique of estimating a travel distance and orientation change of a mobile body based on information such as a rotation velocity of a wheel that drives the mobile body, acquired by a wheel encoder or the like, and acceleration and angular velocity acquired by the IMU 5100 mounted on the mobile body. In general, these odometry techniques have large accumulated errors, leading to occurrence of drift or the like depending on environmental conditions, resulting in inaccurate estimation results. In addition, a three-dimensional mobile body such as a drone has no wheels or the like, and thus, cannot use odometry by the former method using the wheel.

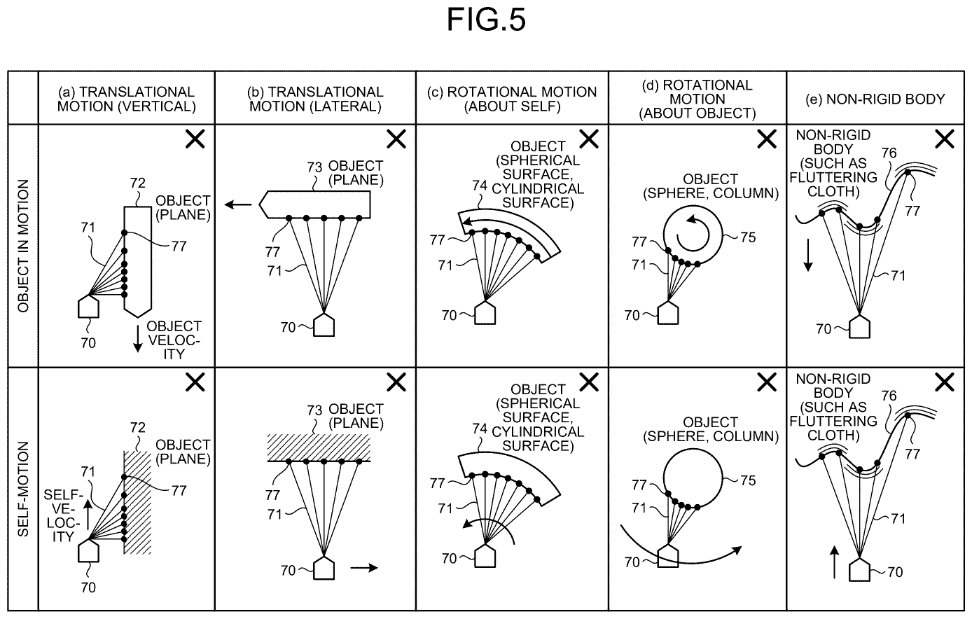

FIG. 5 is a schematic diagram for describing a case where degeneracy or a dynamic environment change occurs in point cloud scan matching according to an existing technology. FIG. 5 schematically illustrates states of measurement in the case where the object is moving (upper drawing) and the case where the object is moving (lower drawing) regarding the relative motion between the measurement target object and the self, as illustrated for each of: (a) longitudinal translational motion; (b) lateral translational motion; (c) rotational motion about the self; (d) rotational motion about the object; and (e) motion in the case where the object is a non-rigid body.

Note that, in FIG. 5, a sensor 70 being the self is a sensor that performs measurement by LiDAR, with the direction of the center of the scanning range defined as a front direction of the sensor 70.
(a) The translational motion in the longitudinal direction indicates, in the upper drawing, an example in which an object 72 having a smooth and planar surface moves so as to pass the side surface of the sensor 70 parallel to the direction of the front surface of the sensor 70 while being irradiated with a transmission light signal 71 transmitted from the sensor 70. Furthermore, the lower drawing is an example in which the sensor 70 moves parallel to the surface of the object 72 toward the front direction while transmitting the transmission light signal 71. In either case, the surface of the object 72 is irradiated with the transmission light signal 71, and the point irradiated with the transmission light signal 71 is defined as a detection point 77 as a ranging target.

Note that a smooth surface indicates that no feature point exists on the surface.
(b) The translational motion in the lateral direction indicates, in the upper drawing, an example in which an object 73 having a smooth and planar surface moves so as to pass the front surface of the sensor 70 perpendicular (in right angle) to the direction of the front surface of the sensor 70 while being irradiated with a transmission light signal 71 transmitted from the sensor 70. The lower drawing is an example in which the sensor 70 moves in parallel with the surface of the object 73 while transmitting the transmission light signal 71 with the front of the sensor 70 facing the surface of the object 73. In either case, the surface of the object 73 is irradiated with the transmission light signal 71, and the point irradiated with the transmission light signal 71 is defined as the detection point 77 as a ranging target.
(c) The rotational motion about the self indicates, in the upper drawing, an example in which an object 74 having a smooth surface with a spherical or cylindrical surface shape rotates, while being irradiated with the transmission light signal 71 by the sensor 70 located at the center of the arc of the cross section of the object 74, the rotation being made about the center. Furthermore, the lower drawing is an example in which the sensor 70 performs rotational motion about the center while transmitting the transmission light signal 71. In either case, the surface of the object 74 is irradiated with the transmission light signal 71, and the point irradiated with the transmission light signal 71 is defined as the detection point 77 as a ranging target.
(d) The rotational motion about the object indicates, in the upper drawing, an example in which an object 75 having a smooth surface with a spherical or a cylindrical surface rotates about the center of the circular cross section of the object 75 while being irradiated with the transmission light signal 71 by the sensor 70. Furthermore, the lower drawing is an example in which the sensor 70 performs rotational motion around the object 75 about the axis while transmitting the transmission light signal 71. In either case, the surface of the object 75 is irradiated with the transmission light signal 71, and the point irradiated with the transmission light signal 71 is defined as the detection point 77 as a ranging target.
(e) The motion in the case where the object is a non-rigid body indicates, in the upper drawing, an example in which an object 76 being a non-rigid body (such as a fluttering cloth) having an irregular surface moves toward the sensor 70 while being irradiated with the transmission light signal 71 by the sensor 70. Furthermore, the lower drawing is an example in which the sensor 70 moves toward the object 76 while transmitting the transmission light signal 71. In either case, the surface of the object 76 is irradiated with the transmission light signal 71, and the point irradiated with the transmission light signal 71 is defined as the detection point 77 as a ranging target.

In any case illustrated in FIG. 5, there is no change in the point cloud frame in the direction of the relative motion of the object 72 to 75 with reference to the sensor 70, leading to occurrence of degeneracy. This makes it possible to perform, in scan matching, motion estimation based on a frame difference. Furthermore, regarding the relative motion of the object 76 with reference to the sensor 70, the state in which the object 76 being a non-rigid body is included in the environment lowers the structural correlation between the point cloud frames, making it extremely difficult to perform matching. Therefore, in a case where the object 76 being a non-rigid body is included in the environment, it is difficult to perform motion estimation based on a frame difference in scan matching.

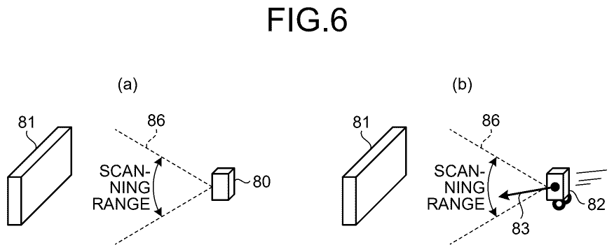

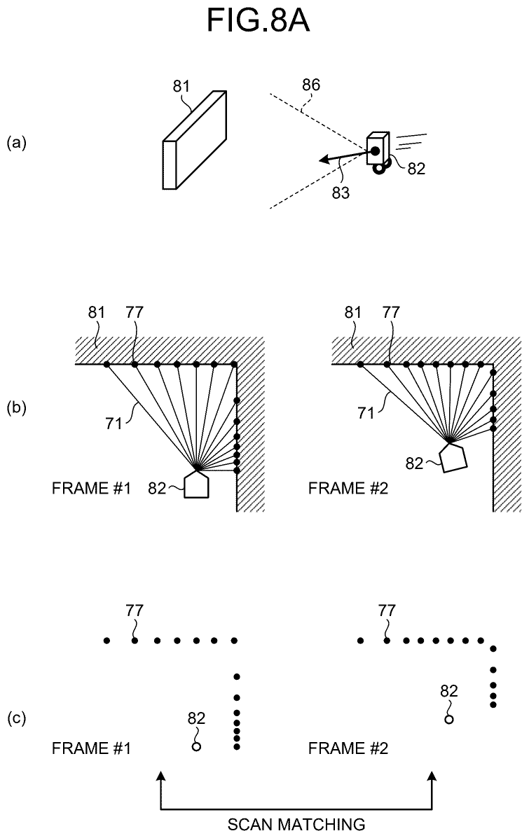

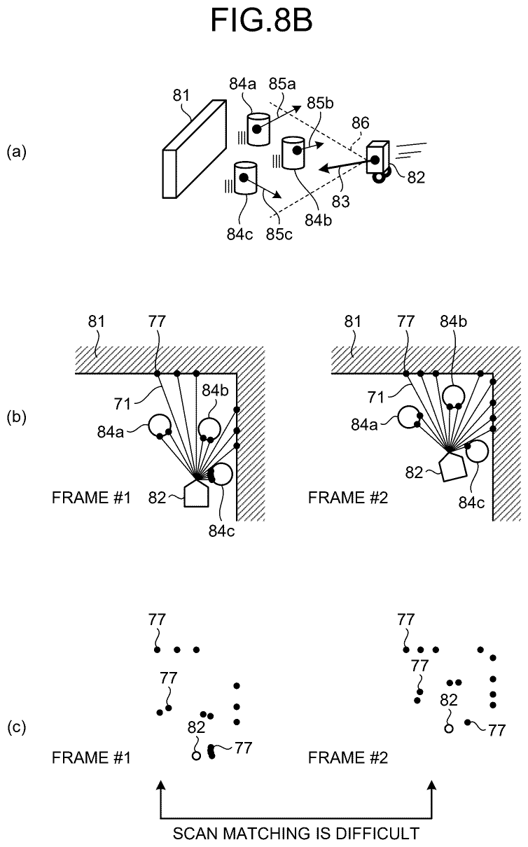

Furthermore, typical SLAM performs processing on the assumption that the environment is static. Therefore, perceiving a moving object as an environment causes an error in self-position estimation or map estimation, leading to a failure in processing. A problem in a case where a moving object is included in the environment will be described with reference to FIGS. 6 to 8B. In FIGS. 8A and 8B, for the sake of simplicity, the point cloud and the environmental map are expressed in two dimensions. However, the point cloud and the environmental map, in practice, need to be handled in three dimensions.

FIG. 6 is a schematic diagram illustrating an example of a static environment in which the environment includes no moving object. In FIG. 6, in section (a), a sensor by LiDAR, for example, is mounted on a stationary object 81 whose position is fixed, and a transmission light signal is scanned in a scanning range 86 to perform measurement. The scanning range 86 includes the stationary object 81, such as a wall, whose position is fixed. In FIG. 6, section (b) illustrates an example in which a sensor is mounted on a mobile body 82 moving in a direction of arrow 83 in the state of section (a).

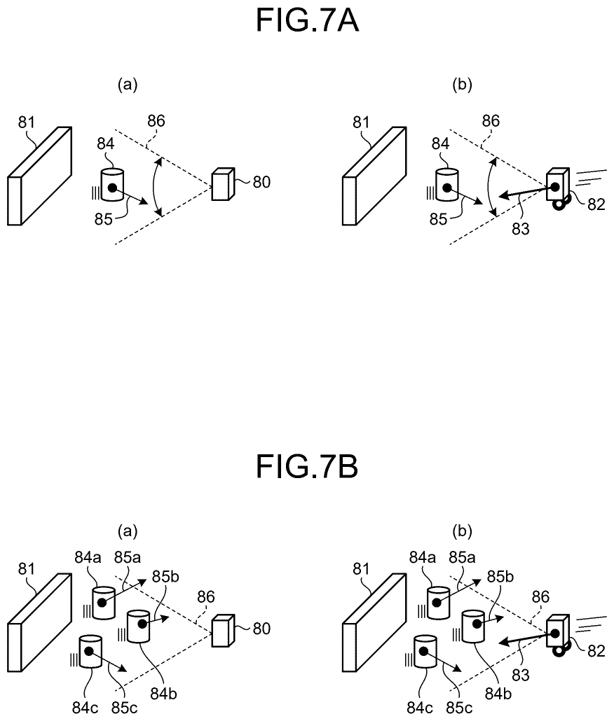

FIG. 7A is a schematic diagram illustrating an example of a dynamic environment in which an environment includes one moving object. In FIG. 7A, section (a) illustrates an example in which one moving object 84 moving in the direction of arrow 85 is included in the scanning range 86 in the state illustrated in section (a) of FIG. 6. In FIG. 7A, section (b) illustrates an example in which the sensor is mounted on the mobile body 82 that moves in the direction of arrow 83 in the state illustrated in section (a) of FIG. 6.

FIG. 7B is a schematic diagram illustrating an example of a dynamic environment in which an environment includes a plurality of moving objects. In FIG. 7B, section (a) is an example in which the scanning range 86 includes a plurality of moving objects 84a, 84b, and 84c respectively moving in directions of arrows 85a, 85b, and 85c in the state illustrated in section (a) of FIG. 6. In FIG. 7B, section (b) illustrates an example in which the sensor is mounted on the mobile body 82 that moves in the direction of arrow 83 in the state illustrated in section (a) of FIG. 6.

FIG. 8A is a schematic diagram for illustrating scan matching in a case where an environment includes no moving object according to an existing technology. In the example of section (a), the sensor is mounted on the mobile body 82 moving in the direction of arrow 83, and a stationary object 81 such as a wall having its position fixed exists in the scanning range 86 of the sensor.

The sensor scans the scanning range 86 from a scanning start position to a scanning end position to form a measurement frame.

Section (b) in FIG. 8A illustrates an example of scanning in frame #1 of sensor measurement and an example of scanning in frame #2 subsequent to frame #1 in time (for example, a frame next to frame #1) in the state of section (a). It can be seen that the positional relationship between the stationary object 81 and the mobile body 82 changes with the movement of the mobile body 82.

Section (c) of FIG. 8A illustrates an example of scan matching for individual detection points 77 of frames #1 and #2, detected by the sensor in section (b). In this case, even with the change in the position of the mobile body 82, the positional relationship of each detection point 77 does not change between the frame #1 and the frame #2, which facilitates scan matching.

FIG. 8B is a schematic diagram for illustrating scan matching in a case where an environment includes a moving object according to an existing technology. A sensor is mounted on the mobile body 82 that moves in a direction of arrow 83 illustrated in section (a), and a stationary object 81 exists in the scanning range 86 of the sensor. Furthermore, the scanning range 86 of the sensor includes moving objects 84a, 84b, and 84c that move at arbitrary velocities in the directions of the arrows 85a, 85b, and 85c, respectively.

Section (b) in FIG. 8B illustrates an example of scanning in frame #1 of sensor measurement and an example of scanning in frame #2 after frame #1 in time in the state of section (a). It can be seen that the mobile body 82 moves, and together with this, the moving objects 84a to 84c move, there is a change in the positional relationship between the stationary object 81 and the mobile body 82, and furthermore, there is a change in the positional relationship between the stationary object 81 and the mobile body 82, and the moving objects 84a to 84c.

Section (c) in FIG. 8B illustrates an example of scan matching for individual detection points 77 of frames #1 and #2 detected by the sensor in section (b). In this case, with the movement of each of the moving objects 84a to 84c, there is a change in the positional relationship between each of the detection points 77 in each of the moving objects 84a to 84c and each of the detection points 77 in the stationary object 81 in the frame #1 and the frame 32, making it difficult to perform scan matching. In this manner, under the condition that the sensor itself and a plurality of moving objects around the sensor are moving, the estimation processing by SLAM is least stable.

Methods of handling the problem in a case where the moving object is perceived as the environment as described with reference to FIG. 8B include a method of handling the moving object explicitly (directly) and a method of removing a point corresponding to the moving object as an outlier.

As the former method, there is a proposed method of handling a moving object and a stationary object in the same framework so that data association with past observation points can be redone. In addition, as the latter method, there are proposed methods including a method of tracking and removing a moving object from a target, and a method of separating a stationary object and a moving object from each other by preliminary learning.

However, each method separates a moving object and a stationary object from each other by performing advanced processing using a plurality of frames of sensor output, leading to a problem of difficulty in handling an object moving at a high speed or having a complicated motion.

### 1-2. Velocity Measurement Technique Applicable to Mobile Body

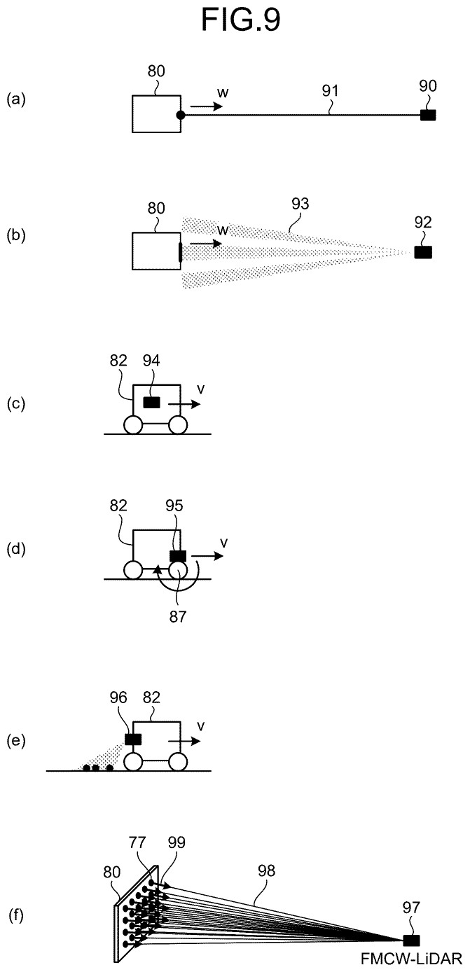

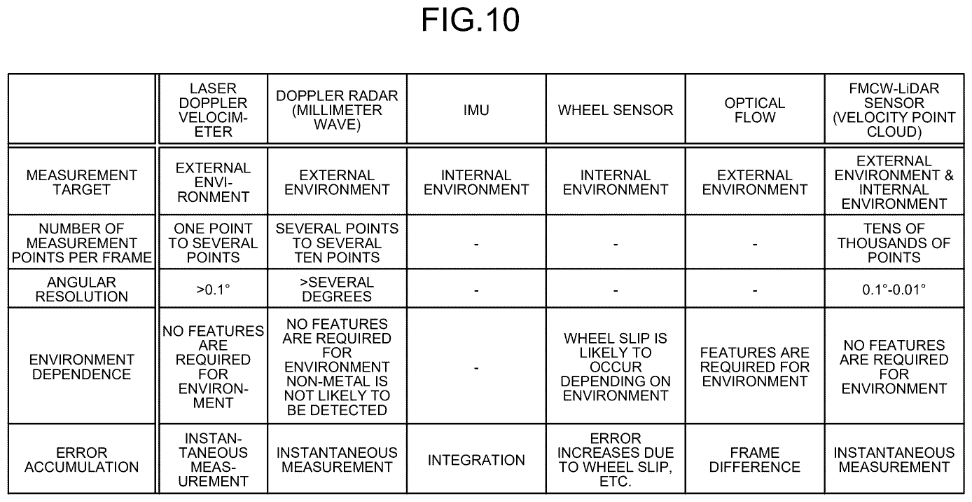

Here, a velocity measurement technique applicable to the mobile body will be schematically described with reference to FIGS. 9 and 10. The velocity measurement regarding a mobile body is roughly divided into a technique of measuring the velocity of the mobile body itself (internal environment) and a technique of measuring the velocity of an external object (external environment) viewed from the mobile body.

FIG. 9 is a schematic diagram schematically illustrating a velocity measurement technique applicable to a mobile body. In FIG. 9, section (a) illustrates an example of velocity measurement using a laser Doppler velocimeter 90. A transmission light signal 91 of modulated light is transmitted from the laser Doppler velocimeter 90, for example, and reflected by an object 80. The laser Doppler velocimeter 90 determines a Doppler velocity w of the object 80 toward the laser Doppler velocimeter 90 based on the transmission light signal 91 and the reflected light signal from the object 80.

In FIG. 9, a section (b) illustrates an example of velocity measurement using a Doppler radar 92 using a millimeter wave. A measurement signal 93 by a millimeter wave is emitted from the Doppler radar 92 and reflected by the object 80. The Doppler radar 92 determines the Doppler velocity w of the object 80 toward the Doppler radar 92 based on a measurement signal 93 and the signal reflected from the object 80.

The measurement technique illustrated in the sections (a) and (b) of FIG. 9 is applied to the external environment as a measurement target.

Section (c) in FIG. 9 illustrates an example of velocity measurement using an IMU 94. Inertial measurement data measured by the IMU 94 mounted on the mobile body 82 is integrated to obtain a velocity v of the mobile body 82.

Section (d) in FIG. 9 illustrates an example of velocity measurement using a wheel sensor 95. The wheel sensor 95 mounted on the mobile body 82 detects, for example, a rotation angle or a rotation speed (per unit time) of a wheel 87 that drives the mobile body 82, and obtains the velocity v of the mobile body 82 based on the detected value.

Section (e) in FIG. 9 illustrates an example of velocity measurement using an optical flow sensor 96. The optical flow sensor 96 mounted on the mobile body 82 performs image shooting of a road surface behind the mobile body 82 in the traveling direction of the mobile body 82 at predetermined time intervals and compares a plurality of shot images, thereby determining the velocity v of the mobile body 82.

In the measurement techniques illustrated in sections (c) to (e) of FIG. 9, the internal environment is a measurement target.

In FIG. 9, section (f) illustrates an example of velocity measurement using an FMCW-LiDAR sensor 97. A transmission light signal 98 of chirp light is transmitted from the FMCW-LiDAR sensor 97 and reflected by the object 80. The FMCW-LiDAR sensor 97 obtains the Doppler velocity w of the object 80 toward the FMCW-LiDAR sensor 97 based on the transmission light signal 98 and the reflected light from the object 80. At this time, the FMCW-LiDAR sensor 97 performs scanning in a predetermined angular range in the horizontal and vertical directions, and acquires a velocity point cloud based on a plurality of beams of reflected light from a plurality of detection points 77 on the object 80. This makes it possible for the FMCW-LiDAR sensor 97 to obtain the velocity distribution on the object 80.

FIG. 10 is a schematic diagram illustrating exemplary characteristics of the above-described sensors, namely, the laser Doppler velocimeter 90, the Doppler radar 92, the IMU 94, the wheel sensor 95, the optical flow sensor 96, and the FMCW-LiDAR sensor 97. The example of FIG. 10 performs comparison, between sensors, of the characteristics of five items of the measurement target, the number of measurement points per frame, the angular resolution, the environment dependence, and the error accumulation.

The measurement target of the laser Doppler velocimeter 90, the Doppler radar 92, and the optical flow sensor 96 is an external environment, and the measurement target of the IMU 94 and the wheel sensor 95 is an internal environment. In contrast, the FMCW-LiDAR sensor 97 can measure the internal environment and the external environment as the measurement target.

The angular resolution and the number of measurement points per frame are applied to the laser Doppler velocimeter 90, the Doppler radar 92, and the FMCW-LiDAR sensor 97 that perform scanning. The number of measurement points is 1 to several points with the laser Doppler velocimeter 90 and several to several 10 points with the Doppler radar 92, whereas the number of points with the FMCW-LiDAR sensor 97 is tens of thousands points. In addition, the angular resolution is larger than 0.1 degree (°) in the laser Doppler velocimeter 90, for example, and larger than several degree (°) in the Doppler radar 92, for example. In contrast, the angular resolution with the FMCW-LiDAR sensor 97 is 0.1° to 0.01°.

Regarding the environment dependence, the velocity measurement based on the Doppler principle, such as the laser Doppler velocimeter 90, the Doppler radar 92, and the FMCW-LiDAR sensor 97 using laser light or millimeter waves, requires no feature in the environment, whereas the optical flow sensor 96 requires features (feature points) in the environment. Furthermore, regarding the wheel sensor 95, the measurement result will vary depending on the environment, that is, the measurement result will be influenced by an occurrence of slip on the wheel 87 or the like. In addition, there is a case where it is difficult for the Doppler radar 92 to detect a non-metal measurement target.

Regarding the error accumulation in velocity measurement, the laser Doppler velocimeter 90, the Doppler radar 92, and the FMCW-LiDAR sensor 97 perform measurement instantaneously, and thus has no error accumulation. In contrast, the IMU 94 performs the measurement based on the integration of the acceleration, and the optical flow sensor 96 performs the measurement based on the frame difference, accumulating or increasing the errors. Furthermore, regarding the wheel sensor 95, there is a possibility that an error increases due to slip of the wheel 87 or the like.

Among the above-described velocity measurement techniques, the present disclosure applies, as a measurement technique of performing velocity measurement, a measurement using the FMCW-LiDAR sensor 97, having high angular resolution and capable of obtaining a very large number of per-frame measurement points simultaneously including the velocity and the distance.

### 1-3. Specific Examples of Technology According to Embodiment of Present Disclosure

Next, a technology according to each embodiment of the present disclosure will be described using a more specific example.

### (1-3-1. Basic System Configuration According to

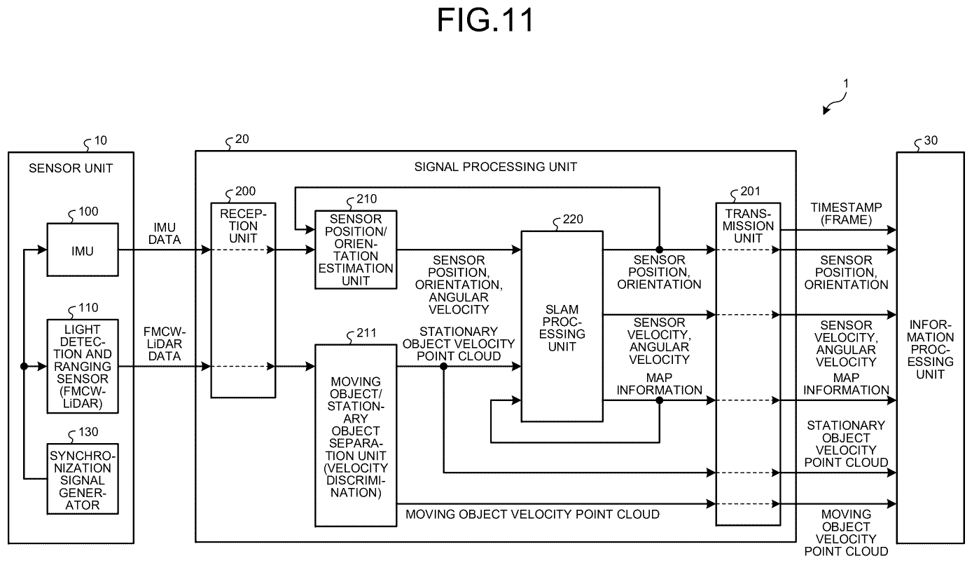

Each Embodiment of Present Disclosure) First, a basic system configuration according to each embodiment of the present disclosure will be schematically described. FIG. 11 is a block diagram illustrating a basic configuration example of a perception system 1 according to each embodiment of the present disclosure.

In FIG. 11, the perception system 1 includes the sensor unit 10, the signal processing unit 20, and the information processing unit 30 as described with reference to FIG. 1. The sensor unit 10 includes an IMU 100, a light detection and ranging sensor 110 that performs ranging and velocity measurement using the FMCW-LiDAR, and a synchronization signal generator 130. As described above, the IMU 100 includes, for example, a triaxial acceleration sensor, a triaxial angular velocity sensor, and a triaxial geomagnetic sensor, and outputs inertial measurement data (IMU data) obtained by these sensors.

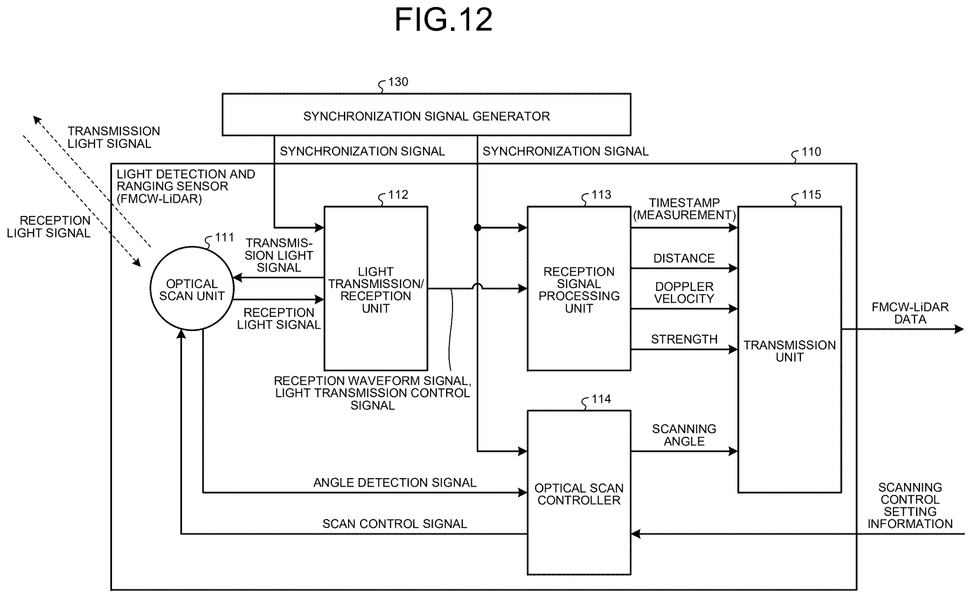

The light detection and ranging sensor 110 is a sensor that performs distance measurement using light, and applies the FMCW-LiDAR method as described above. FIG. 12 is a block diagram illustrating a configuration of an example of the light detection and ranging sensor 110 according to each embodiment.

In FIG. 12, the light detection and ranging sensor 110 includes an optical scan unit 111, a light transmission/reception unit 112, a reception signal processing unit 113, an optical scan controller 114, and a transmission unit 115.

The light transmission/reception unit 112 includes: a light transmission unit that generates a transmission light signal transmitted from the optical scan unit 111 described below; a transmission light controller that controls the transmission light generated by the light transmission unit; and a light reception unit that receives (receives) a reception light signal from the optical scan unit 111.

In the light transmission/reception unit 112, the light transmission unit includes: a light source such as a laser diode for oscillating laser light which is transmission light; an optical system for emitting light oscillated by the light source; and a laser output modulator for driving the light source, for example. The light transmission unit uses the light source to perform light oscillation in accordance with the light transmission control signal supplied from the transmission light controller, and emits a transmission light signal by chirp light whose frequency linearly changes within a predetermined frequency range with the lapse of time. The transmission light signal is transmitted to the optical scan unit 111, and together with this, is transmitted to the light reception unit as local oscillator light.

In the light transmission unit, the transmission light controller generates a signal whose frequency linearly changes (increases and decreases) within a predetermined frequency range with the lapse of time. Such a signal whose frequency linearly changes within a predetermined frequency range with the lapse of time is referred to as a chirp signal. Based on the chirp signal, the transmission light controller generates a light transmission control signal being a modulation synchronization timing signal to be input to the laser output modulator included in the light transmission unit. The transmission light controller generates the light transmission control signal as a signal synchronized with the synchronization signal supplied from the synchronization signal generator 130. The transmission light controller passes the generated light transmission control signal to the light transmission unit and a reception signal processing unit 113 to be described below.

In the light transmission/reception unit 112, the light reception unit includes: for example, a light receiver that receives a reception light signal (performs light reception) from the optical scan unit 111; and a drive circuit that drives the light receiver. For example, the light receiver can be implemented by applying a configuration combining a condenser lens and a light receiving element such as a photodiode. The light reception unit further includes a light combiner that combines the reception light received from the scan unit with the local oscillator light transmitted from the light transmission unit. When the reception light is reflected light from a target of the transmission light, the reception light is a signal delayed in accordance with the distance to the object, as compared with the local oscillator light, and thus, the combined signal obtained by combining the reception light and the local oscillator light is to be a signal (beat signal) having a frequency component corresponding to the distance. The light transmission/reception unit 112 passes this signal to the reception signal processing unit 113 as a reception waveform signal.

The reception signal processing unit 113 performs predetermined signal processing such as fast Fourier transform on the reception signal passed from the light transmission/reception unit 112 in synchronization with the synchronization signal supplied from the synchronization signal generator 130. With this signal processing, the reception signal processing unit 113 acquires a distance to the target, the Doppler velocity of the target, and the strength of the reception light signal. The reception signal processing unit 113 adds a timestamp generated in synchronization with the synchronization signal to the acquired distance, velocity, and Doppler velocity, and passes the data with the timestamp to the transmission unit 115. The timestamp here is a timestamp related to measurement, indicating the timing at which the transmission light signal has been transmitted by the light transmission/reception unit 112, and is generated and added for each measurement.

The optical scan controller 114 generates a scan control signal for controlling scanning of the transmission light signal in the optical scan unit 111. At this time, the optical scan controller 114 generates the scan control signal so that the scanning of the transmission light signal is synchronized with the synchronization signal supplied from the synchronization signal generator 130. The optical scan controller 114 may generate a scan control signal for performing scanning in a predetermined scanning range, or may generate a scan control signal in accordance with scan control information transmitted from a control communication unit 230 described below.

In addition, the optical scan controller 114 receives an angle detection signal indicating a scanning angle of the transmission light signal from the optical scan unit 111. The optical scan controller 114 passes information indicating the scanning angle to the transmission unit 115 based on the received angle detection signal.

The optical scan unit 111 transmits a transmission light signal sent from the light transmission/reception unit 112, the transmission being performed at an angle according to a scan pattern corresponding to the scan control signal supplied from the optical scan controller 114, and receives light incident from the angle, and outputs the light as a reception light signal. In the optical scan unit 111, the scanning mechanism of the transmission light signal can be implemented by applying a biaxial mirror scanner, for example. In this case, the scan control signal is, for example, a drive voltage signal applied to each axis of the biaxial mirror scanner.

In addition, the optical scan unit 111 detects angles in the horizontal direction and the vertical direction at which the transmission light signal is transmitted, and outputs an angle detection signal indicating the detected angle.

The transmission unit 115 transmits the timestamp, the distance, the Doppler velocity, and the strength passed from the reception signal processing unit 113 and the scanning angle passed from the optical scan controller 114 to the signal processing unit 20 as FMCW-LiDAR data. That is, the FMCW-LiDAR data includes a timestamp for each measurement point of the light detection and ranging sensor 110.

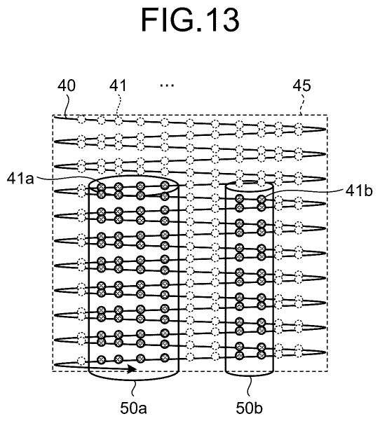

FIG. 13 is a schematic diagram schematically illustrating an example of a scan pattern of a transmission light signal according to the embodiment. FIG. 13 illustrates an example of a raster scan pattern among the scan patterns. The optical scan unit 111 performs scanning within a predetermined angular range 45 along a scanning line 40 that is folded back at both ends of the angular range 45 in the horizontal direction. The scanning line 40 corresponds to one trajectory obtained by scanning between the left end and the right end of the angular range 45. The optical scan unit 111 scans between the upper end and the lower end of the angular range 45 following the scanning line 40 in accordance with the scan control signal.

In accordance with the scan control signal, the optical scan unit 111 sequentially and discretely changes an emission point 41 of the chirp light as the transmission light signal along the scanning line 40 at constant time intervals (point rate), for example. The emission points 41 within the angular range 45 constitute one frame in the FMCW-LiDAR. The scanning time from the upper end to the lower end of the angular range 45 forms 1 frame time span. The transmission light signal at each emission point 41 is sequentially emitted at predetermined time intervals in one frame according to the scanning line 40. Therefore, the measurement data at each of the emission points 41 is acquired at different time-point for each of the emission points 41 according to the scanning order.

In the vicinity of the turning points at the left end and the right end of the angular range 45 of the scanning line 40, the scanning velocity by the biaxial mirror scanner decreases. Therefore, the individual emission points 41 are not arranged in a lattice pattern in the angular range 45.

Among the emission points 41, for example, at emission points 41a and 41b (illustrated as solid points) corresponding to the positions where objects 50a and 50b exist, the emitted transmission light signal is reflected by the objects 50a and 50b, and the reflected light is returned as a reception light signal. On the other hand, among the emission points 41, at an emission point 41 corresponding to a position where no objects 50a and 50b exist, reflected light is not obtained, and thus a reception light signal is not obtained.

Note that the light transmission/reception unit 112 may emit a transmission light signal one or a plurality of times to one emission point 41. In addition, the light transmission/reception unit 112 emits a transmission light signal by chirp light whose frequency continuously changes in time series at each emission point 41, while the optical scan unit 111 continuously changes the scanning angle. Therefore, the transmission light signal is applied to the object in an elliptical shape along the scanning line 40, for example.

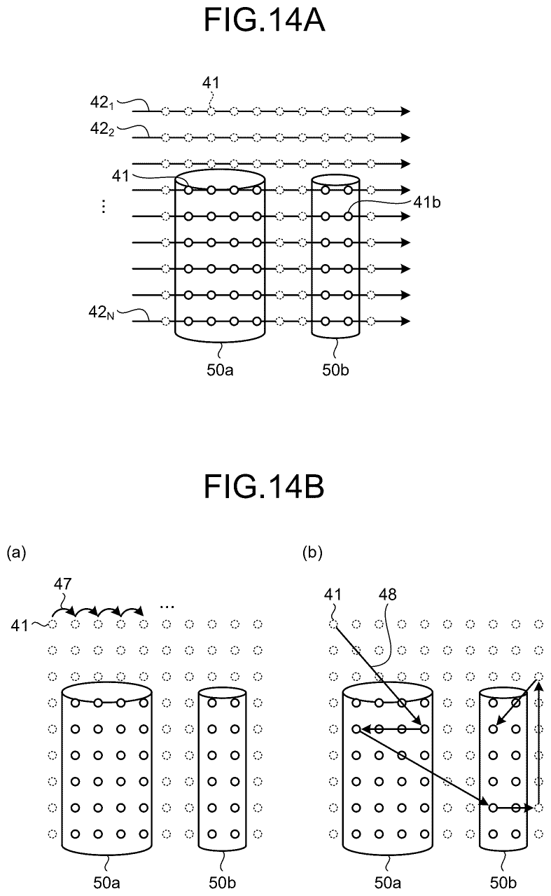

The scan pattern of the transmission light signal is not limited to the above-described raster scan pattern. FIGS. 14A and 14B are schematic diagrams schematically illustrating another example of the scan pattern of the transmission light signal.

FIG. 14A illustrates an example of a multi-layer scan pattern among the scan patterns. In the multi-layer scan, scanning of a plurality of lines is simultaneously performed by rotating a plurality of beams by 360°. More specifically, in the multi-layer scan, the emission point 41 of the transmission light signal is sequentially and discretely changed at constant time intervals along scanning lines 42₁, 42₂, . . . , and 42_{N} individually by the plurality of beams. In the multi-layer scan, folding of the scanning lines 42₁, 42₂, . . . , and 42_{N} does not occur, facilitating arrangement of the emission points 41 in a lattice pattern.

FIG. 14B illustrates an example of a dot scanning scan pattern among the scan patterns. In the dot scanning, the beam scanning trajectory is not continuous but discrete, as it is fixed at each emission point 41. At each emission point 41, a transmission light signal is emitted, and after reception of the reflected light signal is complete, the beam is switched to the next emission point 41. In FIG. 14B, section (a) illustrates an example in which beam switching is sequentially executed according to a prescribed sequence as indicated by arrow 47 in the figure. Furthermore, section (b) illustrates an example in which the beam switching is executed in an arbitrary order by the scan control setting from the signal processing unit 20, for example, as indicated by arrow 48 in the figure. In the example of section (b), only a predetermined region of the entire scanning region may be scanned by the scanning control setting, and the predetermined region may be set in plurality in one frame. Furthermore, the predetermined region may be decided based on the position of the detected moving object or stationary object.

Returning to the description of FIG. 11, the signal processing unit 20 includes a reception unit 200, a sensor position/orientation estimation unit 210, a moving object/stationary object separation unit 211, a SLAM processing unit 220, and a transmission unit 201. Among these units, each unit except the moving object/stationary object separation unit 211 corresponds to the reception unit 5200, the sensor position/orientation estimation unit 5210, the SLAM processing unit 5220, and the transmission unit 5201 described with reference to FIG. 2, respectively.

The reception unit 200 receives the IMU data and the FMCW-LiDAR data transmitted from the sensor unit 10. The reception unit 200 passes the received IMU data to the sensor position/orientation estimation unit 210, and passes the FMCW-LiDAR data to the moving object/stationary object separation unit 211.

The sensor position/orientation estimation unit 210 estimates the position, orientation, and angular velocity of the IMU 100 (sensor unit 10) based on the IMU data passed from the reception unit 200 and the sensor position/orientation passed from the SLAM processing unit 220. The sensor position/orientation estimation unit 210 passes the estimated position, orientation, and angular velocity to the SLAM processing unit 220.

Based on the FMCW-LiDAR data passed from the reception unit 200, the moving object/stationary object separation unit 211 extracts a stationary object velocity point cloud being a velocity point cloud of a stationary object and a moving object velocity point cloud being a velocity point cloud of a moving object. The processing by the moving object/stationary object separation unit 211 will be described below. The moving object/stationary object separation unit 211 passes the extracted stationary object velocity point cloud to the SLAM processing unit 220 and the transmission unit 201. In addition, the moving object/stationary object separation unit 211 passes the extracted moving object velocity point cloud to the transmission unit 201.

The SLAM processing unit 220 creates map information using the SLAM technique based on the sensor position, orientation, and angular velocity data passed from the sensor position/orientation estimation unit 210 and the stationary object velocity point cloud passed from the moving object/stationary object separation unit 211. The configuration of the SLAM processing unit 220 is equivalent to the configuration of the SLAM processing unit 5220 according to the existing technology described with reference to FIG. 4.

The SLAM processing unit 220 according to each embodiment includes a scan matching processing unit, a map update unit, and a map storage unit respectively corresponding to the scan matching processing unit 5222, the map update unit 5223, and the map storage unit 5224 illustrated in FIG. 4. The SLAM processing unit 220 according to the embodiment inputs the stationary object velocity point cloud instead of the point cloud to the scan matching processing unit corresponding to the scan matching processing unit 5222. Since the scan matching processing unit performs scan matching processing based on the stationary object velocity point cloud from which the velocity point cloud by moving objects is excluded, the scan matching processing can be executed with higher accuracy as compared with the scan matching processing unit 5222 according to the existing technology.

The SLAM processing unit 220 passes the sensor position and orientation output from the scan matching processing unit and the map information created and updated by the map update unit 5223 to the transmission unit 201. Furthermore, the SLAM processing unit 220 passes the sensor velocity and the angular velocity to the transmission unit 201.

The transmission unit 201 transmits the sensor position, orientation, velocity, and angular velocity, the map information, the stationary object velocity point cloud, and the moving object velocity point cloud passed from the SLAM processing unit 220 to the information processing unit 30. At this time, the transmission unit 201 adds, to each piece of information, a timestamp indicating the time-point when the light detection and ranging sensor 110 has measured the frame, and transmits the information to the information processing unit 30.

### 1-3-2. Outline of Processing According to Each Embodiment of Present Disclosure

An outline of processing according to each embodiment of the present disclosure will be described.

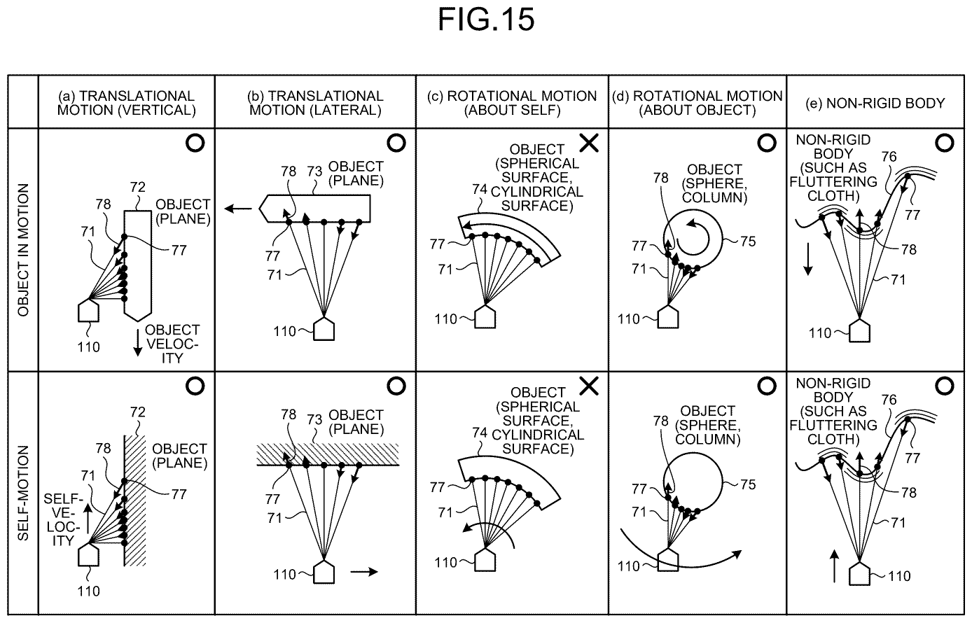

FIG. 15 is a schematic diagram for describing a case where degeneracy or a dynamic environment change occurs in point cloud scan matching according to each embodiment. FIG. 15, which corresponds to the above described FIG. 5, schematically illustrates states of measurement in the case where the object is moving (upper drawing) and the case where the object is moving (lower drawing) regarding the relative motion between the measurement target object and the self, as illustrated for each of: (a) longitudinal translational motion; (b) lateral translational motion; (c) rotational motion about the self; (d) rotational motion about the object; and (e) motion in the case where the object is a non-rigid body.

In each example illustrated in FIG. 15, the relationship between the light detection and ranging sensor 110 and the object 72, which are the self, is the same as the relationship between the sensor 70 and the object 72 in each example in FIG. 5, and thus the description thereof is omitted here.

In FIG. 15, the Doppler velocity 78 can be detected for (a) the longitudinal translational motion, (b) the lateral translational motion, (d) the rotational motion about the object, and (e) the motion when the object is a non-rigid body since the velocity in the distance direction occurs in accordance with the relative motion of the light detection and ranging sensor 110 and the object 72. Accordingly, in the examples of (a), (b), (d), and (e), it is possible to perform velocity estimation using the Doppler velocity 78 without performing scan matching.

In contrast, in FIG. 15, (c) the rotational motion about the self, there is no occurrence of the velocity in the distance direction according to the relative motion between the light detection and ranging sensor 110 and the object 72. Therefore, the Doppler velocity 78 cannot be detected, and the angular velocity cannot be estimated using the Doppler velocity 78. The angular velocity can be obtained, for example, by using a detection result by the IMU 100 together.

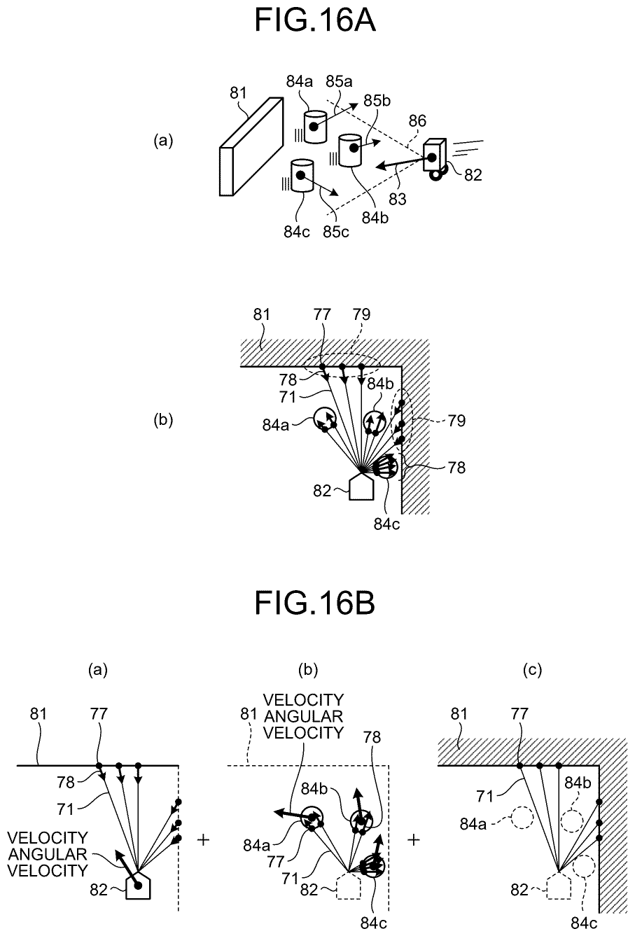

With reference to FIGS. 16A and 16B, scan matching in a case where the subject moves and the environment includes a plurality of moving objects according to each embodiment will be described.

FIG. 16A is a schematic diagram illustrating an example in which a self moves and an environment includes a plurality of moving objects according to the embodiment. In FIG. 16A, in section (a), similarly to section (a) of FIG. 8B described above, the mobile body 82 moving in the direction of the arrow 83 (not illustrated) is equipped with the perception system 1 according to each embodiment, and the stationary object 81 exists in the scanning range 86 of the light detection and ranging sensor 110 included in the perception system 1. Furthermore, the scanning range 86 of the light detection and ranging sensor 110 includes moving objects 84a, 84b, and 84c that move at arbitrary velocities in directions of arrows 85a, 85b, and 85c, respectively.

In FIG. 16A, a section (b) illustrates an example of a point cloud detected by scanning of one frame in the state of section (a). The stationary object 81 and the moving objects 84a to 84c are irradiated with the transmission light signal 71 transmitted from the light detection and ranging sensor 110 mounted on the mobile body 82, and the Doppler velocity 78 is detected at each detection point 77 by the transmission light signal 71.

FIG. 16B is a schematic diagram for illustrating motion estimation of a moving object according to the embodiment. FIG. 16B illustrates a case where motion estimation for each of the moving objects 84a to 84c is performed in the state illustrated in section (b) of FIG. 16A.

First, as illustrated in section (a) of FIG. 16B, the signal processing unit 20 estimates the velocity and the angular velocity of the mobile body 82 based on IMU data output from the IMU 100, for example.

Next, the signal processing unit 20 performs coordinate transformation on each detection point 77 based on the estimated velocity and angular velocity of the mobile body 82, and obtains the Doppler velocity 78 of each detection point 77 obtained by subtracting the velocity and angular velocity of the mobile body 82. Based on the Doppler velocity 78 at each of the detection points 77 obtained in this manner, the signal processing unit 20 extracts the detection points 77 considered to be stationary. Among the extracted detection points 77, the detection points 77 existing as a cluster in a certain region constitute a partial environment point cloud 79 (refer to FIG. 16A, section (b)). As illustrated in section (c) in FIG. 16B, the signal processing unit 20 creates a map based on the partial environment point cloud 79.

Based on the Doppler velocity 78 of each detection point 77 obtained by subtracting the velocity and the angular velocity of the mobile body 82, the signal processing unit 20 further extracts the detection points 77 in the moving objects 84a to 84c. Based on the Doppler velocity 78 of each of the detection points 77 extracted, in this manner, the signal processing unit 20 estimates the velocity and angular velocity of each of the moving objects 84a to 84c. In addition, the signal processing unit 20 estimates the position and orientation of each of the moving objects 84a to 84c based on each of the extracted detection points 77.

### 2. First Embodiment According to Present Disclosure

Next, a first embodiment according to the present disclosure will be described.

### 2-1. Specific Example of Configuration According to First Embodiment

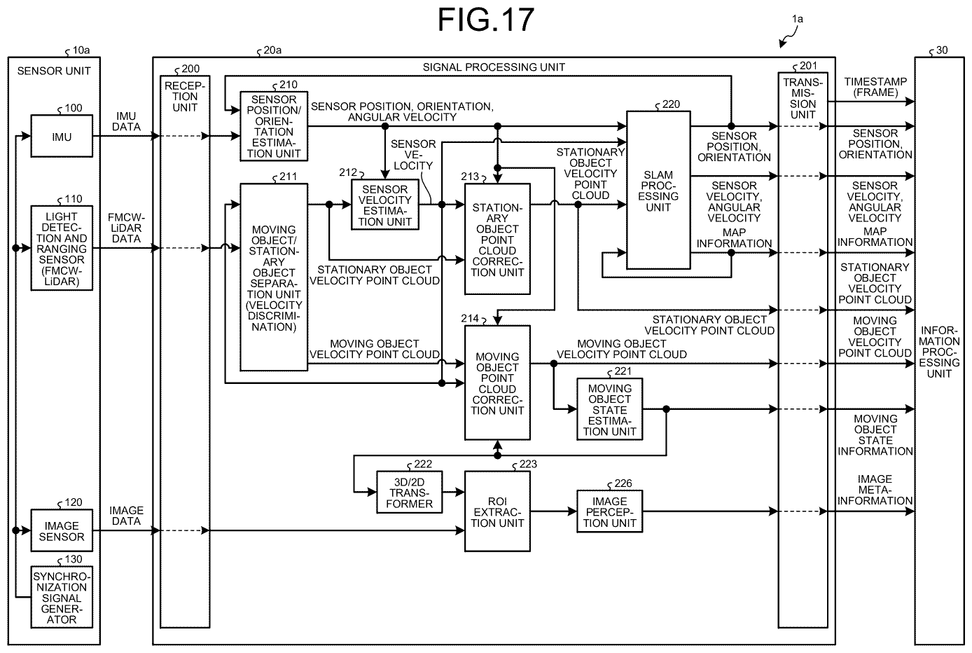

First, the configuration of the first embodiment will be described more specifically. FIG. 17 is a block diagram illustrating a configuration of an example of a perception system according to a first embodiment. In FIG. 17, a perception system 1a according to the first embodiment includes a sensor unit 10a, a signal processing unit 20a, and an information processing unit 30.

The sensor unit 10a includes an IMU 100, a light detection and ranging sensor 110 to which FMCW-LiDAR is applied, an image sensor 120, and a synchronization signal generator 130. Among these, the light detection and ranging sensor 110 may be implemented by applying the configuration described with reference to FIG. 12. The image sensor 120 is typically a camera, images a subject, and outputs image data including information of red (R), green (G), and blue (B), for example.

The synchronization signal generator 130 generates a synchronization signal. The synchronization signal may be a pulse of a predetermined period. The synchronization signal generator 130 supplies the generated synchronization signal to the IMU 100, the light detection and ranging sensor 110, and the image sensor 120. Operation and output timing of output data of each of the IMU 100, the light detection and ranging sensor 110, and the image sensor 120 are controlled in synchronization with the supplied synchronization signal.

### 2-1-1. Signal Processing Unit

In FIG. 17, each configuration included in the signal processing unit 20 can be roughly divided into a section (referred to as a library section) that provides individual functions and a section (referred to as an application section) that executes target processing using the functions provided by the section.

In FIG. 17, the library section includes, for example, a reception unit 200, a sensor position/orientation estimation unit 210, a moving object/stationary object separation unit 211, a sensor velocity estimation unit 212, a stationary object point cloud correction unit 213, and a moving object point cloud correction unit 214. Furthermore, the application section includes, for example, a SLAM processing unit 220, a moving object state estimation unit 221, a 3D/2D transformer 222, a region of interest (ROI) extraction unit 223, and an image perception unit 226.

In the signal processing unit 20, the configurations included in the library section and the application section are not limited to the above-described examples. For example, the moving object state estimation unit 221, or the moving object state estimation unit 221 and the 3D/2D transformer 222 may be included in the library section. In addition, the transmission unit 201 may be included in either the library section or the application section, or may be the section not included in either of them. The reception unit 200 may also be included in the application section, may be included in either the library section or the application section, or may be the section not included in either of them.

### 2-1-1-1. Library Section

First, the library section of the signal processing unit 20 will be described.

In the library section, the reception unit 200 receives each data output from the sensor unit 10 and passes the received data to each unit of the signal processing unit 20. More specifically, the reception unit 200 passes the IMU data output from the IMU 100 of the sensor unit 10 to the sensor position/orientation estimation unit 210. The reception unit 200 also passes the FMCW-LiDAR data output from the light detection and ranging sensor 110 of the sensor unit 10 to the moving object/stationary object separation unit 211. Furthermore, the reception unit 200 passes the image data output from the image sensor 120 of the sensor unit 10 to the ROI extraction unit 223.

In this manner, the reception unit 200 functions as a reception unit that receives the velocity point cloud data, which includes the plurality of points each having the velocity information and time-point information, and the inertial measurement data (IMU data).

The sensor position/orientation estimation unit 210 estimates the position, orientation, and angular velocity of the IMU 100 based on the IMU data passed from the reception unit 200. For example, the sensor position/orientation estimation unit 210 estimates the current position, orientation, and angular velocity of the IMU 100 by performing sensor fusion processing such as a Kalman filter, for example, using each sensor data by the triaxial acceleration sensor, the triaxial angular velocity sensor, and the triaxial geomagnetic sensor, included in the IMU data. The sensor position/orientation estimation unit 210 preliminarily acquires calibration data such as a positional relationship of the reference coordinate system of the light detection and ranging sensor 110 with respect to the reference coordinate system of the IMU 100 and internal parameters of each sensor, and uses the prepared calibration data at the time of estimation. The sensor position/orientation estimation unit 210 passes data of the estimated sensor position, orientation, and angular velocity to the sensor velocity estimation unit 212, the SLAM processing unit 220, and the transmission unit 201.

The moving object/stationary object separation unit 211 receives the FMCW-LiDAR data from the reception unit 200, and also receives the sensor velocity indicating the velocity of the light detection and ranging sensor 110 estimated by the sensor velocity estimation unit 212 to be described below. Using velocity discrimination based on the Doppler velocity and the sensor velocity included in the passed FMCW-LiDAR data, the moving object/stationary object separation unit 211 separates the velocity point cloud indicated by the FMCW-LiDAR data into a velocity point cloud by a moving object and a velocity point cloud by a stationary object. The moving object/stationary object separation unit 211 may extract the moving object velocity point cloud and the stationary object velocity point cloud from the FMCW-LiDAR data corresponding to the scan for one frame.

For example, the moving object/stationary object separation unit 211 subtracts an optical axis direction component of the sensor velocity from the Doppler velocity of each measurement point included in the FMCW-LiDAR data to eliminate the influence of the movement of the sensor unit 10 from the velocity information of the velocity point cloud, and obtains the corrected Doppler velocity of each measurement point viewed from the coordinate system of the stationary object. That is, the corrected Doppler velocity is the velocity obtained by excluding the influence of the movement of the sensor unit 10 from the Doppler velocity included in the FMCW-LiDAR data. The moving object/stationary object separation unit 211 performs threshold determination on the magnitude of the corrected Doppler velocity, and extracts, as a moving object velocity point cloud, a velocity point cloud (referred to as a localized velocity point cloud) based on measurement points localized in a certain spatial range (corresponding to the size of the target object) among measurement points with a size being the threshold or more. The moving object/stationary object separation unit 211 may extract a plurality of moving object velocity point clouds from one frame of FMCW-LiDAR data.

In addition, the moving object/stationary object separation unit 211 performs threshold determination on the magnitude of the corrected Doppler velocity for the measurement points based on the FMCW-LiDAR data. As a result of the threshold determination, the moving object/stationary object separation unit 211 extracts a set of measurement points at which the magnitude of the corrected Doppler velocity is the threshold or less as a stationary object velocity point cloud.

Here, in this threshold determination, the moving object/stationary object separation unit 211 may provide two types of thresholds: a threshold vₜha and a threshold v_{tbb}(<vₜₕₐ). The moving object/stationary object separation unit 211 may extract a measurement point at which the magnitude of the corrected Doppler velocity is the threshold vₜₕₐ or more as a moving object velocity point cloud and may extract a measurement point at which the magnitude of the corrected Doppler velocity is the threshold v_{tbb} or less as a stationary object velocity point cloud. This means that there is an intermediate point cloud that does not belong to either the moving object velocity point cloud or the stationary object velocity point cloud. For the purpose of extracting clearly stationary measurement points, it is appropriate to provide two types of thresholds in this manner.

Note that a point cloud frame is constituted by the velocity point cloud obtained from the FMCW-LiDAR data of one frame.

The moving object/stationary object separation unit 211 passes the extracted stationary object velocity point cloud to the sensor velocity estimation unit 212 and the stationary object point cloud correction unit 213. In addition, the moving object/stationary object separation unit 211 passes the extracted moving object velocity point cloud to the moving object point cloud correction unit 214.

The sensor velocity estimation unit 212 estimates the sensor velocity indicating the velocity of the sensor unit 10 based on the stationary object point cloud passed from the moving object/stationary object separation unit 211 and the sensor position, orientation, and angular velocity passed from the sensor position/orientation estimation unit 210. A specific example of the estimation processing of the sensor velocity by the sensor velocity estimation unit 212 will be described below.

The sensor velocity estimation unit 212 passes the estimated sensor velocity to the stationary object point cloud correction unit 213 and the moving object/stationary object separation unit 211, and together with this operation, inputs the estimated sensor velocity to the moving object/stationary object separation unit 211. The sensor velocity estimation unit 212 passes the estimated sensor velocity to the transmission unit 201.

The stationary object point cloud correction unit 213 corrects the stationary object velocity point cloud using the sensor position, orientation, and angular velocity passed from the sensor position/orientation estimation unit 210 and the sensor velocity passed from the sensor velocity estimation unit 212. The moving object point cloud correction unit 214 corrects the moving object velocity point cloud by using the sensor position, orientation, and angular velocity passed from the sensor position/orientation estimation unit 210, the sensor velocity passed from the sensor velocity estimation unit 212, and information indicating the state of the moving object passed from the moving object state estimation unit 221 described below.

As described above, in the FMCW-LiDAR, the acquisition time of the measurement data at each measurement point in the frame varies depending on the position of the measurement point in the frame depending on the type of the scan pattern. The stationary object point cloud correction unit 213 and the moving object point cloud correction unit 214 estimate data of each point in a case where each point of the velocity point cloud in the frame is acquired at the same predetermined time, and correct the velocity point cloud in accordance with the estimation result.

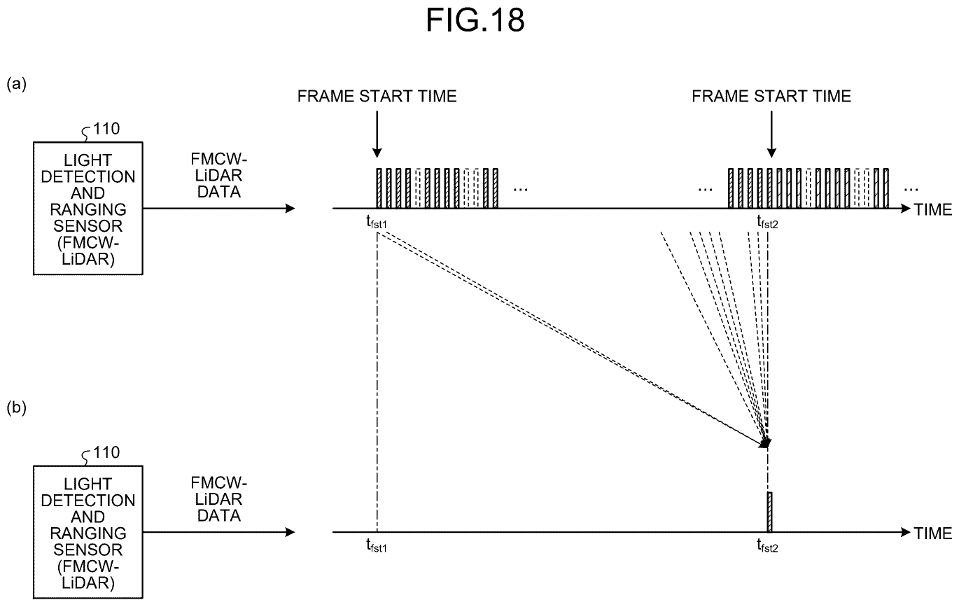

FIG. 18 is a schematic diagram schematically illustrating velocity point cloud correction processing according to the embodiment. In FIG. 6, a section (a) illustrates an example of an output timing of the FMCW-LiDAR data output from the light detection and ranging sensor 110. As illustrated in this figure, the FMCW-LiDAR data is output at constant time intervals from the frame start time t_{fst1} to the next frame start time t_{fst2}. Each point of the velocity point cloud based on the FMCW-LiDAR data has time information corresponding to the output timing of each data.

In the figure, data corresponding to the emission point 41 corresponding to the position where the objects 50a and 50b (refer to FIG. 13) and the like exist is indicated by a solid line (hatched). In addition, data corresponding to the emission point 41 corresponding to a position where no objects 50a and 50b exist is indicated by a dotted line. The data indicated by the dotted line indicates that nothing is actually detected as an object from the reception light signal.

In FIG. 18, section (b) schematically illustrates a state in which the FMCW-LiDAR data output from the light detection and ranging sensor 110 is corrected by the stationary object point cloud correction unit 213 and the moving object point cloud correction unit 214. The stationary object point cloud correction unit 213 and the moving object point cloud correction unit 214 estimate a value at a time serving as a reference for correction of each FMCW-LiDAR data from the frame start time t_{fst1} to the frame start time t_{fst2}, for example, at the frame start time t_{fst2}, based on the sensor position, orientation, and angular velocity, and the sensor velocity, for example. The stationary object point cloud correction unit 213 and the moving object point cloud correction unit 214 individually correct the stationary object velocity point cloud and the moving object velocity point cloud based on the estimation results.

More specifically, the stationary object point cloud correction unit 213 and the moving object point cloud correction unit 214 correct the time information of each point included in the stationary object velocity point cloud and the moving object velocity point cloud to the reference time. This eliminates the distortion of the point cloud caused by the self-motion or the moving object motion within the frame time span, making it possible, in the embodiment, to implement more universal use of the measurement result by the FMCW-LiDAR.

The stationary object point cloud correction unit 213 and the moving object point cloud correction unit 214 individually output the corrected stationary object velocity point cloud and moving object velocity point cloud. At this time, the stationary object point cloud correction unit 213 and the moving object point cloud correction unit 214 add a timestamp indicating time (frame start time t_{fst2} in the example of FIG. 18) to be a reference of correction to the corrected stationary object velocity point cloud and moving object velocity point cloud, and output the data with the timestamp. Here, the timestamp is a value determined for each frame.

In this manner, the stationary object point cloud correction unit 213 and the moving object point cloud correction unit 214 function as a correction unit that corrects at least one attribute value related to at least one point included in the velocity point cloud data based on an estimated value at a predetermined time-point.

The stationary object point cloud correction unit 213 and the moving object point cloud correction unit 214 respectively pass the stationary object velocity point cloud and the moving object velocity point cloud, corrected and having the timestamp added, to the transmission unit 201.

A specific example of correction processing based on the sensor position, orientation, and angular velocity and the sensor velocity by the stationary object point cloud correction unit 213 and the moving object point cloud correction unit 214 will be described below.

In each embodiment, this correction processing makes it possible to treat each point included in the stationary object velocity point cloud and the moving object velocity point cloud in one frame as a point acquired at the same time-point, leading to reduction of the load of processing on the stationary object velocity point cloud and the moving object velocity point cloud in the subsequent stage.

In addition, in the embodiment, the velocity point cloud is corrected based on values estimated based on the sensor position, orientation, angular velocity, and the sensor velocity. Therefore, in each embodiment, the velocity point cloud in which each point has the time information of the same time can be acquired by the FMCW-LiDAR data for one frame.

Note that the method of acquiring the velocity point cloud in which each point has the time information of the same time-point is not limited to the above-described method. For example, by using FMCW-LiDAR data of a plurality of frames and by performing linear interpolation based on data having correspondence of the emission point 41 among the plurality of frames, it is also possible to acquire a velocity point cloud in which each point has time information of the same time-point.

### 2-1-1-2. Application Section

Next, the application section of the signal processing unit 20 will be described.

In FIG. 17, the stationary object point cloud correction unit 213 passes the corrected stationary object velocity point cloud to the transmission unit 201 and the SLAM processing unit 220.

The SLAM processing unit 220 estimates and creates map information based on the sensor position, orientation, and angular velocity passed from the sensor position/orientation estimation unit 210 and the stationary object velocity point cloud passed from the stationary object point cloud correction unit 213. The map information includes the self-position of the sensor unit 10 and the map of the surrounding environment of the sensor unit 10. The SLAM processing unit 220 passes the created map information to the transmission unit 201.

In addition, the SLAM processing unit 220 passes the sensor position, orientation, and angular velocity passed from the sensor position/orientation estimation unit 210, and the velocity passed from the sensor velocity estimation unit 212, to the transmission unit 201.

The moving object point cloud correction unit 214 passes the corrected moving object velocity point cloud to the transmission unit 201 and the moving object state estimation unit 221.

For example, the moving object state estimation unit 221 separates each moving object included in one frame based on the corrected moving object velocity point cloud. For each separated moving object, the moving object state estimation unit 221 estimates the state of the moving object including the position, orientation, velocity, and angle of the moving object based on the corresponding moving object velocity point cloud. The moving object state estimation unit 221 passes moving object state information, being information indicating the estimated state of the moving object, to the transmission unit 201 and also passes the moving object state information to the moving object point cloud correction unit 214 and the 3D/2D transformer 222.

The 3D/2D transformer 222 transforms a moving object velocity point cloud, which is three-dimensional (3D) information, into two-dimensional (2D) data corresponding to image data output from the image sensor 120. More specifically, the 3D/2D transformer 222 transforms the 3D coordinates of the moving object velocity point cloud into 2D coordinates according to the coordinate system of the image data obtained by the image sensor 120. The 3D/2D transformer 222 preliminarily acquires calibration data such as a positional relationship of the reference coordinate system of the light detection and ranging sensor 110 with respect to the reference coordinate system of the image sensor 120 and internal parameters of each sensor in advance, and uses the prepared calibration data at the time of transformation. This makes it possible to obtain the position of each moving object indicated in the moving object velocity point cloud in the image data. The 3D/2D transformer 222 passes the point cloud, being a point cloud obtained by transforming the coordinates of the moving object velocity point cloud into 2D coordinates, to the ROI extraction unit 223.

Based on the point cloud in the 2D coordinates passed from the 3D/2D transformer 222, the ROI extraction unit 223 extracts the region of interest (ROI) from the image data passed from the image sensor 120 via the reception unit 200. More specifically, the ROI extraction unit 223 may extract, for example, a region corresponding to the point cloud in the 2D coordinates passed from the 3D/2D transformer 222 in the image data, as the region of interest. Incidentally, the positional relationship between the light detection and ranging sensor 110 and the image sensor 120 is known, the ROI extraction unit 223 can instantaneously calculate the correspondence relationship between the image data and the point cloud on the 2D coordinates.

The ROI extraction unit 223 passes the extracted image data of the region of interest to the transmission unit 201 and the image perception unit 226.

The image perception unit 226 performs image perception based on the image data of the region of interest passed from the ROI extraction unit 223, and outputs image meta-information (indicating that the subject is a person, subject name, or indicating the subject is a vehicle, etc.). For example, the image perception unit 226 may perform image perception using a learning model trained by machine learning based on image data using known images. The image meta-information output from the image perception unit 226 is passed to the transmission unit 201.

The transmission unit 201 transmits the sensor position, orientation, and angular velocity passed from the SLAM processing unit 220 and the sensor velocity to the information processing unit 30. In addition, the transmission unit 201 transmits, to the information processing unit 30, the sensor position, orientation, angular velocity, and sensor velocity passed from the SLAM processing unit 220, the map information, and the corrected stationary object velocity point cloud passed from the stationary object point cloud correction unit 213. Furthermore, the transmission unit 201 transmits the moving object velocity point cloud passed from the moving object point cloud correction unit 214 and the moving object state information passed from the moving object state estimation unit 221 to the information processing unit 30. Still further, the transmission unit 201 transmits the image meta-information passed from the image perception unit 226 to the information processing unit 30.

The transmission unit 201 adds a timestamp to each of the information and the point cloud described above and transmits the data with the timestamp to the information processing unit 30. Here, the timestamp added to each piece of information and the point cloud by the transmission unit 201 may be time-point information in units of one frame of scanning by the light detection and ranging sensor 110. As a specific example, with reference to FIG. 18 described above, information indicating the frame start time t_{fst2} serving as a reference of correction of the velocity point cloud may be added as a timestamp to each piece of information acquired in the period from the frame start time t_{fst1} to the next frame start time t_{fst2} in the scanning by the light detection and ranging sensor 110.

In this manner, the transmission unit 201 functions as an output unit that outputs the sensor state information, being information including the information indicating the position and orientation of the sensor unit, and the moving object state information, being information including the information indicating the position, orientation, and velocity of the moving object, which are generated based on the velocity point cloud data and the inertial measurement data.

The transmission unit 201 may selectively transmit, to the information processing unit 30, information or a point cloud in response to a request from the information processing unit 30 among the above-described information and point cloud. Furthermore, the transmission unit 201 may transmit each piece of the information and the point cloud described above to a transmission destination different from the information processing unit 30.

### 2-1-2. System Configuration

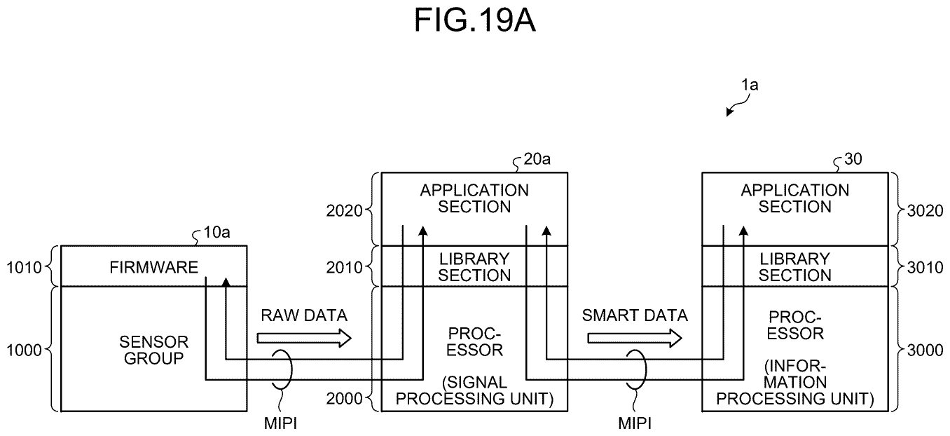

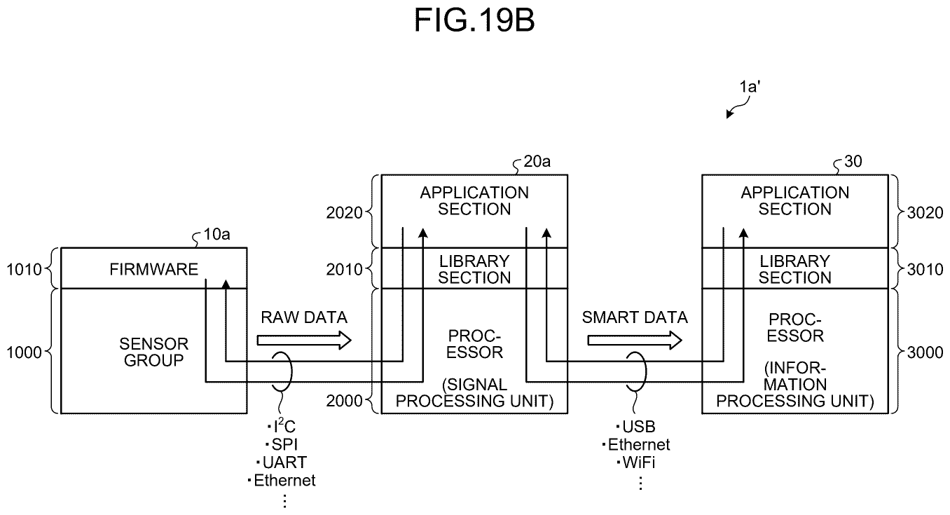

Next, a system configuration applicable to the first embodiment will be described with reference to FIGS. 19A and 19B. The configurations illustrated in FIGS. 19A and 19B are similarly applicable to modifications of the first embodiment described below, as well as to the second embodiment and the third embodiment.

FIG. 19A is a block diagram illustrating a hardware configuration of an example of a perception system 1a applicable to the first embodiment.

In FIG. 19A, a sensor unit 10a includes a sensor group 1000 and firmware 1010. The sensor group 1000 includes an IMU 100, a light detection and ranging sensor 110, and an image sensor 120.

The firmware 1010 may be a program for controlling the operation of the sensor group 1000. The firmware 1010 may control, for example, an interface (not illustrated) as hardware that controls input/output of data of each sensor included in the sensor group 1000 and an operation of the synchronization signal generator 130. For example, the interface may include memory that stores the firmware 1010 in advance and a processor that operates according to the firmware 1010 stored in the memory.

The signal processing unit 20a includes a processor 2000. The processor 2000 operates according to a program stored in memory (not illustrated), so as to implement the above-described library section 2010 and application section 2020. The processor 2000 may be, for example, an Image Signal Processor (ISP). The processor 2000 is not limited thereto, and may be a Digital Signal Processor (DSP) or a Central Processing Unit (CPU).

Furthermore, the configuration is not limited to this configuration, and a part or all of the units included in the library section 2010 and the application section 2020 described above can be implemented by hardware circuits that operate in cooperation with each other.

Similarly to the signal processing unit 20a, the information processing unit 30 includes, for example, a processor 3000 including an ISP. The processor 3000 operates according to a program stored in memory (not illustrated), so as to implement a library section 3010 and an application section 3020. The library section 3010 is a set of programs that provide individual functions in the information processing unit 30, and the application section 3020 is a set of programs that execute target processing using the functions provided by the library section 3010.

As an example, in a case where the information processing unit 30 is applied to the control of an autonomously operating robot (mobile body), the library section 3010 may include a function of outputting a control command for driving the robot. Furthermore, the application section 3020 may include a function of deciding the motion of the robot based on the map information, the motion meta-information, the image meta-information, and the like passed from the signal processing unit 20a. As another example, in a case where the information processing unit 30 is applied to a control system of a monitoring camera, the library section 3010 may include a function of outputting a control command for controlling the operation of the monitoring camera. In addition, the application section 3020 may include a function of performing judgment based on an image from a monitoring camera, motion meta-information passed from the signal processing unit 20a, image meta-information, and the like.

Not limited to this configuration, some or all of the units included in the library section 3010 and the application section 3020 can be implemented by hardware circuits that operate in cooperation with each other. Furthermore, a typical computer may be applied as the information processing unit 30.

In the example of FIG. 19A, the output (IMU data, FMCW-LiDAR data, image data) of each sensor included in the sensor group 1000 is output as RAW data in a predetermined format under the control of the firmware 1010, and is transmitted to the signal processing unit 20a by an interface (not illustrated). The signal processing unit 20a receives the RAW data transmitted from the sensor unit 10a by the reception unit 200 and passes the RAW data to the library section 2021.

The library section 2010 performs the above-described processing on the RAW data passed from the reception unit 200 and passes the processed RAW data to the application section 2020. The application section 2020 performs the above-described processing on the data passed from the library section 2010, and the transmission unit 201 adds a timestamp in units of frames to each piece of information and a point cloud generated by the processing and outputs the data with the timestamp. In the example of FIG. 19A, the output of the signal processing unit 20a is transmitted to the information processing unit 30 as SMART data.

The information processing unit 30 receives the SMART data transmitted from the signal processing unit 20a and passes the SMART data to the library section 3010.

The library section 3010 performs processing related to individual functions on the received SMART data and passes the data to the application section 3020. The application section 3020 performs predetermined processing on the data passed from the library section 3010 to generate output data. The data generated by the application section 3020 may be output from the information processing unit 30, for example.

The information processing unit 30 may generate a request for the signal processing unit 20a by the application section 3020, for example, and transmit the generated request to the signal processing unit 20a. For example, the application section 3020 may generate and transmit, to the signal processing unit 20a, a request for designating each piece of information that can be transmitted by the signal processing unit 20a using the transmission unit 201, necessary information from the point cloud, and the point cloud.

Similarly, the signal processing unit 20a may generate a request for the sensor unit 10a using the application section 2020, for example, and transmit the generated request to the sensor unit 10a. For example, the application section 2020 may generate and transmit a request for restricting the scanning range to the region of interest to the light detection and ranging sensor 110.

In the example of FIG. 19A, a Mobile Industry Processor Interface (MIPI) (registered trademark) is applied as an interface for data transmission from the sensor unit 10a to the signal processing unit 20a and data transmission from the signal processing unit 20a to the information processing unit 30. More specifically, a MIPI-Camera Serial Interface 2 (MIPI-CSI-2) may be applied as the interface.

Although the above has described an example in which an interface related to data transmission between the sensor unit 10a and the signal processing unit 20a and between the signal processing unit 20a and the information processing unit 30 is the MIPI, the interface is not limited to this example. In the embodiment, another interface may be applied as the interface related to the data transmissions. For example, as in a perception system 1a′ illustrated in FIG. 19B, the interface between the sensor unit 10a and the signal processing unit 20a may be implemented by applying a serial interface mainly used for device internal data communication, such as an Inter-Integrated Circuit (I²C), a Serial Peripheral Interface (SPI), or a Universal Asynchronous Receiver/Transmitter (UART), or a communication interface such as a Universal Serial Bus (USB) or Ethernet (registered trademark). Furthermore, the interface between the signal processing unit 20a and the information processing unit 30 may be implemented by applying an interface mainly used for device external communication, such as USB, Ethernet, or Wireless Fidelity (Wi-Fi) (registered trademark).

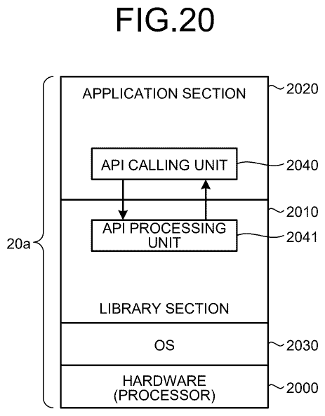

FIG. 20 is a diagram illustrating an example of an architecture of the signal processing unit 20a according to the embodiment. The signal processing unit 20a has a structure in which an operating system (OS) 2030 operates on a processor 2000 such as an ISP being a hardware component, and the library section 2010 and the application section 2020 operate on the OS 2030.

The application section 2020 includes an Application Programming Interface (API) calling unit 2040, while the library section 2010 includes an API processing unit 2041. The API calling unit 2040 calls a function of the library section 2010 in response to a request from the application section 2020. In response to the function call by the API calling unit 2040, the API processing unit 2041 returns a response by the function in the library section 2010 to the API calling unit 2040.

As an example, in a case where, in the application section 2020, the moving object state estimation unit 221 requests output of the moving object state information, the API calling unit 2040 requests the moving object velocity point cloud from the library section 2010. In response to this request, the API processing unit 2041 calls, in the library section 2010, the function of the moving object point cloud correction unit 214 and returns the moving object velocity point cloud output from the moving object point cloud correction unit 214 to the API calling unit 2040. The API calling unit 2040 passes the moving object velocity point cloud returned from the API processing unit 2041 to the moving object state estimation unit 221.

### 2-2. Processing According to First Embodiment

Next, the processing according to the first embodiment will be described in more detail. The processing described here is similarly applicable to each modification of the first embodiment and the second and third embodiments.

### 2-2-1. Measurement Technique Applicable to First Embodiment

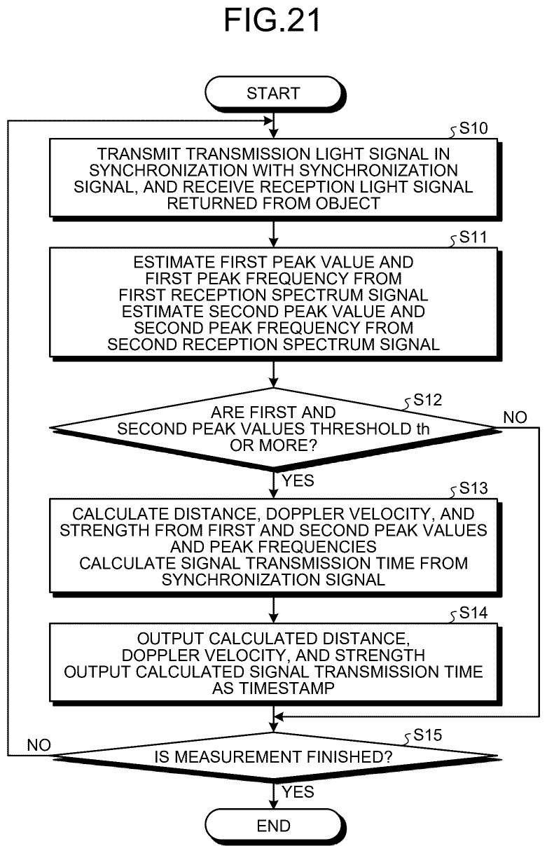

FIG. 21 is a flowchart of an example illustrating transmission light signal detection processing in the light detection and ranging sensor 110, applicable to the first embodiment.

In step S10, the light detection and ranging sensor 110 uses the light transmission/reception unit 112 to transmit (emit) a transmission light signal of laser light subjected to continuous frequency modulation in synchronization with a synchronization signal, and receives a reception light signal reflected on and returned from an object.

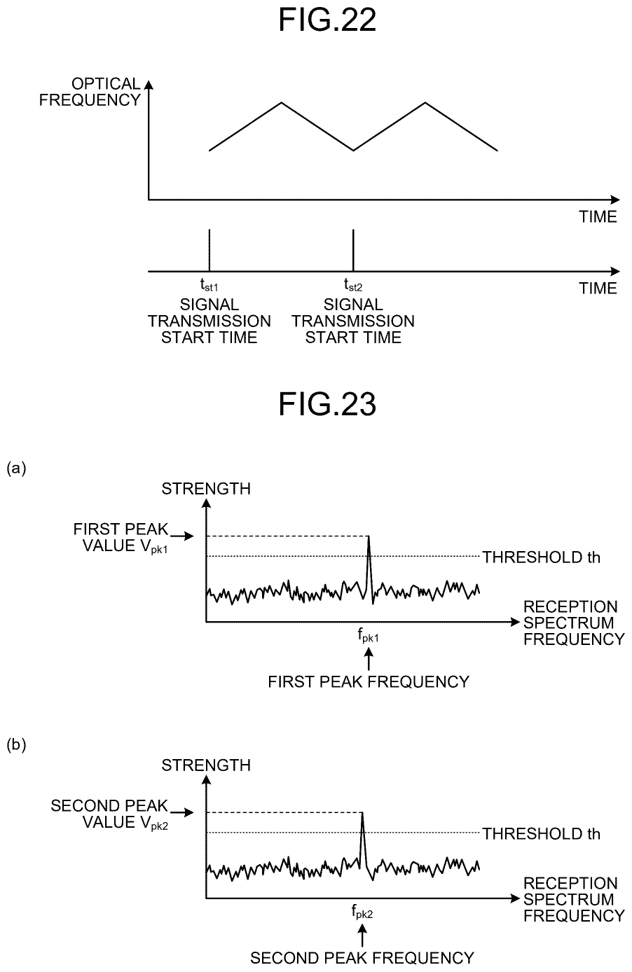

FIG. 22 is a schematic diagram for illustrating a transmission light signal transmitted by the light transmission/reception unit 112, applicable to the first embodiment. The upper diagram of FIG. 22 illustrates the relationship between the optical frequency of the transmission light signal and the time, while the lower diagram illustrates signal transmission start time tₜ in the upper diagram. In the upper diagram of FIG. 22, the vertical axis represents the optical frequency of the transmission light signal, and the horizontal axis represents time.

In FIG. 22, for example, the light transmission/reception unit 112 linearly increases and decreases the optical frequency of the laser light using a period from the signal transmission start time tai to the next signal transmission start time tₛₜ₂, and generates chirp light. The light transmission/reception unit 112 emits, as a transmission light signal, chirp light formed with a set of increasing and decreasing patterns of the optical frequency from the optical scan unit 111 toward a predetermined emission point. Similarly, at the signal transmission start time tₛₜ₂, the optical frequency of the transmission light signal is linearly raised and lowered according to the above-described period to generate chirp light, and the generated chirp light is emitted from the optical scan unit 111 toward a predetermined emission point as the transmission light signal. In the raster scan pattern, the transmission light signal is formed in this manner with continuously transmitted chirped light having a set of increasing and decreasing patterns of optical frequency.

Returning to FIG. 21, in the next step S11, the light detection and ranging sensor 110 uses the reception signal processing unit 113 to estimate a first peak value and a signal spectrum frequency (peak frequency) at the peak value from a first reception spectrum signal in the received reception light signal. In addition, the light detection and ranging sensor 110 uses the reception signal processing unit 113 to estimate a second peak value and a signal spectrum frequency (peak frequency) at the peak value from a second reception spectrum signal in the received reception light signal.

The first reception spectrum signal is a signal, being a partial signal out of the reception light signal, corresponding to the transmission light signal in the period in which the optical frequency increases. The second reception spectrum signal is a signal, being a partial signal out of the reception light signal, corresponding to the transmission light signal in the period in which the optical frequency decreases.

In step S12, the reception signal processing unit 113 of the light detection and ranging sensor 110 determines whether the first peak value and the second peak value estimated in step S11 are a threshold th or more.

FIG. 23 is a schematic diagram for illustrating determination processing on a reception light signal according to the first embodiment. In FIG. 23, section (a) is a diagram illustrating determination processing on the first reception spectrum signal, and section (b) is a diagram illustrating determination processing on the second reception spectrum signal. In the drawings in the sections (a) and (b), the vertical axis represents the strength of the reception light signal, and the horizontal axis represents the reception spectrum frequency.

In section (a) of FIG. 23, the strength of the first reception spectrum signal exceeds the threshold th at the signal spectrum frequency fₚₖ₁, and a first peak value Vₚₖ₁ is obtained. The signal spectrum frequency fₚₖ₁ at which the strength of the first reception spectrum signal indicates the first peak value Vₚₖ₁ is set as a first peak frequency.

Similarly, in section (b) of FIG. 23, the strength of the second reception spectrum signal exceeds the threshold th at a signal spectrum frequency fₚₖ₂, and a second peak value Vₚₖ₂ is obtained. The signal spectrum frequency fₚₖ₂ at which the strength of the second reception spectrum signal indicates the second peak value Vₚₖ₂ is set as a second peak frequency.

Returning to the description of FIG. 21. In step S12, in a case where the reception signal processing unit 113 has determined that at least one of the first peak value Vₚₖ₁ and the second peak value Vₚₖ₂ is less than the threshold th (step S12, “No”), the processing proceeds to step S15. In contrast, when having determined that each of the first peak value Vₚₖ₁ and the second peak value Vₚₖ₂ is the threshold th or more (step S12, “Yes”), the reception signal processing unit 113 proceeds to the processing to step S13.

In step S13, based on the first peak value Vₚₖ₁ and the second peak value Vₚₖ₂ and the signal spectrum frequencies fₚₖ₁ and fₚₖ₂ having the first peak value Vₚₖ₁ and the second peak value Vₚₖ₂, the reception signal processing unit 113 calculates a distance to the object, the Doppler velocity with respect to the object, and the strength of the reception light signal. In addition, the reception signal processing unit 113 calculates a signal transmission start time tₛₜ₁ based on the synchronization signal.

The emission point 41 corresponding to the reception light signal in which each of the first peak value Vₚₖ₁ and the second peak value Vₚₖ₂ is the threshold th or more is set as a detection point at which the object has been detected.

In the next step S14, the reception signal processing unit 113 outputs the distance, the Doppler velocity, and the strength calculated in step S13. In addition, the reception signal processing unit 113 outputs the signal transmission start time calculated in step S13 as a type stamp for each measurement (for each emission point).

The transmission unit 115 receives the distance, the Doppler velocity, the strength, and the timestamp, being data output from the reception signal processing unit 113. The transmission unit 115 adds a timestamp to the received distance, Doppler velocity, and strength, and outputs the data with the timestamp as FMCW-LiDAR data from the light detection and ranging sensor 110.

In the next step S15, the light detection and ranging sensor 110 determines whether the measurement has been completed. For example, the light detection and ranging sensor 110 may determine whether the measurement has been finished in accordance with a control signal (not illustrated) input from the outside to the sensor unit 10. When having determined that the measurement is finished, the light detection and ranging sensor 110 finishes a series of processes according to the flowchart of FIG. 22.

In contrast, when having determined in step S15 that the measurement has not been finished, the light detection and ranging sensor 110 returns the processing to step S10 and executes processing for the next emission point.

The determination processing in step S12 in the flowchart of FIG. 21 will be described using a specific example.

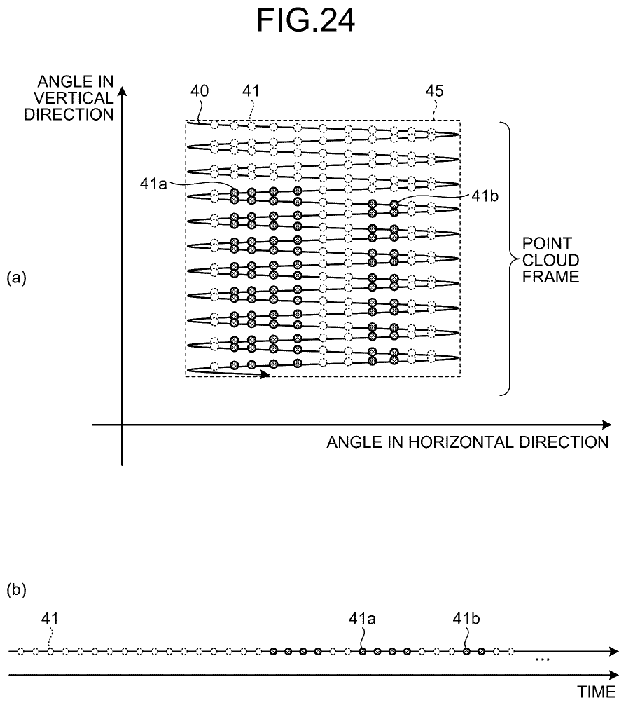

FIG. 24 is a schematic diagram illustrating an example of data output in a case where the light detection and ranging sensor 110 according to the first embodiment performs scanning with a raster scan pattern. In FIG. 24, section (a) corresponds to FIG. 13 described above, and the vertical axis indicates the angle in the vertical direction of scanning and the horizontal axis indicates the angle in the horizontal direction of scanning. Section (b) illustrates an example in which the FMCW-LiDAR data output from the light detection and ranging sensor 110 corresponding to each emission point 41 is arranged in time series. Furthermore, the emission points 41a and 41b illustrated in the figure as solid points are, for example, emission points corresponding to positions where the objects 50a and 50b (refer to FIG. 4) exist, and reflected light, that is, the light reflected by the objects 50a and 50b is returned as a reception light signal.

The light detection and ranging sensor 110 uses the optical scan unit 111 to scan between the upper end and the lower end of the angular range 45 according to the scanning line 40 folded, within a predetermined angular range 45, at both ends in the horizontal direction of the angular range 45. Each of the emission points 41, 41a, and 41b within the angular range 45 constitutes a point cloud frame.

As illustrated in section (b) of FIG. 24, the output data of each emission point 41 is output at predetermined time intervals, for example, in accordance with the emission timing of the transmission light signal. In this case, the emission points 41 (indicated by dotted circles in the figure) other than the emission points 41a and 41b corresponding to the positions where the objects 50a and 50b exist can be considered as points where there is no reception, in the light detection and ranging sensor 110, of light signal corresponding to the transmission light signal, or the reception light signal that has been received is noise.

Referring to FIG. 23, for example, at the emission points 41a and 41b, the first peak value Vₚₖ₁ and the second peak value Vₚₖ₂ at which the strength of the reception light signal is the threshold th or more are obtained. Therefore, according to the determination in step S12 in the flowchart of FIG. 21 (step S12, “Yes”), the processing proceeds to step S13.

On the other hand, at the emission point 41 indicated by a dotted circle in FIG. 24, at least one of the first peak value Vₚₖ₁ and the second peak value Vₚₖ₂ of the strength is not clearly obtained or is a value less than the threshold th. Therefore, according to the determination in step S12 in the flowchart of FIG. 21 (step 512, “No”), the processing proceeds to step 515.

In this manner, the processing of steps S13 and S14 in the flowchart of FIG. 21 is executed at the emission points 41a and 41b corresponding to the positions where the objects 50a and 50b exist, among the emission points included in the point cloud frame. On the other hand, at the emission points 41 indicated by dotted circles in the figure other than the emission points 41a and 41b, among the emission points included in the point cloud frame, the processing of steps S13 and S14 is canceled, and the processing for the next emission point is executed.

### 2-2-2. Data Structure Example According to First Embodiment

Next, a data structure example according to the first embodiment will be described. The following will describe, in particular, a data structure example regarding each data transmitted from the sensor unit 10a to the signal processing unit 20a.

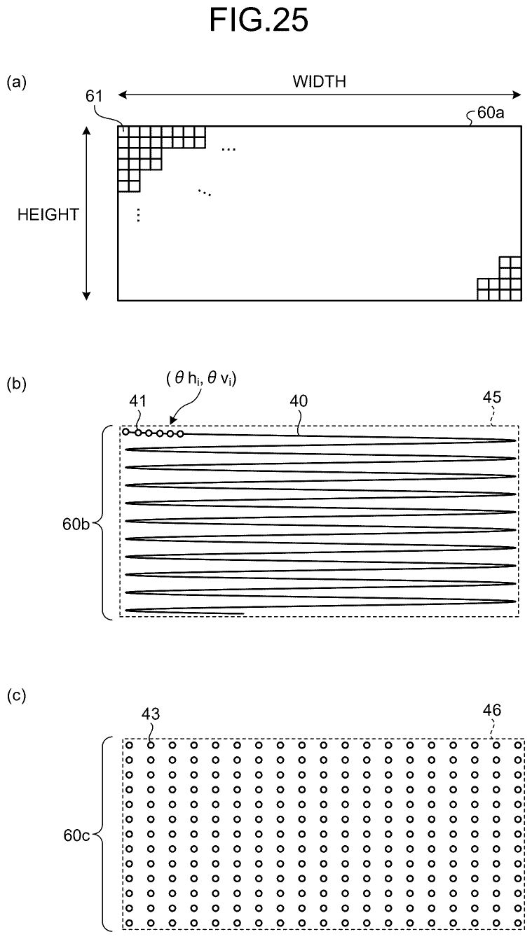

FIG. 25 is a schematic diagram for illustrating a frame definition applicable to the embodiment. In FIG. 25, section (a) illustrates an example of a frame based on image data output from the image sensor 120. Sections (b) and (c) of FIG. 25 each illustrate an example of a frame based on the FMCW-LiDAR data output from the light detection and ranging sensor 110. Here, section (b) illustrates an example of a raster scan pattern used in raster scan, and section (c) illustrates an example of a dot scan pattern used in dot scan.

The raster scan is implemented by a mechanical mirror scanner, for example. The dot scan is implemented by, for example, a beam steering device such as an optical phase array (OPA) or a light beam switching element.

In the image data illustrated in section (a) of FIG. 25, a set of pixels 61 including information of respective colors of red (R), green (G), and blue (B) constitutes a frame 60a. The size of the frame 60a is represented by the number of pixels 61 in the width direction and the height direction. Each pixel 61 is arranged in a matrix array corresponding to each pixel included in the effective pixel region of the pixel array.

In the FMCW-LiDAR data according to the raster scan pattern illustrated in section (b) of FIG. 25, the emission points 41 within the predetermined angular range 45 constitute a frame (point cloud frame) 60b. In the raster scan pattern, as described above, scanning is performed according to the scanning line 40 folded back at both ends in the horizontal direction of the angular range 45. The position of each emission point 41 on the scanning line 40 is represented by the scanning angles (horizontal angle θhᵢ, vertical angle θvᵢ) in the horizontal and vertical directions of the transmission light signal from the optical scan unit 111.

In the raster scan pattern, as described above, chirp light by a set of rise and fall of the optical frequency is continuously transmitted, forming a transmission light signal. Each emission point 41 illustrated in section (b) of FIG. 25 may be defined corresponding to, for example, a scanning angle (horizontal angle θhᵢ and vertical angle θvᵢ) at signal transmission start time-points tₛₜ₁, tₛₜ₂, . . . at which the optical frequency starts to rise in the chirp light.

In the FMCW-LiDAR data according to the dot scan pattern illustrated in section (c) of FIG. 25, the individual emission points 43 within a predetermined scanning range 46 constitute a frame (point cloud frame) 60c. In the dot scan pattern, the chirp light is completed for each emission point 43. That is, the transmission light signal is transmitted for each emission point 43. Therefore, the position of each emission point 43 may be represented by an xy coordinate in the scanning range 46.

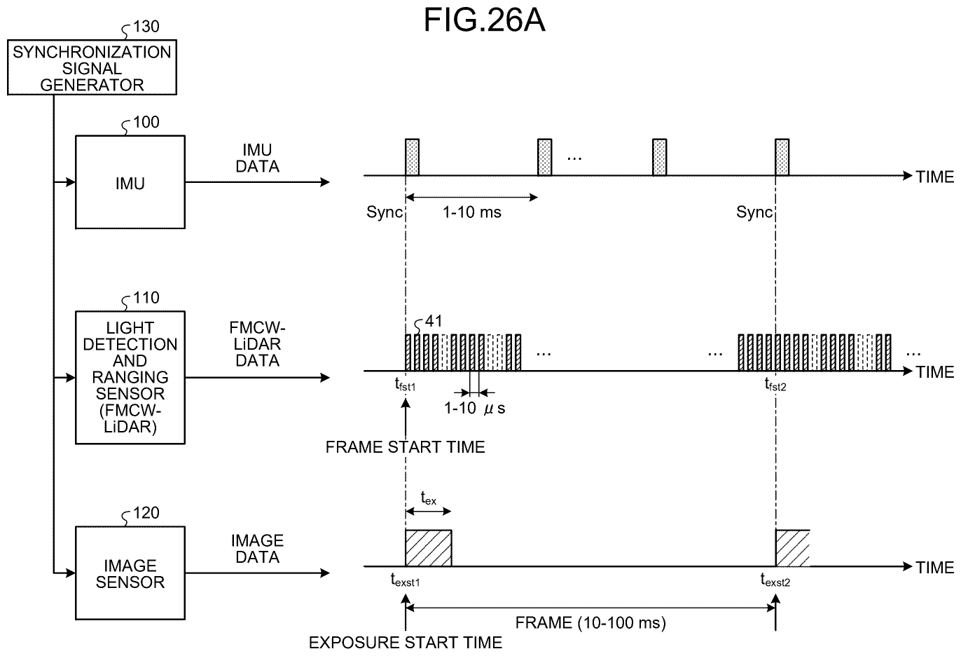

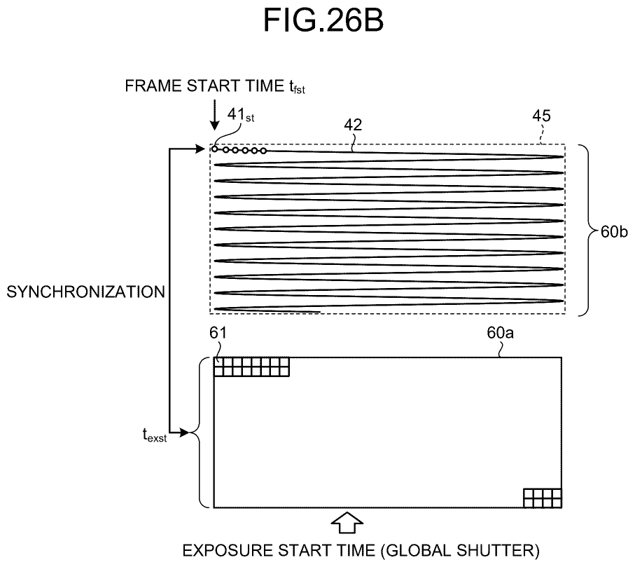

FIGS. 26A and 26B are schematic diagrams for illustrating output timing of each data by the sensor unit 10a according to the first embodiment. Here, it is assumed that the image sensor 120 performs exposure by a global shutter system that simultaneously exposes all pixels.

FIG. 26A illustrates an example of measurement timing by each sensor of the sensor unit 10a according to the first embodiment. In the sensor unit 10a, the IMU 100, the light detection and ranging sensor 110, and the image sensor 120 each perform a measurement operation in synchronization with a synchronization signal Sync supplied from the synchronization signal generator 130, and outputs data. Note that the synchronization signal Sync is supposed to be output from the synchronization signal generator 130 in a period corresponding to one frame period of image data.

The image sensor 120 starts exposure at the exposure start time tₑₓₛₜ₁ in synchronization with the synchronization signal Sync, and continues exposure during an exposure period tₑₓ. At an exposure start time tₑₓₛₜ₂ after one frame period of the image data, exposure of the next one frame is started. The frame period of the image data is about 10 ms (milliseconds) to 100 ms. For example, image data of one frame by exposure started from the exposure start time tₑₓₛₜ₁ is output during a period from the end of the exposure period tₑₓ to the next exposure start time tₑₓₛₜ₂.

In accordance with the synchronization signal Sync, the light detection and ranging sensor 110 starts scanning of one frame at each point of frame start time t_{fst1}, t_{fst2}, . . . synchronized with the points of exposure start time tₑₓₛₜ₁, tₑₓₛₜ₂, . . . , for example. FIG. 26B schematically illustrates a relationship between the exposure start time tₑₓₛₜ in the image sensor 120 and the frame start time t_{fst} in the light detection and ranging sensor 110. As illustrated in FIG. 26B, the emission timing of the transmission light signal at an emission point 41st at the head of the frame 60b by the light detection and ranging sensor 110 is synchronized with the exposure start time tₑₓₛₜ of each pixel 61 in the frame 60a by the image sensor 120.

In the light detection and ranging sensor 110, the emission interval of the transmission light signal at each emission point 41 is set to about 1 μs (microsecond) to several 100 μs, for example. The FMCW-LiDAR data is output in accordance with the emission timing of each emission point 41.

Here, the emission point 41 illustrated with a dotted line in the drawing indicates an emission point at which the transmission light signal has not been reflected by an object or the like and thus the reception light signal has not been received, or an emission point at which the strength of the reception light signal is less than the threshold th, for example. In addition, an emission point 41 illustrated with a solid line (hatched) in the drawing indicates, for example, an emission point at which a transmission light signal has been reflected by an object or the like and thus a reception light signal having an intensity being the threshold th or more has been received. Accordingly, the FMCW-LiDAR data is actually output only at the timing corresponding to the emission point 41 illustrated with the hatched solid line in the figure.

The IMU 100 outputs the IMU data in synchronization with the head of the frame of the image data and the FMCW-LiDAR data in accordance with the synchronization signal Sync. The IMU 100 may output the IMU data according to, for example, a signal obtained by multiplying the synchronization signal Sync in a period from the synchronization signal Sync to the next synchronization signal Sync. The output interval of the IMU data in the IMU 100 is set to about 1 ms to 1000 ms, for example.

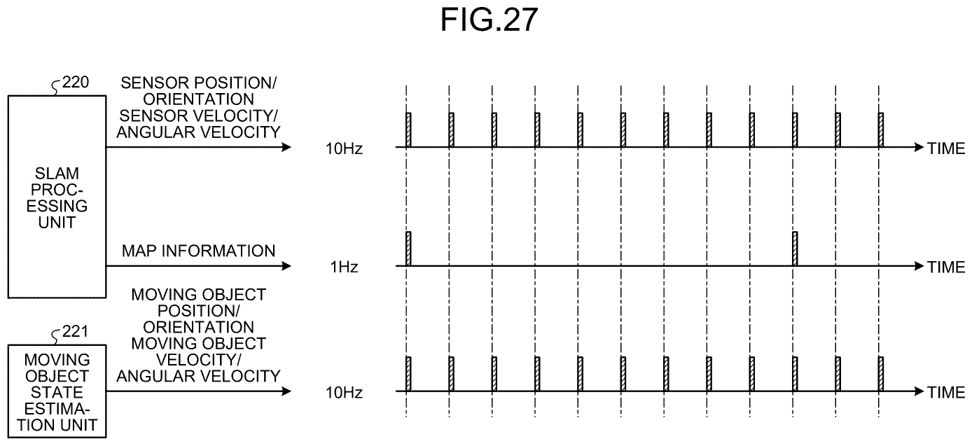

FIG. 27 is a schematic diagram illustrating an example of an output rate of each data according to the first embodiment. Among the data output from the SLAM processing unit 220, the sensor position/orientation, and the sensor velocity/angular velocity data, as well as the moving object state data (moving object position/orientation, and moving object velocity/angular velocity) output from the moving object state estimation unit 221, may have an output rate of about 10 Hz, for example, in accordance with the output timing of the image sensor 120. In this case, each data is output every 0.1 seconds.

On the other hand, the generation processing of map information in the SLAM processing unit 220 includes processing of combining with reference to the map information having a large information capacity stored in the map storage unit. Therefore, the output rate of the map information is typically lower than the output rate of each data measured by the above-described sensor. Accordingly, in the example of FIG. 27, the output rate of map information is set to about 1 Hz, which is lower than the output rate of each data measured by the sensor or the moving object state data.

Note that the data including the map information output from the SLAM processing unit 220 and the moving object state data output from the moving object state estimation unit 221 are preferably synchronized with each other. In addition, each output rate illustrated in FIG. 27 is an example, and is not limited to these values.

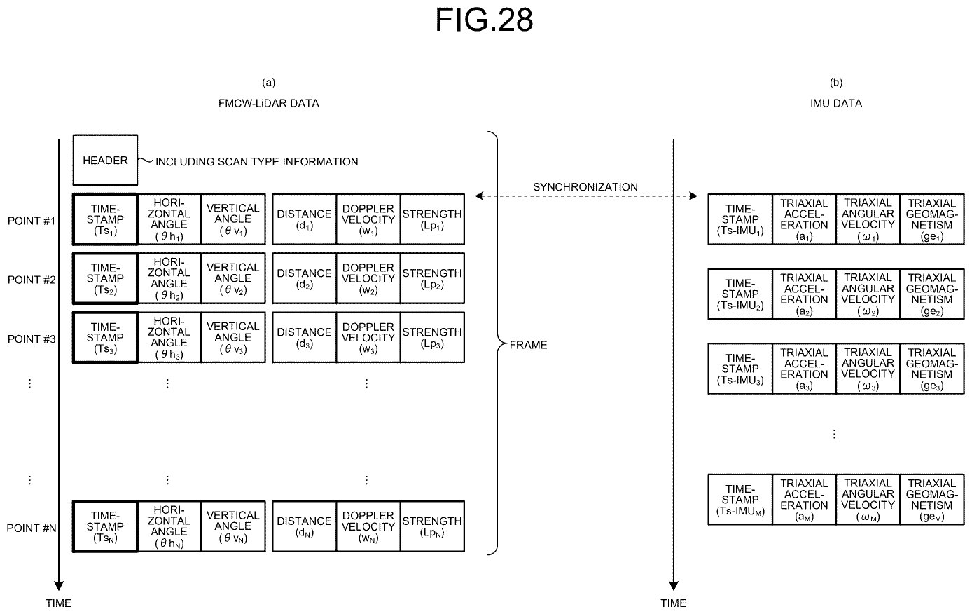

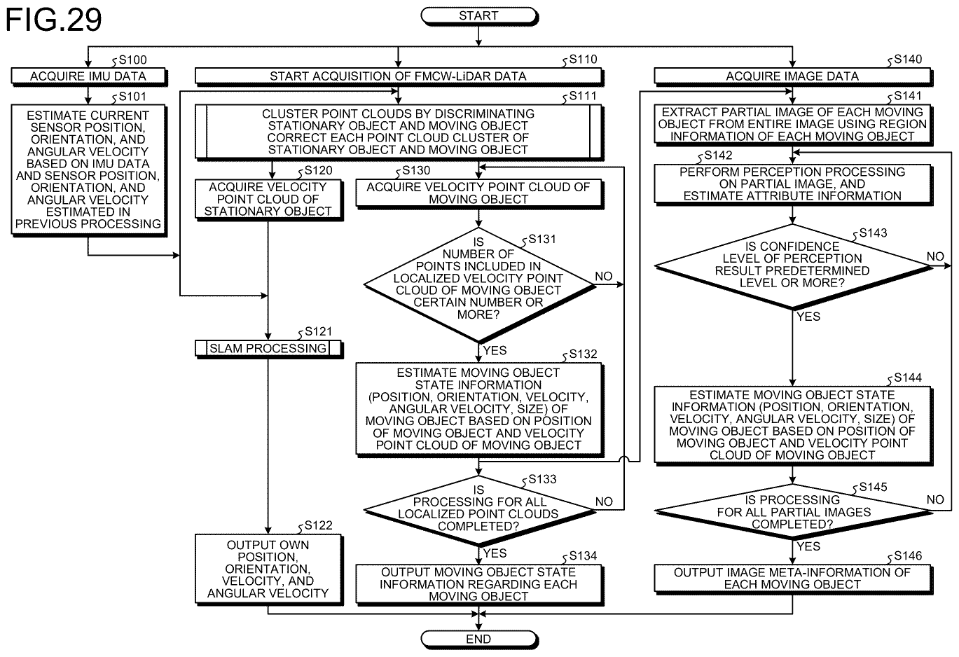

FIG. 28 is a schematic diagram illustrating an example of a data structure of FMCW-LiDAR data and IMU data output from the sensor unit 10 according to the embodiment. In FIG. 28, a section (a) illustrates an example of a data structure of FMCW-LiDAR data, and a section (b) illustrates an example of a data structure of IMU data. In both sections (a) and (b), time is represented in the vertical direction on the figure.

In section (a) of FIG. 28, in the FMCW-LiDAR data, for example, a header is transmitted at the head of the frame, and then, data corresponding to each emission point is sequentially transmitted following the header. Note that, in the figure, each emission point is indicated as point #1, point #2, . . . , and point #N. Hereinafter, each emission point is described as point #1, point #2, . . . , and point #N as appropriate. In addition, in a case where it is not necessary to particularly distinguish point #1, point #2, . . . , to point #N, the description will be represented by point #i, with each number using the subscript in the figure also represented by i (similar applies to section (b)).

The header includes at least scan type information. The scan type information may be information indicating a scanning method such as raster scanning, multi-layer scanning, or dot scanning.

The data of point #i includes a timestamp Tsᵢ and a scanning angle (horizontal angle θhᵢ and vertical angle θvᵢ) as information related to scanning, and includes a distance dᵢ, a Doppler velocity wᵢ, and strength Lpᵢ as measurement data obtained based on the reception light signal. The timestamp Tsᵢ indicates the time at which the transmission light signal is transmitted at the point #i.

In addition, each point #i may be a point at which the strength of the reception light signal described above has increased to the threshold th or more in the first and second reception spectrum signals. In the embodiment, since the timestamp Tsᵢ is added to the data of each point #i, it is possible to easily grasp the basis of the data of each point i included in the FMCW-LiDAR data of one frame, that is, which emission point the data as a basis of the reception light signal corresponds to.

Furthermore, there are cases where processing in the signal processing unit 20 for the data of each point #i (for example, correction processing by the stationary object point cloud correction unit 213 and the moving object point cloud correction unit 214) differ depending on the scanning method. In the embodiment, the header transmitted at the head of the frame includes scan type information indicating the scanning method. This makes it possible for the signal processing unit 20 to perform processing according to the scanning method on the FMCW-LiDAR data.

In section (b) of FIG. 28, in the IMU data, a timestamp Ts-IMUᵢ, a triaxial acceleration ai, a triaxial angular velocity ωᵢ, and a triaxial geomagnetism geᵢ are sequentially transmitted at each measurement timing in the IMU 100. In the IMU data, the first data of the frame to which the timestamp Ts-IMUᵢ is added is synchronized with, for example, the data of the first point #1 in the FMCW-LiDAR data illustrated in section (a).

Here, the IMU 100 performs measurement at constant time intervals. Therefore, for example, by synchronizing the first data of the frame with the data of the point #1 of the FMCW-LiDAR data, it is possible to estimate the measurement timing of each data and omit each timestamp Ts-IMUᵢ.

### 2-2-3. Details of Processing According to First Embodiment

Next, the processing according to the first embodiment will be described in more detail.

FIG. 29 is a flowchart of an example illustrating processing by the signal processing unit 20a according to the first embodiment.

In the flowchart of FIG. 29, steps S100 to S101 indicate processing related to IMU data, steps S110 to S134 indicate processing related to FMCW-LiDAR data, and steps S140 to S146 indicate processing related to image data. Note that the processing according to the flowchart of FIG. 29 may be repeated for each measurement of one frame by the light detection and ranging sensor 110, for example.

In FIG. 29, the signal processing unit 20a acquires, in step S100, IMU data from the IMU 100 by the reception unit 200. In the next step S101, the signal processing unit 20a uses the sensor position/orientation estimation unit 210 to estimate the current sensor position, orientation, and angular velocity based on the IMU data acquired in step S100 and the sensor position, orientation, and angular velocity acquired in the previous processing. The sensor position/orientation estimation unit 210 passes the estimated sensor position, orientation, and angular velocity to the processing of step S121, and proceeds to the processing of step S121.

In step S110, the signal processing unit 20a uses the reception unit 200 to acquire FMCW-LiDAR data from the light detection and ranging sensor 110. In the next step S111, the signal processing unit 20a uses the moving object/stationary object separation unit 211 to discriminate and cluster the velocity point cloud included in the FMCW-LiDAR data, and then extracts a point cloud cluster of each of the stationary object and the moving object. The signal processing unit 20a corrects the extracted point cloud cluster of the stationary object by the stationary object point cloud correction unit 213. Furthermore, the signal processing unit 20a uses the moving object point cloud correction unit 214 to correct the extracted point cloud cluster of the moving object.

Hereinafter, steps S120 to S122 are a series of processing for the point cloud cluster of the stationary object. In addition, steps S130 to S134 are a series of processing for the point cloud cluster of the moving object.

In step S120, the signal processing unit 20a uses the stationary object point cloud correction unit 213 to acquire the stationary object velocity point cloud based on the point cloud cluster of the stationary object discriminated, clustered, and corrected in step S111. In the next step S121, the signal processing unit 20a uses the SLAM processing unit 220 to execute the SLAM processing using the stationary object velocity point cloud acquired in step S12 and the sensor position, orientation, and angular velocity passed from the sensor position/orientation estimation unit 210 in step S101.

In the next step S122, the signal processing unit 20a uses the transmission unit 201 to output its own position, orientation, velocity, and angular velocity acquired by the SLAM processing in step S121.

In step S130, the signal processing unit 20a uses the moving object point cloud correction unit 214 to acquire one velocity point cloud out of the point cloud cluster (velocity point cloud cluster) of each moving object discriminated, clustered, and corrected in step S111. The acquired velocity point cloud is a local velocity point cloud in which a velocity point cloud of moving objects locally exists. The local velocity point cloud is formed for each moving object corresponding to each moving object, for example.

In the next step S131, the signal processing unit 20a uses the moving object state estimation unit 221 to determine whether the number of included points is a certain number or more for the local point cloud of the moving object acquired in step S130. When having determined that the number of points included in the target local point cloud is less than the certain number (step S131, “No”), the moving object state estimation unit 221 returns the processing to step S130 and executes the processing on the next local point cloud. In contrast, when having determined that the number of points included in the target local point cloud is the certain number or more in step S131 (step S131, “Yes”), the moving object state estimation unit 221 proceeds to the processing of step S132.

In step S132, the moving object state estimation unit 221 estimates the moving object state information of the moving object based on the position of the moving object corresponding to the local velocity point cloud acquired in step S130 and the velocity point cloud of the moving object. Here, the moving object state information relates to region information indicating a region of a moving object in the local velocity point cloud, and may include, for example, a position, orientation, a velocity, an angular velocity, and a size of the moving object.

The signal processing unit 20a uses the 3D/2D transformer 222 to transform the moving object state information estimated by the moving object state estimation unit 221 in step S132 into 2D data, passes the obtained 2D data to the processing of step S141, and then proceeds to the processing of step S133.

In step S133, the signal processing unit 20a uses the moving object state estimation unit 221 to determine whether the processing for all the localized point clouds by the point cloud cluster of the moving object extracted and corrected in step S111 is completed. When having determined that the processing is not completed (step S133, “No”), the moving object state estimation unit 221 returns the processing to step S130 and executes the processing on the next local point cloud. In contrast, when the moving object state estimation unit 221 has determined that the processing for all the localized point clouds is completed in step S133 (step S133, “Yes”), the processing proceeds to step S134.

In step S134, the signal processing unit 20a uses the transmission unit 201 to output the moving object state information of each moving object acquired in the processing of steps S130 to S133.

In step S140, the signal processing unit 20a uses the reception unit 200 to acquire image data from the image sensor 120. In the next step S141, the signal processing unit 20a uses the ROI extraction unit 223 to extract a partial image of each moving object from the entire image based on the image data acquired in step S140 by using the region information of each moving object based on the 2D data, being data obtained by converting the moving object state information and passed from the moving object state estimation unit 221 in step S132.

In the next step S142, the signal processing unit 20a uses the image perception unit 226 to execute perception processing on one partial image among the partial images extracted in step S141, and estimates attribute information related to the partial image. In the next step S143, the signal processing unit 20a uses the image perception unit 226 to determine whether the confidence level of the perception result of the perception processing in step S142 is a certain value or more.

In step S143, when the image perception unit 226 has determined that the confidence level of the perception result is less than the certain value (step S143, “No”), the signal processing unit 20a returns the processing to step S142 and executes the processing on the next partial image. In contrast, when the image perception unit 226 has determined that the confidence level of the perception result is the certain value or more in step S143 (step S143, “Yes”), the signal processing unit 20a proceeds to the processing of step S144.

In step S144, the signal processing unit 20a uses the image perception unit 226 to estimate the moving object state information of the moving object based on the position of the moving object and the velocity point cloud of the moving object, corresponding to the partial image for which the perception processing has been executed in step S142. Here, the moving object state information relates to region information indicating a region of a moving object in the local velocity point cloud, and may include, for example, a position, orientation, a velocity, an angular velocity, and a size of the moving object.

In the next step S145, the signal processing unit 20a uses the image perception unit 226 to determine whether the processing for all the partial images extracted in step S141 is completed. When having determined that the processing for all the partial images is not completed (step S145, “No”), the image perception unit 226 returns the processing to step S142 and executes the processing for the next partial image. In contrast, when the image perception unit 226 has determined that the processing for all the partial images is completed (step S145, “Yes”), the signal processing unit 20a proceeds to the processing of step S146.

In step S146, the signal processing unit 20a uses the transmission unit 201 to output the attribute information of each partial image estimated by the image perception unit 226 as image meta-information of each moving object corresponding to each partial image.

The processing of steps S100, S110, and S140 described above may be executed in synchronization with the start timing of the measurement processing of one frame by the light detection and ranging sensor 110, for example. In addition, the data output in steps S122, S134, and S146 may be output in synchronization with each other at the output rate described with reference to FIG. 27, for example. In this case, the image meta-information output by the image perception unit 226 may be output at an output timing corresponding to the map information, for example. Alternatively, the image meta-information may be output at an output timing corresponding to another piece of information.

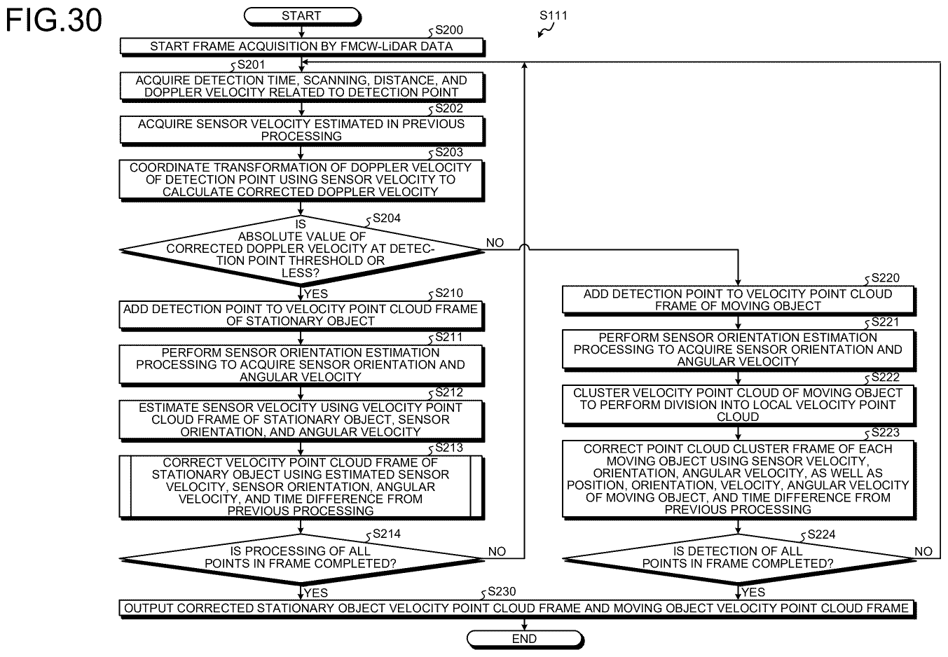

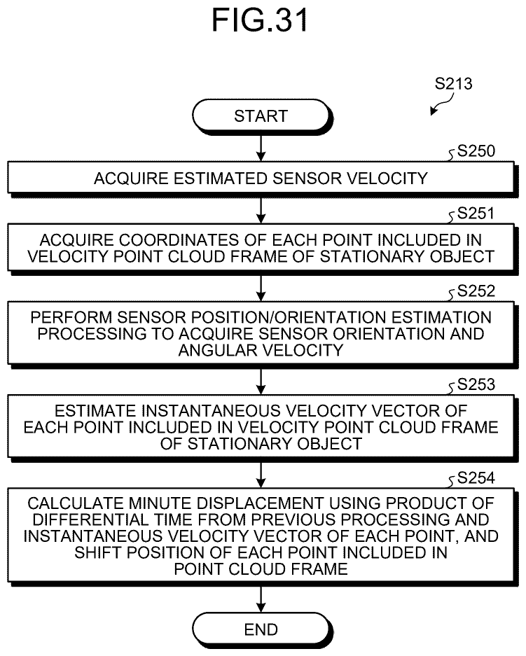

FIG. 30 is a flowchart of an example illustrating processing related to point cloud correction in the signal processing unit 20a according to the first embodiment. The processing in FIG. 30 and FIG. 31 described below is executed for each measurement processing of one frame by the light detection and ranging sensor 110. The processing of FIG. 30 is similarly applicable to each modification of the first embodiment, as well as the second and third embodiments.

In step S200, the signal processing unit 20a starts acquisition of a frame based on the FMCW-LiDAR data output from the light detection and ranging sensor 110.

In the next step S201, the signal processing unit 20a uses the moving object/stationary object separation unit 211 to acquire the distance and the Doppler velocity, as well as the detection time, and the scanning angle, regarding the detection point at which the reception light signal has been detected. In the next step S202, the signal processing unit 20a uses the moving object/stationary object separation unit 211 to acquire the sensor velocity estimated by the sensor velocity estimation unit 212 in the previous processing. In the next step S203, the signal processing unit 20a uses the moving object/stationary object separation unit 211 to perform coordinate transformation on the Doppler velocity at the detection point by using the sensor velocity acquired in step S202, and calculates the corrected Doppler velocity.

In the next step S204, the signal processing unit 20a uses the moving object/stationary object separation unit 211 to determine whether the absolute value of the corrected Doppler velocity at the detection point calculated in step S203 is a threshold or less.

When the moving object/stationary object separation unit 211 has determined that the absolute value of the corrected Doppler velocity at the detection point is the threshold or less (step S204, “Yes”), the signal processing unit 20a proceeds to the processing of step S210, being a step related to the processing of the stationary object point cloud.

In step S210, the signal processing unit 20a uses the stationary object point cloud correction unit 213 to add the detection point to the velocity point cloud frame of the stationary object. In the next step S211, the signal processing unit 20a uses the stationary object point cloud correction unit 213 to acquire the sensor orientation and the angular velocity estimated by the sensor position/orientation estimation unit 210. In the next step S212, the signal processing unit 20a uses the sensor velocity estimation unit 212 to estimate the sensor velocity by using the velocity point cloud frame of the stationary band, the sensor orientation, and the angular velocity.

In the next step S213, the signal processing unit 20a uses the stationary object point cloud correction unit 213 to correct the velocity point cloud frame of the stationary object by using the sensor velocity estimated in step S212, the sensor orientation and the angular velocity acquired in step S211, and a time difference from the previous processing.

In the next step S214, the signal processing unit 20a determines whether the processing for all the points in the frame has been completed by the stationary object point cloud correction unit 213. When the stationary object point cloud correction unit 213 has determined that the processing is completed (step S214, “Yes”), the signal processing unit 20a proceeds to the processing of step S230. In contrast, when having determined that the processing is not completed by the stationary object point cloud correction unit 213 (step S214, “No”), the signal processing unit 20a returns the processing to step S201 and executes the processing for the next detection point in the frame based on the FMCW-LiDAR data.

When the moving object/stationary object separation unit 211 has determined, in step S204 described above, that the absolute value of the corrected Doppler velocity at the detection point exceeds the threshold (step S204, “No”), the signal processing unit 20a proceeds to the processing of step S220, being a step related to the processing of the moving object point cloud.

In step S220, the signal processing unit 20a uses the moving object point cloud correction unit 214 that corrects the moving object point cloud to add the detection point to the velocity point cloud frame of the moving object. In the next step S221, the signal processing unit 20a uses the moving object point cloud correction unit 214 to acquire the sensor orientation and the angular velocity estimated by the sensor position/orientation estimation unit 210.

In the next step S212, the signal processing unit 20a uses the moving object point cloud correction unit 214 to perform clustering on the velocity point cloud of the moving object, and divides the velocity point cloud of the moving object into local velocity point clouds. That is, the signal processing unit 20a uses the moving object point cloud correction unit 214 to divide the velocity point cloud included in the velocity point cloud frame of the moving object into the velocity point cloud of each moving object.

In the next step S223, the signal processing unit 20a uses the moving object point cloud correction unit 214 to correct the point cloud cluster frame (local velocity point cloud) of each moving object in the velocity point cloud frame by using the sensor velocity, the sensor orientation, and the angular velocity, the position, the orientation, the velocity, and the angular velocity of the moving object, and the time difference from the previous processing.

In the next step S224, the signal processing unit 20a determines whether the processing for all the points in the frame has been completed by the moving object point cloud correction unit 214. When having determined that the processing is completed by the moving object point cloud correction unit 214 (step S224, “Yes”), the signal processing unit 20a proceeds to the processing of step S230. In contrast, when having determined that the processing is not completed by the moving object point cloud correction unit 214 (step S224, “No”), the signal processing unit 20a returns the processing to step S201 and executes the processing for the next detection point in the frame.

In step S230, the signal processing unit 20a outputs the stationary object velocity point cloud frame formed with the stationary object point cloud corrected by the stationary object point cloud correction unit 213 and the moving object velocity point cloud frame formed with the moving object point cloud corrected by the moving object point cloud correction unit 214. The output stationary object velocity point cloud frame is passed to the SLAM processing unit 220, for example. Furthermore, the output moving object velocity point cloud frame is passed to the moving object state estimation unit 221, for example.

FIG. 31 is a flowchart illustrating an example of correction processing of a velocity point cloud frame of a stationary object in the signal processing unit 20a according to the first embodiment. The flowchart of FIG. 31 illustrates the processing of step S213 in the above-described flowchart of FIG. 30 in more detail.

In step S250, the signal processing unit 20a uses the stationary object point cloud correction unit 213 to acquire the sensor velocity estimated by the sensor velocity estimation unit 212. In the next step S251, the signal processing unit 20a uses the stationary object point cloud correction unit 213 to acquire coordinates of each point included in the velocity point cloud frame of the stationary object. In the next step S252, the signal processing unit 20a uses the stationary object point cloud correction unit 213 to acquire the sensor orientation and the acceleration estimated by the sensor position/orientation estimation unit 210. In the next step S253, the signal processing unit 20a uses the stationary object point cloud correction unit 213 to estimate the instantaneous velocity vector of each point included in the velocity point cloud frame of the stationary object based on each value acquired in steps S250 to S252.

In the next step S254, the signal processing unit 20a uses the stationary object point cloud correction unit 213 to calculate the minute displacement of each point from the product of the differential time from the previous processing and the instantaneous velocity vector of each point. The signal processing unit 20a uses the stationary object point cloud correction unit 213 to shift the position of each point based on the calculated minute displacement of each point and correct the velocity point cloud frame of the stationary object.

### 2-2-4. Point Cloud Correction Processing According to First Embodiment

Next, the point cloud correction processing according to the first embodiment will be described. The point cloud correction processing according to the first embodiment is executed by the stationary object point cloud correction unit 213 and the moving object point cloud correction unit 214 illustrated in FIG. 17.

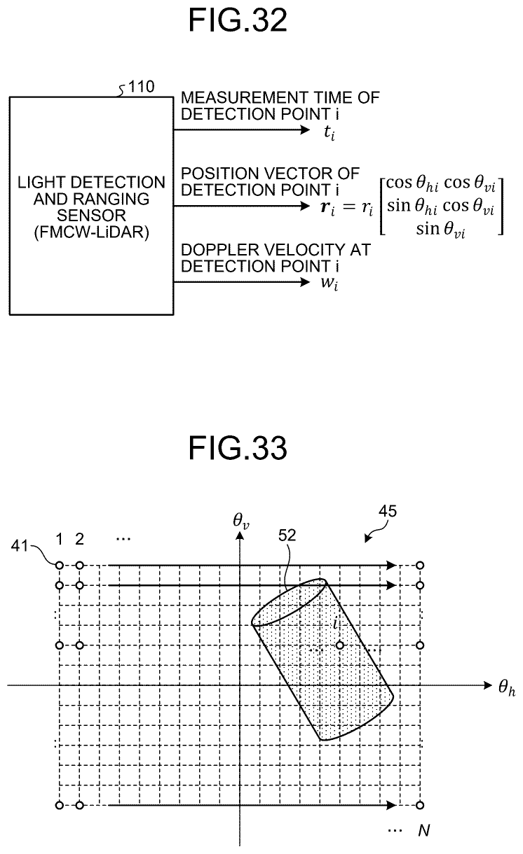

FIG. 32 is a schematic diagram illustrating an example of output data by the light detection and ranging sensor 110 according to the first embodiment. The light detection and ranging sensor 110 outputs a detection time tᵢ of the detection point i, a position vector rᵢ of the detection point i, and a Doppler velocity wᵢ of the detection point i. In the following description, the detection point i denotes an emission point at which the strength of each of the first and second reception spectrum signals in the reception light signal is the threshold th or more.

FIG. 33 is a schematic diagram illustrating a definition of coordinates of an emission point, applicable to the first embodiment. In FIG. 33, when the center of the angular range 45 related to scanning is set as the origin, a vertical angle θᵥ is defined in the vertical direction and a horizontal angle θₕ is defined in the horizontal direction in the figure. When the emission point 41 at the upper left corner of the angular range 45 is set as point #1, points are set such as points #1, #2, . . . from left to right, so as to reach the emission point 41 at the lower right corner of the angular range 45 set as point #N. Among the emission points 41, the emission point 41 at a position corresponding to an object 52, being a measurement target, is set as the detection point i.

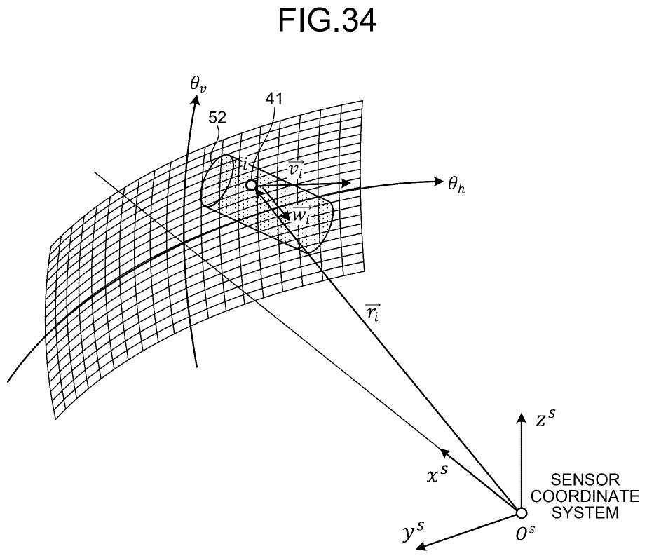

FIG. 34 is a schematic diagram illustrating each emission point 41 and the object 52 as viewed from the light detection and ranging sensor 110.

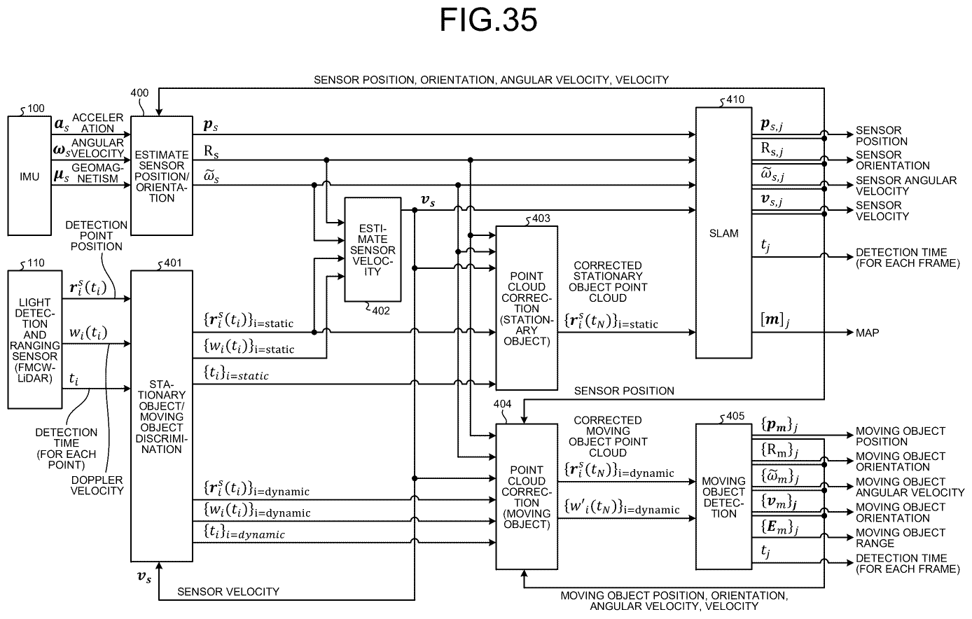

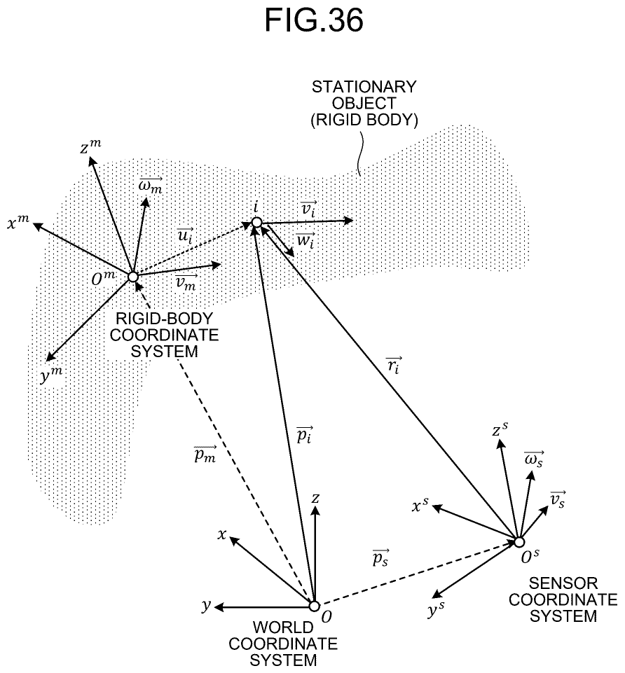

Symbols and the like used in FIG. 34 as well as FIGS. 35 and 36 to be described below, and each mathematical expression to be described below may be replaced with the following mathematical expressions.
Vectors represented in bold in the drawings and the mathematical expressions are denoted with an immediately preceding “_” (underscore), such as “Vector_x”.
In the drawings and the mathematical expressions, a character having “->” (arrow) added immediately above it to indicate a vector is denoted by adding “->” (arrow) immediately before the character, such as “vector->x”.
In the drawings and the mathematical expressions, a superscript “s” attached to a character indicates that a value represented by the character is a value in the sensor coordinate system.
In the drawings and the mathematical expressions, a superscript “m” attached to a character indicates that a value denoted by the character is a value in a moving-object/rigid-body coordinate system.
In the drawings and the mathematical formulas, a character with “⋅” (dot) added immediately above it to indicate time derivative is denoted by adding “⋅” immediately before the character, such as “⋅x”.
In the drawings and the mathematical formulas, a character having “~” (tilde) added immediately above it to indicate an angular velocity tilde matrix is denoted by adding “~” immediately before the character, such as “~x”.

In FIG. 34, when the position of the light detection and ranging sensor 110 is set by a position O^{s} and this position O^{s} is set as an origin, a sensor coordinate system is defined by coordinate axes x^{s}, y^{s}, and z^{s}. Furthermore, for convenience, each emission point 41 is illustrated as a point equidistant from the light detection and ranging sensor 110.

In FIG. 34, at the detection point i corresponding to the object 52, the vector->vᵢ denotes the motion of the object 52, and the vector->wᵢ denotes the Doppler velocity of the object 52 with respect to the position OS of the sensor. A vector->rᵢ starting from the position OS toward the detection point i denotes a distance from the light detection and ranging sensor 110 to the detection point i in the object 52. The final target information to be acquired is vector->vᵢ.

FIG. 35 is a schematic diagram illustrating an overall flow of processing related to point cloud correction in the signal processing unit 20a according to the embodiment.

In FIG. 35, a sensor position/orientation estimation processing 400, a stationary object/moving object discrimination processing 401, and a sensor velocity estimation processing 402 are a series of processing respectively performed by the sensor position/orientation estimation unit 210, the moving object/stationary object separation unit 211, and the sensor velocity estimation unit 212 in FIG. 17. Furthermore, a point cloud correction processing 403 and 404 are processing respectively performed by the stationary object point cloud correction unit 213 and the moving object point cloud correction unit 214 in FIG. 17. Furthermore, moving object detection processing 405 is processing performed by the moving object state estimation unit 221 in FIG. 17. Furthermore, the processing performed by the SLAM processing unit 220 in FIG. 17 is SLAM processing 410.

The IMU 100 outputs acceleration as, angular velocity_ωₛ, and geomagnetism_μₛ as IMU data. Based on the acceleration_aₛ, the angular velocity_ωₛ, and the geomagnetism_μₛ output from the IMU 100, and the sensor position_p_{s,j}, the sensor orientation R_{s,j}, the sensor angular velocity ~ω_{s,j}, and the sensor velocity_v_{s,j} obtained by the SLAM processing 410, the sensor position/orientation estimation processing 400 estimates the sensor position_pₛ, the sensor orientation Rₛ, and the sensor angular velocity ~ωₛ. The sensor position/orientation estimation processing 400 passes the estimated sensor position pₛ to the SLAM processing 410. Furthermore, the sensor position/orientation estimation processing 400 passes the estimated sensor orientation Rₛ and sensor angular velocity ~ωₛ to the sensor velocity estimation processing 402.

The light detection and ranging sensor 110 outputs, as FMCW-LiDAR data, a detection time tᵢ, a distance_r^{s}ᵢ(tᵢ) for a position at the detection time tᵢ, and a Doppler velocity wᵢ(tᵢ) for each detection point i. Each piece of data output from the light detection and ranging sensor 110 is passed to the stationary object/moving object discrimination processing 401.

Based on each data passed from the light detection and ranging sensor 110 and the sensor velocity_vₛ estimated by the sensor velocity estimation processing 402, the stationary object/moving object discrimination processing 401 calculates a distance {_r^{s}ᵢ(tᵢ)}_{i=static} for the position of the stationary object at the detection time ti, the Doppler velocity {wᵢ(tᵢ)}_{i=static}, and the stationary object detection time {tᵢ}_{i=static}.

The braces “{” and “}” indicate that the sandwiched part is a set.

The stationary object/moving object discrimination processing 401 passes the calculated distance {_r^{s}ᵢ(tᵢ)}_{i=static} and the Doppler velocity {wᵢ(tᵢ)}_{i=static} to the sensor velocity estimation processing 402. In addition, the stationary object/moving object discrimination processing 401 passes the calculated distance {_r^{s}ᵢ(tᵢ)}_{i=static} and the stationary object detection time {tᵢ}_{i=static} to the point cloud correction processing 403 that corrects the stationary object point cloud.

Furthermore, based on each data passed from the light detection and ranging sensor 110 and the sensor velocity_vₛ estimated by the sensor velocity estimation processing 402, the stationary object/moving object discrimination processing 401 calculates a distance {_r^{s}ᵢ(tᵢ)}_{i=dynamic} for the position of the moving object at the detection time tᵢ, the Doppler velocity {wᵢ(tᵢ)}_{i=dynamic}, and the stationary object detection time {tᵢ}_{i=dynamic}.

The stationary object/moving object discrimination processing 401 passes the calculated distance {_r^{s}ᵢ(tᵢ)}_{i=dynamic}, the Doppler velocity {wᵢ(tᵢ)}_{i=dynamic}, and the stationary object detection time {tᵢ}_{i=dynamic} to the point cloud correction processing 404 that corrects the moving object point cloud.

The sensor velocity estimation processing 402 calculates the sensor velocity_vₛ as the velocity of the sensor unit 10 based on the sensor orientation Rₛ and the sensor angular velocity ~ωₛ passed from the sensor position/orientation estimation processing 400 described above, and the distance {_t^{s}ᵢ(tᵢ)}_{i=static} and the Doppler velocity {wᵢ(tᵢ)}_{i=static} passed from the stationary object/moving object discrimination processing 401. The sensor velocity estimation processing 402 passes the calculated sensor velocity_vₛ to the stationary object/moving object discrimination processing 401, the point cloud correction processing 403 and 404, and the SLAM processing 410.

Based on the sensor orientation Rₛ and the sensor angular velocity ~ωₛ passed from the sensor position/orientation estimation processing 400, and the distance {_r^{s}ᵢ(tᵢ)}_{i=static} and the stationary object detection time {tᵢ}_{i=static} passed from the stationary object/moving object discrimination processing 401, the point cloud correction processing 403 calculates a distance {_r^{s}ᵢ(t_{N})}_{i=static} as a corrected position of the stationary object point cloud. The point cloud correction processing 403 passes the calculated distance {_r^{s}ᵢ(t_{N})}_{i=static} to the SLAM processing 410.

Based on the sensor orientation Rₛ and the sensor angular velocity ~ωₛ, which are passed from the sensor position/orientation estimation processing 400, the distance {_r^{s}ᵢ(tᵢ)}_{i=dynamic}, the Doppler velocity {wᵢ(tᵢ)}_{i=dynamic}, and stationary object detection time {tᵢ}_{i=dynamic}, which are passed from the stationary object/moving object discrimination processing 401, the sensor velocity_vₛ passed from the sensor velocity estimation processing 402, the sensor position_p_{s,j} passed from the SLAM processing 410, the moving object position {_pₘ}ⱼ, the moving object orientation {Rₘ} and {_vₘ}ⱼ, and based on moving object angular velocity {~ωₘ}ⱼ, which are passed from the moving object detection processing 405, the point cloud correction processing 404 calculates a corrected moving object point cloud {r^{s}ᵢ(t_{N})}_{i=dynamic} and the corrected Doppler velocity {w′ᵢ(t_{N})}_{i=dynamic}. The point cloud correction processing 404 passes the calculated corrected moving object point cloud {r^{s}ᵢ(t_{N})}_{i=dynamic} and the corrected Doppler velocity {w′ᵢ(t_{N})}_{i=dynamic} to the moving object detection processing 405.

Based on the corrected moving object point cloud {_r^{s}ᵢ(t_{N})}_{i=dynamic} and the corrected Doppler velocity {w′ᵢ(t_{N})}_{i=dynamic} passed from the point cloud correction processing 404, the moving object detection processing 405 calculates a moving object position {_pₘ}ⱼ, moving object orientation {Rₘ}ⱼ and {_vₘ}ⱼ, a moving object angular velocity {~ωₘ}ⱼ, and a moving object range {Eₘ}ⱼ, and then outputs the calculated data. Furthermore, the moving object detection processing 405 outputs the detection time to for each frame. Each value output from the moving object detection processing 405 is passed to the transmission unit 201, for example (refer to FIG. 17). Furthermore, the moving object detection processing 405 passes the calculated moving object position {_pₘ}ⱼ, the moving object orientation {Rₘ}ⱼ and {_vₘ}ⱼ, and the moving object angular velocity {~wₘ}ⱼ to the point cloud correction processing 404.

The SLAM processing 410 creates and outputs a map <_m> (“<” and “>” indicate outer brackets) based on the sensor position_pₛ, the sensor orientation Rₛ, and the sensor angular velocity ~ωₛ which are passed from the sensor position/orientation estimation processing 400, the sensor velocity_vₛ passed from the sensor velocity estimation processing 402, and the corrected stationary object point cloud {_r^{s}ᵢ(t_{N})}_{i=static} passed from the point cloud correction processing 403. Furthermore, the SLAM processing 410 outputs the sensor position_p_{s,j}, the sensor orientation R_{s,j}, the sensor angular velocity ~ω_{s,j}, and the sensor velocity_v_{s,j}. Furthermore, the SLAM processing 410 outputs the detection time tⱼ for each frame. Each value output from the SLAM processing 410 is passed to the transmission unit 201, for example (refer to FIG. 17).

### (Description Using Theoretical Formula of Processing According to First Embodiment)

Here, the processing in the signal processing unit 20a according to the first embodiment described with reference to FIG. 35 will be described using theoretical formulas.

### (Processing Related to Stationary Object)

First, processing related to a stationary object will be described. FIG. 36 is a schematic diagram for defining a coordinate system and each variable used in the following description. In FIG. 36, when the position of the light detection and ranging sensor 110 (hereinafter, the sensor) as a position O^{s}_ and the position O^{s}_is set as an origin, a sensor coordinate system is defined by coordinate axes x^{s}, y^{s} and z^{s} orthogonal to each other. The angular velocity and velocity of the sensor are defined as angular velocity->ωₛ and velocity->vₛ, respectively.

In a stationary object (rigid body), when a position O^{m} on the rigid body is set as an origin, a rigid body coordinate system is defined by axes x^{m}, y^{m} and z^{m} orthogonal to each other. The angular velocity and velocity of the rigid body are defined as ->ωₘ and ->vₘ, respectively.

A point i which is a detection position on the rigid body is assumed to be a position indicated by a vector->uᵢ from the position O^{m}, and the point i is supposed to have a velocity->vᵢ and a Doppler velocity->wᵢ with respect to the light detection and ranging sensor 110. The point i is assumed to be at a position of a distance->rᵢ as viewed from the sensor.

In addition, when an arbitrary position O in the space is set as an origin, a world coordinate system is defined by axes x, y, and z orthogonal to each other. When viewed from the position O, which is the origin of the world coordinate system, the position O^{m}, which is the origin of the rigid body coordinate system, is assumed to be located at the position->pₘ, and the point i is assumed to be located at the position->pᵢ. In addition, the position O^{s}, which is the origin of the sensor coordinate system, is assumed to be located at the position->pₛ when viewed from the position O.

(a Case where the Detection Target is a Stationary Object and the Sensor is in Motion)

First, a relationship between values in each coordinate system in a case where the detection target is a stationary object and the sensor is in motion will be described. The position vector_pᵢ of the point i is expressed by the following Formula (1).

pᵢ=pₛ+rᵢ (1)m

The velocity vector ⋅_pᵢ of the point i is expressed by the following Formula (2).

\dot{p}ᵢ=\dot{p}ₛ+ωₛrᵢ+\dot{r}ᵢ (2)

In the Formula (2), the angular velocity tilde matrix ~ωₛ indicating the angular velocity of the rigid body is expressed as the following Formula (4) based on the angular velocity vector_ω of the following Formula (3).

$$ω = [ \begin{matrix}{ω}_{x} \\ {ω}_{y} \\ {ω}_{z}\end{matrix} ] \qquad ( 3 )$$

$$\tilde{ω} = [ \begin{matrix}0 & - {ω}_{z} & {ω}_{y} \\ {ω}_{z} & 0 & - {ω}_{x} \\ - {ω}_{y} & {ω}_{x} & 0\end{matrix} ] \qquad ( 4 )$$

In Formula (2), when the rigid body coordinate system is stationary, the following Formula (5) holds.

\dot{p}ᵢ=0 (5)

In addition, according to the vector constant expression, the relationship of the following Formula (6) holds for the distance_rᵢ and the angular velocity tilde matrix ~ωₛ.

rᵢ·\tilde{w}ₛrᵢ=0 (6)

Furthermore, the Doppler velocity wᵢ of the point i is expressed by the following Formula (7).

$${w}_{i} = \frac{{r}_{i}}{{r}_{i}} \cdot {\dot{r}}_{i} \qquad ( 7 )$$

The following Formula (8) is obtained by the above-described Formulas (2) and (5) to (7).

$${\dot{p}}_{i} = \frac{{r}_{i}}{{r}_{i}} \cdot {\dot{p}}_{s} + \frac{{r}_{i}}{{r}_{i}} \cdot {\tilde{ω}}_{s} {r}_{i} + {w}_{i} \qquad ( 8 )$$

Formula (8) is transformed into Formula (9) below to rearrange the relationship between the values, so as to obtain the relationship between the Doppler velocity wᵢ and the velocity vector ⋅_pᵢ at the point i.

$${w}_{i} = - \frac{{r}_{i}}{{r}_{i}} \cdot {\dot{p}}_{s} \qquad ( 9 )$$

### (Estimation of Sensor Velocity Using Doppler Velocity)

Next, the following will describe a method of estimating the sensor velocity using the Doppler velocity by the sensor velocity estimation processing 402 in a case where the sensor is in motion and the point i is a stationary object. The relationship between the Doppler velocity wᵢ and the sensor velocity vₛ is expressed by the following Formula (10) based on Formula (9) described above.

$${w}_{i} = - \frac{{r}_{i}}{{r}_{i}} \cdot {\dot{p}}_{s} \qquad ( 10 )$$

Formula (10) can be expressed as the following Formula (11) using the sensor orientation Rₛ.

$$\begin{matrix}[ Mathematical Expression 11 ] & \\ {w}_{i} = - \frac{{R}_{s} {r}_{i}^{s}}{{r}_{i}} \cdot {v}_{s} & ( 11 )\end{matrix}$$

In Formula (11), −(r^{s}ᵢ/rᵢ) indicates a beam direction vector, which can be expressed as the following Formula (12) using a matrix.

$$\frac{{r}_{i}^{s}}{{r}_{i}} = [ \begin{matrix}cos {θ}_{hi} cos {θ}_{vi} \\ sin {θ}_{hi} cos {θ}_{vi} \\ sin {θ}_{vi}\end{matrix} ] \qquad ( 12 )$$

By substituting Formula (12) into Formula (11), the following Formula (13) is obtained.

$${w}_{i} = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{v}_{sx} \\ {v}_{sy} \\ {v}_{sz}\end{matrix} ] \qquad ( 13 )$$

Here, based on Formula (13), the value_eᵢ is defined as the following Formula (14).

$${e}_{i} = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \qquad ( 14 )$$

Using Formula (14), the following Formula (15) representing the sensor velocity_vₛ can be obtained. In the sensor velocity estimation processing 402, sensor velocity_vₛ is estimated by this Formula (15).

$${v}_{s} = [ \begin{matrix}{v}_{sx} \\ {v}_{sy} \\ {v}_{dz}\end{matrix} ] = {[ \begin{matrix}{e}_{x 1} & {e}_{y 1} & {e}_{z 1} \\ ⋮ & ⋮ & ⋮ \\ {e}_{xN} & {e}_{yN} & {e}_{zN}\end{matrix} ]}^{†} [ \begin{matrix}{w}_{1} \\ ⋮ \\ {w}_{N}\end{matrix} ] \qquad ( 15 )$$

Note that, in Formula (15), a matrix based on the value eᵢ indicates a matrix of beam direction vectors in the stationary object and the world coordinate system.

### (Stationary Object Point Cloud Correction Processing)

Next, stationary object point cloud correction processing performed by the point cloud correction processing 403 in a case where the sensor is in motion will be described.

The velocity vector_vᵢ of the point i is expressed by the following Formula (16).

vᵢ=vₛ+\tilde{ω}ₛrᵢ+\dot{r}ᵢ (16)

Formula (16) is transformed to obtain Formula (17).

$${R}_{s} \dot{{r}_{i}^{s}} + {\tilde{ω}}_{s} {R}_{s} {r}_{i}^{s} + {v}_{s} = \qquad ( 37 )$$

Formula (17) is further transformed to obtain the following Formula (18).

$$\frac{{dr}_{i}^{s}}{dt} = - {R}_{s}^{- 1} ( {\tilde{ω}}_{s} {R}_{s} {r}_{i}^{s} - {v}_{s} ) \qquad ( 18 )$$

Formula (18) is transformed into a discrete equation to obtain the following Formula (19). In the Formula (19), Δtᵢ is the measurement differential time and is obtained by Δtᵢ=tᵢ−tᵢ₋₁.

$$Δ {r}_{i}^{s} = - {R}_{s}^{- 1} ( {\tilde{ω}}_{s} {R}_{s} {r}_{i}^{s} - {v}_{s} ) Δ {t}_{i} \qquad ( 19 )$$

Based on Formula (19), the correction coefficient X^{s}ᵢ is defined as the following Formula (20).

$${χ}_{i}^{s} = - {R}_{s}^{- 1} ( {\tilde{ω}}_{s} {R}_{s} {r}_{i}^{s} - {v}_{s} ) \qquad ( 20 )$$

Using the measurement differential time Δtᵢ and the correction coefficient X^{s}ᵢ in Formula (20), the position of each point of the stationary object point cloud is corrected by the following Formula (21).

$$\begin{matrix}{r}_{0}^{s} ( {t}_{N} ) = {χ}_{0}^{s} ( {t}_{N} ) Δ {t}_{N} & + {χ}_{0}^{s} ( {t}_{N - 1} ) Δ {t}_{N - 1} & … & + {χ}_{0}^{s} ( {t}_{1} ) Δ {t}_{1} & + {r}_{0}^{s} ( {t}_{0} ) \\ ⋮ & & & & ⋮ \\ {r}_{N - 2}^{s} ( {t}_{N} ) = {χ}_{N - 2}^{s} ( {t}_{N} ) Δ {t}_{N} & + {χ}_{N - 2}^{s} ( {t}_{N - 1} ) Δ {t}_{N - 1} & & … & + {r}_{N - 2}^{s} ( {t}_{N - 2} ) \\ {r}_{N - 1}^{s} ( {t}_{N} ) = {χ}_{N - 1}^{s} ( {t}_{N} ) Δ {t}_{N} & & & & + {r}_{N - 1}^{s} ( {t}_{N - 1} ) \\ {r}_{N}^{s} ( {t}_{N} ) = & & & & + {r}_{N}^{s} ( {t}_{N} )\end{matrix} \qquad ( 21 )$$

In the Formula (21), the left side indicates the position vector of each corrected detection point (point i) in the sensor coordinate system. The last term on the right side indicates a position vector in the sensor coordinate system of each detection point before correction. In the point cloud correction processing 403, the position of each point of the stationary object point cloud is corrected by the Formula (21) by adding the position correction value to the position vector of the detection point (point i) in the sensor coordinate system before the correction of each detection point using the correction term based on the measurement differential time Δtᵢ and the correction coefficient X^{s}ᵢ at the point i.

### (Processing Related to Moving Object)

Next, processing related to a moving object will be described. The coordinate system is the same as that in FIG. 36 except that the stationary object (rigid body) in FIG. 36 described above is replaced with a moving object (rigid body), and thus the description thereof is omitted.

(Case where the Detection Target is a Moving Object and the Sensor is in Motion)

First, a relationship between values in each coordinate system in a case where the detection target is a moving object and the sensor is in motion will be described. The position vector_pᵢ of the point i (detection position) is expressed by the following Formula (22).

pₗ=pₘ+uᵢ (22)

The velocity vector ⋅_pᵢ in the rigid body coordinate system of the point i is expressed by the following Formula (23). Note that the velocity vector ⋅_pᵢ in the sensor coordinate system of the point i is similar to the above-described Formula (2), and thus the description thereof will be omitted here.

\dot{p}ᵢ=\dot{p}ₘ+ωₘuᵢ (23)

Using the above-described Formula (6) by the vector constant equation and the velocity vector ⋅_pᵢ of the sensor coordinate system of the point i in Formula (2), Formula (23) is transformed to obtain the following Formula (24).

$$\frac{{r}_{i}}{{r}_{i}} \cdot \dot{{p}_{m}} + \frac{{r}_{i}}{{r}_{i}} \cdot {\tilde{ω}}_{m} {u}_{i} = \frac{{r}_{i}}{{r}_{i}} \cdot \dot{{r}_{s}} + \frac{{r}_{i}}{{r}_{i}} \cdot {\tilde{ω}}_{s} {r}_{i} + {w}_{i} \qquad ( 24 )$$

Formula (24) is further transformed into the following Formula (25) to rearrange the relationship between the individual values.

$${w}_{i} + \frac{{r}_{i}}{{r}_{i}} \cdot \dot{{p}_{s}} = \frac{{r}_{i}}{{r}_{i}} \cdot ( \dot{{p}_{m}} + {\tilde{ω}}_{m} {u}_{i} ) \qquad ( 25 )$$

### (Velocity Discrimination Between Stationary Object and Moving Object)

Next, velocity discrimination between a stationary object and a moving object by the stationary object/moving object discrimination processing 401 will be described. By correcting the Doppler velocity wᵢ in accordance with the motion of the point i, a corrected Doppler velocity wᵢ′ is obtained by the following Formula (26).

$${w}_{i}^{′} = {w}_{i} + \frac{{r}_{i}}{{r}_{i}} \cdot {v}_{s} \qquad ( 26 )$$

The stationary object/moving object discrimination processing 401 performs threshold determination on the corrected Doppler velocity wᵢ′, thereby determining whether the point i is a moving object or a stationary object. For example, a moving object determination threshold vₜₕ₁ for determining a moving object and a stationary object determination threshold vₜₕ₂ for determining a stationary object are set. When the absolute value of the corrected Doppler velocity wᵢ′ is less than the stationary object determination threshold vₜₕ₂ (|wᵢ′|<vₜₕ₂), it is determined that the point i is a stationary object. In a case where the absolute value of the corrected Doppler velocity wᵢ′ exceeds the moving object determination threshold vₜₕ₁ (|wᵢ′|>vₜₕ₁), it is determined that the point i is a moving object.

### (Estimation of Sensor Velocity Using Doppler Velocity)

Next, the following will describe a method of estimating the sensor velocity using the Doppler velocity by the sensor velocity estimation processing 402 in a case where the sensor is in motion and the point i is a moving object. The relative velocity of the sensor with respect to the moving object is expressed by the following Formula (27) using the Doppler velocity wᵢ.

$${w}_{i} - \frac{{r}_{i}}{{r}_{i}} \cdot ( {\tilde{ω}}_{m} {u}_{i} ) = - \frac{{r}_{i}}{{r}_{i}} \cdot ( {v}_{s} - {v}_{m} ) \qquad ( 27 )$$

Formula (27) is transformed using the sensor orientation Rₛ to obtain the following Formula (28).

$${w}_{i} - \frac{{R}_{s} {r}_{i}^{s}}{{r}_{i}} \cdot ( {\tilde{ω}}_{m} {u}_{i} ) = - \frac{{R}_{s} {r}_{i}^{s}}{{r}_{i}} \cdot ( {v}_{s} - {v}_{m} ) \qquad ( 28 )$$

Here, the value_ηᵢ is defined as in the following Formula (29).

ηᵢ=\tilde{ω}ₘuᵢ (29)

Vector_uᵢ in Formula (29) is obtained by the following Formula (30).

uᵢ=pₛ+rᵢ−pₘ (30)

Formula (29) is expressed as the following Formula (31) using a determinant.

$$[ \begin{matrix}{η}_{ix} \\ {η}_{iy} \\ {η}_{iz}\end{matrix} ] = [ \begin{matrix}0 & - {ω}_{mz} & {ω}_{my} \\ {ω}_{mz} & 0 & - {ω}_{mx} \\ - {ω}_{my} & {ω}_{mx} & 0\end{matrix} ] [ \begin{matrix}{x}_{s} + {x}_{i} - {x}_{m} \\ {y}_{s} + {y}_{i} - {y}_{m} \\ {z}_{s} + {z}_{i} - {z}_{m}\end{matrix} ] \qquad ( 31 )$$

The above-described Formula (28) is transformed using Formulas (29) to (31) to obtain the following Formula (32).

$${w}_{i} - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{η}_{ix} \\ {η}_{iy} \\ {η}_{iz}\end{matrix} ] = - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{v}_{sx} - {v}_{mx} \\ {v}_{sy} - {v}_{mx} \\ {v}_{sz} - {v}_{mx}\end{matrix} ] \qquad ( 32 )$$

Here, a value ξᵢ is defined as in the following Formula (33).

$${ξ}_{i} = {w}_{i} - {R}_{s} [ \begin{matrix}cos {θ}_{hi} cos {θ}_{vi} \\ sin {θ}_{hi} cos {θ}_{vi} \\ sin {θ}_{vi}\end{matrix} ] \cdot [ \begin{matrix}{η}_{ix} \\ {η}_{iy} \\ {η}_{iz}\end{matrix} ] \qquad ( 33 )$$

The above-described Formula (32) is transformed using the value ξᵢ of the Formula (33) and the value eᵢ defined using the Formula (14) to obtain the following Formula (34) indicating a moving object velocity_vₘ.

$${v}_{m} = [ \begin{matrix}{v}_{mx} \\ {v}_{my} \\ {v}_{mz}\end{matrix} ] = {v}_{s} - {[ \begin{matrix}{e}_{x 1} & {e}_{y 1} & {e}_{z 1} \\ ⋮ & ⋮ & ⋮ \\ {e}_{x N} & {e}_{y N} & {e}_{z N}\end{matrix} ]}^{†} [ \begin{matrix}{ξ}_{1} \\ ⋮ \\ {ξ}_{N}\end{matrix} ] \qquad ( 34 )$$

### (Moving Object Point Cloud Correction Processing)

Next, the following will describe moving object point cloud correction processing performed by the point cloud correction processing 404 in a case where the sensor is in motion.

The velocity vector_vᵢ of the point i in the sensor coordinate system is expressed by the following Formula (35).

vᵢ=vₛ+ωₛrᵢ+\dot{r}ₗ (35)

The velocity vector_vᵢ of point i in the rigid body coordinate system is expressed by the following Formula (36).

vᵢ+vₘ+\tilde{ω}ₘuᵢ (36)

Formula (35) and Formula (36) are assumed to be equal, and Formula (35) is transformed using the sensor orientation Rₛ to obtain the following Formula (37).

$${R}_{s} \dot{{r}_{i}^{s}} + {\tilde{ω}}_{s} {R}_{s} {r}_{i}^{s} + {v}_{s} = {v}_{m} + {\tilde{ω}}_{m} {u}_{i} \qquad ( 37 )$$

The above-described Formula (30) is substituted into the vector_uᵢ of the Formula (37) to obtain the following Formula (38).

$$\frac{{dr}_{i}^{s}}{dt} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) \qquad ( 38 )$$

Formula (38) is transformed into a discrete equation, and the measurement differential time Δtᵢ is applied to obtain the following Formula (39).

$$Δ {r}_{i}^{s} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) Δ {t}_{i} \qquad ( 39 )$$

Based on Expression 39, the correction coefficient σ^{s}ᵢ is defined as in the following Formula (40).

$${σ}_{i}^{s} = - {R}_{s}^{- 1} ( {\tilde{ω}}_{s} {R}_{s} {r}_{i}^{s} - {v}_{s} + {v}_{m} + {\tilde{ω}}_{m} ( {p}_{s} + {r}_{i} - {p}_{m} ) ) \qquad ( 40 )$$

Using the measurement differential time Δtᵢ and the correction coefficient σ^{s}ᵢ indicated in Formula (40), the position of each point of the moving object point cloud is corrected by the following Formula (41).

$$\begin{matrix}{r}_{0}^{s} ( {t}_{N} ) = & {σ}_{0}^{s} ( {t}_{N} ) {Δt}_{N} & + {σ}_{0}^{s} ( {t}_{N - 1} ) {Δt}_{N - 1} & … & {σ}_{0}^{s} ( {t}_{1} ) Δ {t}_{1} & + {r}_{0}^{s} ( {t}_{0} ) \\ ⋮ & & & & & ⋮ \\ {r}_{N - 2}^{s} ( {t}_{N} ) = & {σ}_{N - 2}^{s} ( {t}_{N} ) {Δt}_{N} & + {σ}_{N - 2}^{s} ( {t}_{N - 1} ) {Δt}_{N - 1} & & … & + {r}_{N - 2}^{s} ( {t}_{N - 2} ) \\ {r}_{N - 1}^{s} ( {t}_{N} ) = & {σ}_{N - 1}^{s} ( {t}_{N} ) {Δt}_{N} & … & & & + {r}_{N - 1}^{s} ( {t}_{N - 1} ) \\ {r}_{N}^{s} ( {t}_{N} ) = & & & & & + {r}_{N}^{s} ( {t}_{N} )\end{matrix} \qquad ( 41 )$$

In the Formula (41), the left side indicates the position vector of each corrected detection point (point i) in the sensor coordinate system. The last term on the right side indicates a position vector in the sensor coordinate system of each detection point before correction. In the point cloud correction processing 404, the position of each point of the moving object point cloud is corrected by the Formula (41) by adding the position correction value to the position vector of the detection point (point i) in the sensor coordinate system before the correction of each detection point using the correction term based on the measurement differential time Δtᵢ and the correction coefficient σ^{s}ᵢ at the point i.

### 2-2-5. Effects of First Embodiment

In the measurement using direct Time of Flight (dToF)-LiDAR according to the existing technology, there has been very few method to calculate the moving velocity of the surrounding environment, specifically, using the method in which the movement of the surrounding environmental structure is grasped from a difference in the matching of structural shapes of a plurality of frames, and the amount of the movement is divided by a frame period time or the like.

In contrast, by the measurement performed using the FMCW-LiDAR technology applied to the present disclosure, it is possible to acquire information referred to as a velocity point cloud. The velocity point cloud is information being a set of the distance from the sensor to the detection point of the object, the direction angle, and the Doppler velocity.

The measurement by FMCW-LiDAR typically sequentially performs beam scanning and distance measurement and thereby outputs a velocity point cloud at constant periods. Here is an assumable case of acquiring the environment around the mobile body and the velocity point cloud obtained by measuring the moving object using the FMCW-LiDAR sensor, which is mounted on the mobile body and performs measurement using FMCW-LiDAR.

The entire surrounding environmental structure can be regarded as one rigid body, and the motion of the rigid body is to be a self motion when viewed from the reference coordinate system of the environmental structure. A relationship among the Doppler velocity, the scanning direction vector, the rigid body velocity vector, and the rigid body angular velocity vector is derived from a kinematic equation related to the velocity vector and the angular velocity vector at one point on the rigid body and a relational expression between the velocity vector and the Doppler velocity at one point.

As a result, the velocity vector of the rigid body reference point is considered to be calculated by using the position vector, the angular velocity vector, and the velocity point cloud acquired by the FMCW-LiDAR sensor. Therefore, with the measurement method according to the first embodiment, the motion of the surrounding environmental structure can be estimated even with only a single frame of the velocity point cloud acquired by the measurement using the FMCW-LiDAR sensor mounted on the mobile body. That is, the self-motion can be estimated by changing the reference coordinate system.

Since the measurement method according to the first embodiment of the present disclosure is not a method using a frame difference, velocity estimation can be continued even under conditions with occurrence of a degeneracy problem. Furthermore, with the measurement method according to the first embodiment, it is possible to measure the motion that cannot be estimated by the frame difference, not only in the self-motion estimation but also in the motion estimation of the surrounding moving object.

In addition, with to the measurement method according to the first embodiment, even in a case where there is a dynamic environment around, it is possible to exclude a dynamic object with high accuracy in a single frame by performing velocity discrimination using a velocity point cloud. That is, with the measurement method according to the first embodiment, the highly accurate self-motion estimation can be achieved by excluding the portion corresponding to the dynamic object from the acquired velocity point cloud, and estimating the motion estimation by using only the partial velocity point cloud corresponding to the surrounding environment.

### 2-3. First Modification of First Embodiment

Next, a first modification of the first embodiment will be described. The first modification of the first embodiment is an example in which a configuration of generating motion meta-information related to a motion of a moving object is added to the configuration of the perception system 1a according to the first embodiment illustrated in FIG. 17.

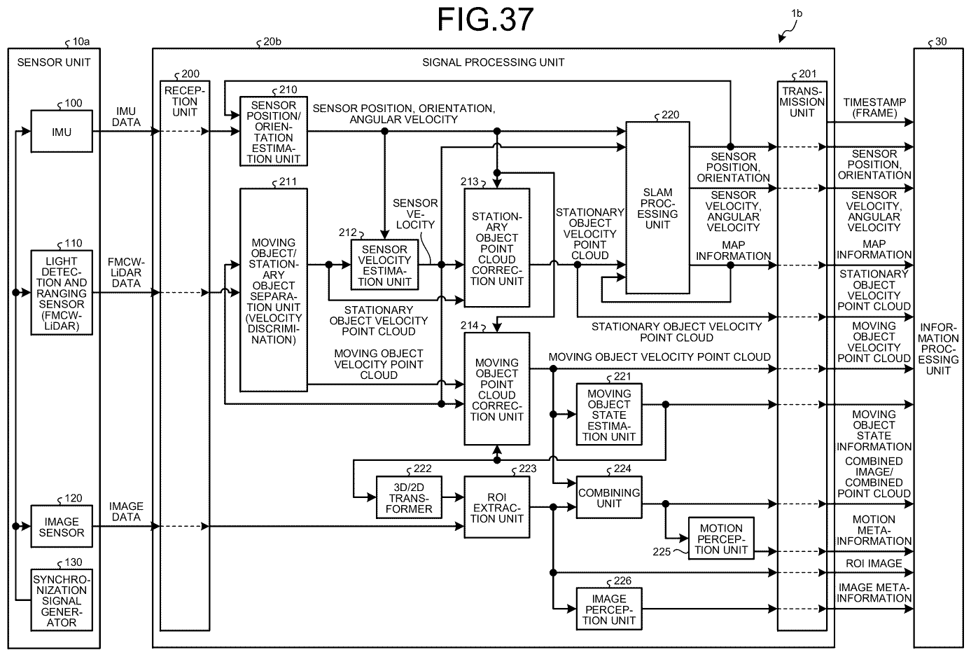

FIG. 37 is a block diagram illustrating a configuration of an example of a perception system according to a first modification of the first embodiment. In FIG. 37, in a perception system 1b according to the first modification of the first embodiment, a signal processing unit 20b is a unit in which a combining unit 224 and a motion perception unit 225 has been added to the signal processing unit 20a of the perception system 1a according to the first embodiment illustrated in FIG. 17.

The combining unit 224 receives the moving object velocity point cloud passed from the moving object point cloud correction unit 214, and receives the image data of the region of interest passed from the ROI extraction unit 223. The combining unit 224 combines the moving object velocity point cloud and the image data of the region of interest. For example, the combining unit 224 may combine the moving object velocity point cloud with the image data of the region of interest. In this case, the combining unit 224 may associate velocity information of each point included in the moving object velocity point cloud with each pixel data in the image data of the region of interest. The image obtained by combining the velocity information with each pixel of the image data of the region of interest is referred to as a combined image.

Combining is not limited thereto, and the combining unit 224 may combine the image data of the region of interest with the moving object velocity point cloud. In this case, the combining unit 224 may associate information of corresponding pixel data in the region of interest with each point of the moving object velocity point cloud. A point cloud obtained by combining each pixel data of the region of interest with each point of the moving object velocity point cloud is referred to as a combined point cloud.

The combining unit 224 passes the combined image or the combined point cloud to the transmission unit 201 as well as to the motion perception unit 225.

The motion perception unit 225 perceives the motion of the moving object based on the combined image or the combined point cloud passed from the combining unit 224. The motion perception unit 225 can acquire velocity distribution information based on the velocity information of each point included in the combined image or the combined point cloud. The motion perception unit 225 can more precisely estimate the motion of the moving object by using the distribution information of velocity. For example, the motion perception unit 225 may perform motion perception using a learning model trained by machine learning based on known velocity distribution information. The motion perception unit 225 perceives the motion of the moving object and outputs meta-information (walking, running, etc.) related to the motion. The motion meta-information output from the motion perception unit 225 is passed to the transmission unit 201.

The transmission unit 201 transmits the combined image or the combined point cloud passed from the combining unit 224 and the motion meta-information passed from the motion perception unit 225 to the information processing unit 30.

### 2-4. Second Modification of First Embodiment

Next, a second modification of the first embodiment will be described. The second modification of the first embodiment is an example in which the image sensor 120 and the configuration for performing processing related to image data have been omitted from the perception system 1a according to the embodiment illustrated in FIG. 17.

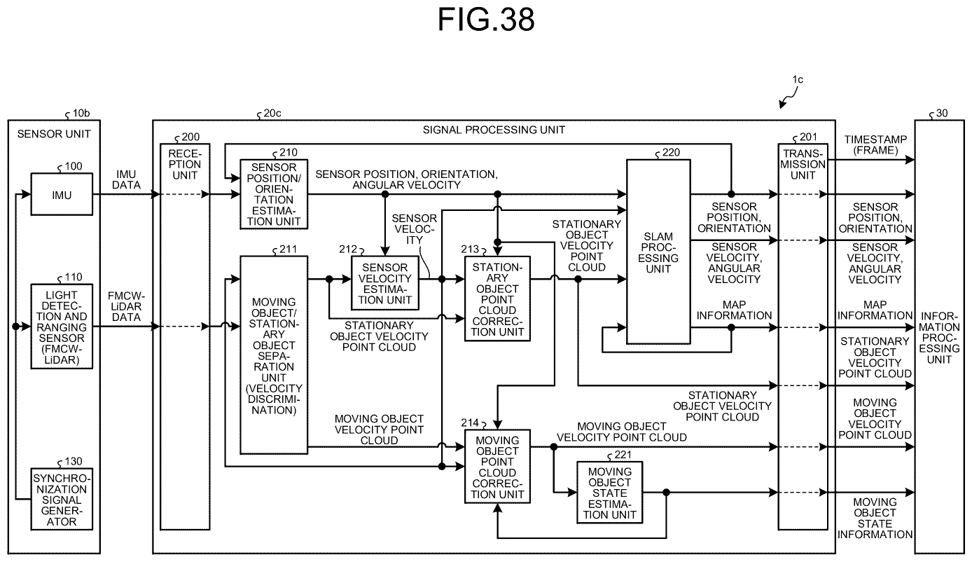

FIG. 38 is a block diagram illustrating a configuration of an example of a perception system according to a second modification of the first embodiment. In FIG. 38, a perception system 1c has a sensor unit 10b, in which the image sensor 120 is omitted as compared with the sensor unit 10 illustrated in FIG. 17. Furthermore, the perception system 1c has a signal processing unit 20c, in which the components related to the processing of the image data are omitted as compared with the signal processing unit 20a illustrated in FIG. 17, specifically, the 3D/2D transformer 222, the ROI extraction unit 223, the combining unit 224, the motion perception unit 225, and the image perception unit 226 are omitted.

Even in the configuration of the perception system 1c according to the second modification of the present embodiment, it is possible to output map information and output a stationary object velocity point cloud and a moving object velocity point cloud. When there is no need to have the motion meta-information obtained by motion perception of the moving object or the image meta-information obtained by image perception cost reduction can be achieved by applying the configuration of the perception system 1c according to the second modification of the embodiment.

### 2-5. Third Modification of First Embodiment

Next, a third modification of the embodiment of the present disclosure will be described. The third modification of the embodiment is an example in which a configuration of controlling scanning of the light detection and ranging sensor 110 has been added to the perception system 1a according to the embodiment illustrated in FIG. 17.

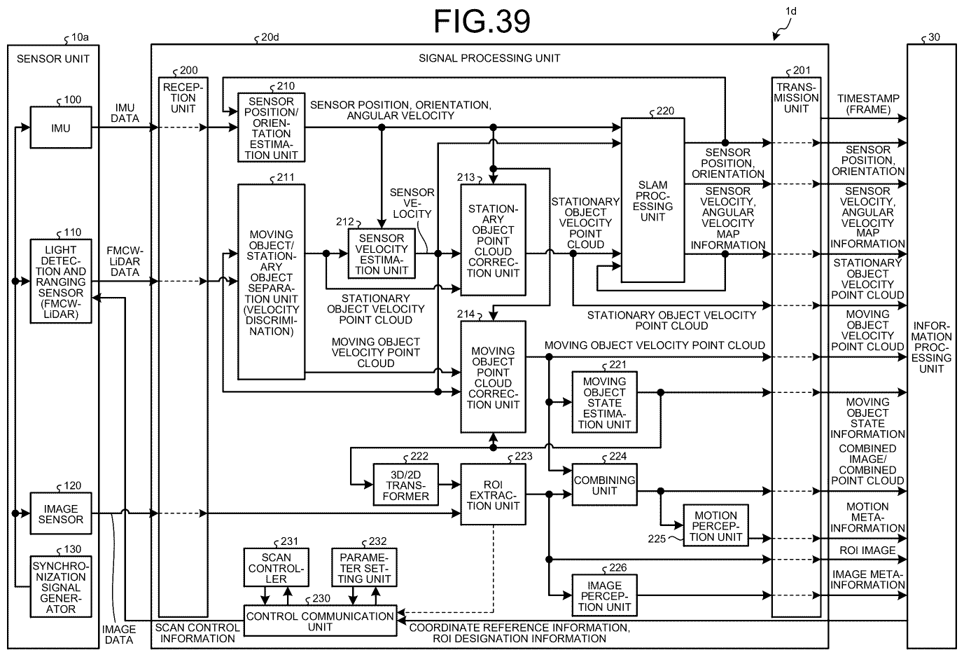

FIG. 39 is a block diagram illustrating a configuration of an example of a signal processing system according to the third modification of the first embodiment. In a perception system 1d in FIG. 39, a signal processing unit 20d has additional units, specifically, a control communication unit 230, a scan controller 231, and a parameter setting unit 232, added to the signal processing unit 20a in the perception system 1a in FIG. 17.

Based on coordinate reference information and ROI designation information transmitted from the information processing unit 30, the control communication unit 230 generates scan control information for controlling scanning in the light detection and ranging sensor 110.

For example, the control communication unit 230 passes the received coordinate reference information to the parameter setting unit 232. Based on the received coordinate reference information, the parameter setting unit 232 sets an initial value related to scanning of the light detection and ranging sensor 110, for example. The control communication unit 230 passes the initial value set by the parameter setting unit 232 to the light detection and ranging sensor 110 as scan control information. The light detection and ranging sensor 110 initializes a scanning mechanism and the like in accordance with the scan control information passed from the control communication unit 230.

Furthermore, for example, the control communication unit 230 passes received ROI designation information to the scan controller 231. The ROI designation information may include, for example, coordinate information set as a region of interest for the image data. For example, based on the received ROI designation information, the scan controller 231 converts the coordinate information into information of horizontal and vertical angular ranges for controlling the scanning range in the light detection and ranging sensor 110, and passes the information to the control communication unit 230. The control communication unit 230 passes the information of the horizontal and vertical angular ranges passed from the scan controller 231 to the light detection and ranging sensor 110 as scan control information. The light detection and ranging sensor 110 controls the scanning range in accordance with the received scan control information.

This makes it possible to perform control the light detection and ranging sensor 110 to exclusively scan the designated region of interest, leading to reduction of the time required for scanning. In addition, it is also possible to control the light detection and ranging sensor 110 to perform exclusive and high-density scanning of the designated region of interest, leading to achievement of more accurate operation perception and image perception in the region of interest.

Not limited to this, the ROI designation information may be passed from the ROI extraction unit 223 to the control communication unit 230. That is, based on the point cloud by the 2D coordinates passed from the 3D/2D transformer 222, the ROI extraction unit 223 passes information indicating the region of interest extracted from the image data passed from the image sensor 120 via the reception unit 200 to the control communication unit 230 as ROI designation information. The control communication unit 230 passes the ROI designation information passed from the ROI extraction unit 223 to the scan controller 231.

### 3. Second Embodiment According to Present Disclosure

Next, a second embodiment according to the present disclosure will be described. The second embodiment according to the present disclosure is an example in which the processing in the SLAM processing unit 220 further uses position information obtained by a Global Navigation Satellite System (GNSS).

In a SLAM system that is mounted on a mobile body and simultaneously estimates a self-position orientation and a surrounding environment, a GNSS may be used together in order to reduce a cumulative error of a self-position. However, in an environmental condition having difficulty in receiving GNSS signals, the cumulative error cannot be reduced, having a problem of degraded precision of the self-absolute position. For example, in an indoor environment that frequently utilizes a SLAM system using an external environment sensor, it is difficult for the GNSS to receive radio waves from a satellite, leading to failure in operation of GNSS because of deterioration of precision indicated as Dilution of Precision (DOP). In addition, in an indoor environment structure, there is a high probability that a smooth wall, a floor, or the like mainly exists a field of view, leading to occurrence of a degeneracy problem in SLAM.

The perception system using the light detection and ranging sensor 110 by FMCW-LiDAR according to the present disclosure can estimate the self-velocity and the angular velocity with high accuracy even in a scene with occurrence of degeneracy. This makes it possible to stably continue the SLAM processing even under a condition having difficulty in receiving GNSS signals.

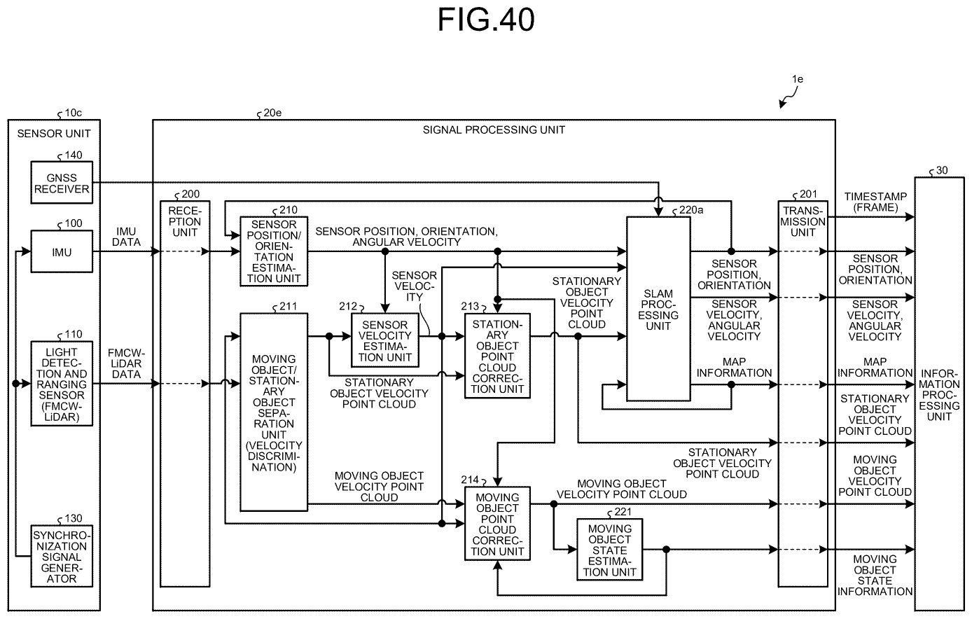

FIG. 40 is a block diagram illustrating a configuration of an example of a perception system according to a second embodiment. Note that a perception system 1e in FIG. 40 is illustrated as an example in which a GNSS receiver 140 is added to the perception system 1c according to the second modification of the first embodiment illustrated in FIG. 38.

In the perception system 1e illustrated in FIG. 40, a sensor unit 10c includes the IMU 100, the light detection and ranging sensor 110, and the synchronization signal generator 130, and also includes the GNSS receiver 140. Based on the GNSS signal received from the GNSS satellite, the GNSS receiver 140 acquires position information (referred to as GNSS absolute position) indicating the position of the GNSS receiver 140 on the earth. The GNSS receiver 140 outputs the acquired GNSS absolute position and a value (DOP value) indicating DOP of the received GNSS signal.

This example illustrates the GNSS receiver 140 as operating independently of the synchronization signal generated by the synchronization signal generator 130, but the operation is not limited to this example. For example, the GNSS receiver 140 may receive the GNSS signal in synchronization with the synchronization signal.

The position information and the DOP value output from the GNSS receiver 140 are passed to a SLAM processing unit 220a in a signal processing unit 20e. The SLAM processing unit 220a further includes a determination unit that performs determination based on the DOP value of the GNSS signal as compared to the configuration of the SLAM processing unit 5220 described with reference to FIG. 4, for example. In accordance with the determination result of the determination unit, the SLAM processing unit 220a may execute the SLAM processing by combining the position information passed from the GNSS receiver 140 with the stationary object velocity point cloud corrected by the stationary object point cloud correction unit 213.

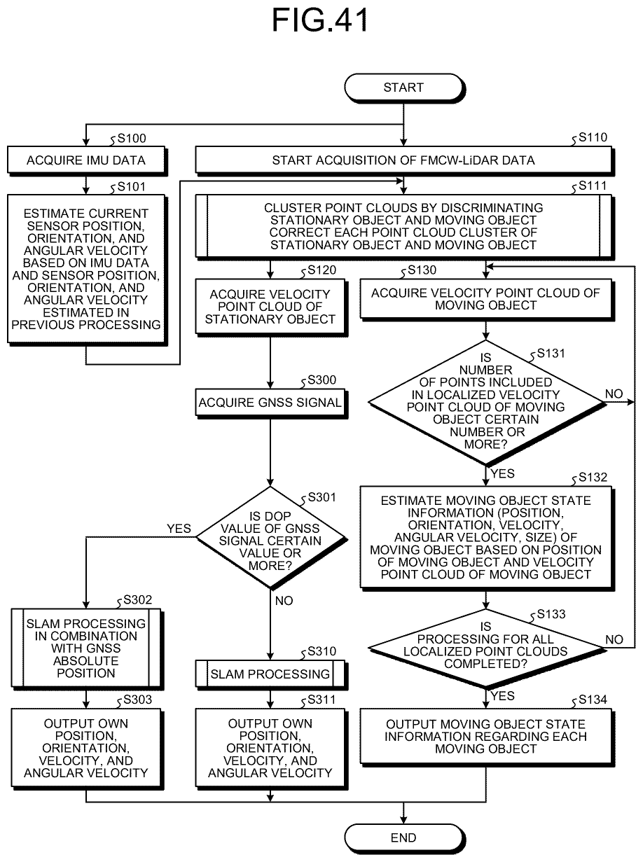

FIG. 41 is a flowchart of an example illustrating processing by the signal processing unit 20e according to the second embodiment. Here, description will be given focusing on processing of a portion (steps S300 to S311) different from the flowchart of FIG. 29 described above, and description of other processing will be omitted.

In step S120, when the stationary object velocity point cloud is acquired by the stationary object point cloud correction unit 213 in the signal processing unit 20e, the processing proceeds to step S300. In step S300, in the perception system 1e, a GNSS signal is received by the GNSS receiver 140, achieving acquisition of the GNSS signal. Based on the received GNSS signal, the GNSS receiver 140 calculates the GNSS absolute position and obtains the DOP value of the GNSS signal.

In the next step S301, the signal processing unit 20e uses the SLAM processing unit 220a to determine whether the DOP value of the GNSS signal obtained in step S300 is a certain value or more. When having determined that the DOP value of the GNSS signal is the certain value or more in step S301 (step S301, “Yes”), the signal processing unit 20e proceeds to the processing of step S302.

In step S302, the signal processing unit 20e uses the SLAM processing unit 220a to execute the SLAM processing by combining: the GNSS absolute position, the sensor position, orientation, and angular velocity passed from the sensor position/orientation estimation unit 210; the sensor velocity; and the stationary object velocity point cloud passed from the stationary object point cloud correction unit 213. For example, the SLAM processing unit 220a may correct the sensor position passed from the sensor position/orientation estimation unit 210 based on the GNSS absolute position. Furthermore, the SLAM processing unit 220a may correct the map information based on the GNSS absolute position.

In the next step S303, the signal processing unit 20e uses the transmission unit 201 to output its own position, orientation, velocity, and angular velocity acquired by the SLAM processing unit 220a in step S302.

In contrast, when having determined that the DOP value of the GNSS signal is less than the certain value in step S301 (step S301, “No”), the signal processing unit 20e proceeds to the processing of step S302.

In step S302, similarly to the processing in step S121 in the flowchart of FIG. 29, the signal processing unit 20e uses the SLAM processing unit 220a to execute the SLAM processing using the stationary object velocity point cloud acquired in step S120 and the sensor position, orientation, and angular velocity passed from the sensor position/orientation estimation unit 210 in step S101.

In the next step S311, the signal processing unit 20e uses the transmission unit 201 to output its own position, orientation, velocity, and angular velocity acquired by the SLAM processing unit 220a in step S310.

In this manner, in the second embodiment of the present disclosure, the self-position and the like are estimated using the GNSS absolute position in a case where the GNSS signal reception is good, and the self-position is estimated using the FMCW-LiDAR data and the IMU data in a case where it is difficult to receive the GNSS signal. Therefore, even in a state where it is difficult to receive the GNSS signal, the self-position and the like can be estimated with high precision.

### 4. Third Embodiment According to Present Disclosure

Next, a third embodiment according to the present disclosure will be described. The third embodiment according to the present disclosure is an example in which the SLAM processing is performed by applying Visual-SLAM that performs SLAM processing based on image data.

In a SLAM system that is mounted on a mobile body and simultaneously estimates self-position/orientation and a surrounding environment, Visual-SLAM using a camera image may be used. For example, under environmental conditions with few structures in the measurement range (desert or the like), there is a case where Visual-SLAM is more stable than LiDAR-SLAM using the measurement result of LiDAR.

Visual-SLAM extracts feature points from an image obtained by capturing an environment, and estimates a change in the self-position from an inter-frame correlation of a feature point cloud. At this time, it is assumed that the feature point is extracted from the surrounding stationary environment. Therefore, in the presence of a plurality of moving objects around and when a feature point is extracted from the moving object, the SLAM operation might become unstable.

The perception system using the FMCW-LiDAR according to the present disclosure can instantaneously distinguish between the moving object and the stationary object using the velocity point cloud information, making it possible to extract only a partial image corresponding to the static environment structure from the image acquired by the camera. Therefore, by performing feature point extraction processing on the image, a stable visual-SLAM operation can be implemented even in the presence of a plurality of moving objects in the surrounding environment.

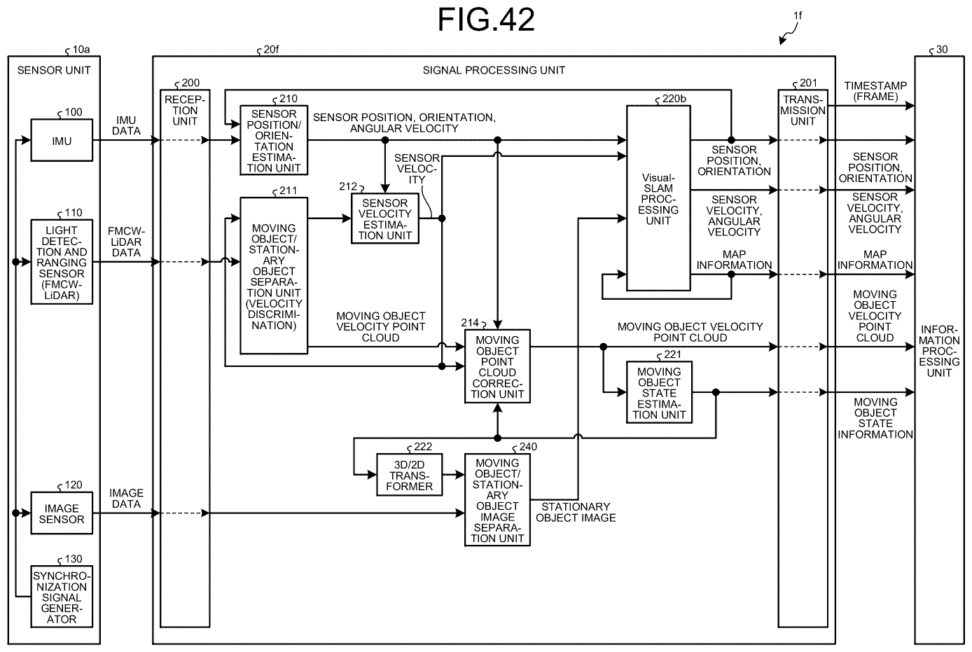

FIG. 42 is a block diagram illustrating a configuration of an example of a perception system according to the third embodiment. A perception system if illustrated in FIG. 42 has a configuration in which the ROI extraction unit 223 has been replaced with a moving object/stationary object image separation unit 240 and the image perception unit 226 has been omitted from the perception system 1a according to the first embodiment illustrated in FIG. 17.

In FIG. 42, the reception unit 200 passes the image data received from the image sensor 120 to the moving object/stationary object image separation unit 240. Using the moving object state information, the moving object/stationary object image separation unit 240 extracts a partial image of the stationary environment from the entire image based on the image data. More specifically, the moving object/stationary object image separation unit 240 extracts a region other than the moving object in the image data as a partial image of a stationary environment based on the 2D data obtained by transforming the moving object velocity point cloud into the 2D data by the 3D/2D transformer 222. The moving object/stationary object image separation unit 240 passes the extracted partial image of the stationary environment to a Visual-SLAM processing unit 220b as a stationary object image.

The Visual-SLAM processing unit 220b executes SLAM processing based on the sensor position, orientation, and angular velocity passed from the sensor position/orientation estimation unit 210 and the sensor velocity passed from the sensor velocity estimation unit 212. At the same time, the visual-SLAM processing unit 220b executes the visual-SLAM processing based on the still image passed from the moving object/stationary object image separation unit 240. For example, the Visual-SLAM processing unit 220b may acquire the current position of the sensor unit 10a or the like by extracting feature points from the stationary object image and comparing the extracted feature points with map information.

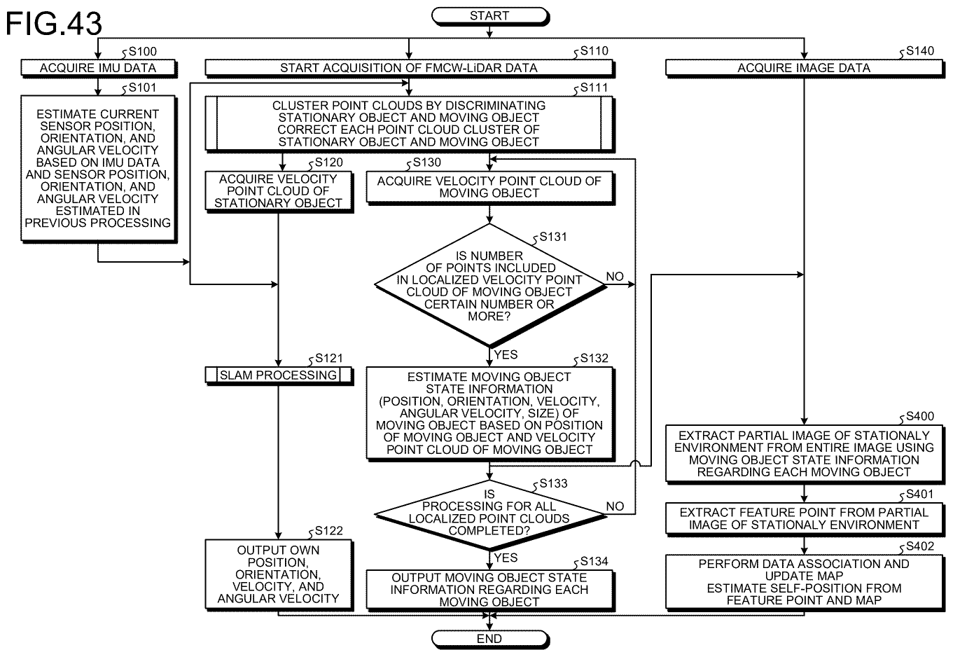

FIG. 43 is a flowchart of an example illustrating processing by the signal processing unit according to the third embodiment. In FIG. 43, since the processing using the IMU data and the processing using the FMCW-LiDAR data in steps S100 to S134 are similar to the processing in steps S100 to S134 of the flowchart of FIG. 29, the description thereof is omitted here.

In step S140, a signal processing unit 20f uses the reception unit 200 to acquire image data from the image sensor 120, and proceeds to the processing of step S400. Furthermore, the signal processing unit 20f transforms the moving object state information estimated by the moving object state estimation unit 221 in step S132 into 2D data by the 3D/2D transformer 222 and passes the 2D data to the processing in step S400.

In step S400, the signal processing unit 20f uses the moving object/stationary object image separation unit 240 to extract a partial image of the stationary environment from the entire image based on the image data by using operation state information of each moving object. The moving object/stationary object image separation unit 240 passes the extracted partial image to the Visual-SLAM processing unit 220b.

In the next step S401, the signal processing unit 20f uses the Visual-SLAM processing unit 220b to extract feature points from the partial image of the stationary environment passed from the moving object/stationary object image separation unit 240. In the next step S402, the Visual-SLAM processing unit 220b associates the feature point extracted in step S401 with the map information, and updates the map information. Furthermore, the Visual-SLAM processing unit 220b estimates the self-position based on the extracted feature points and the updated map information. The signal processing unit 20f uses the transmission unit 201 to output the self-position estimated by the Visual-SLAM processing unit 220b.

In this manner, the third embodiment performs the combined use of both the SLAM processing based on the FMCW-LiDAR data and the IMU data and the Visual-SLAM processing using the image data, making it possible to acquire the self-position and map information with higher precision even under environmental conditions with few structures.

In addition, the Visual-SLAM processing unit 220b according to the third embodiment extracts a partial image formed with a stationary object image using a moving object velocity point cloud that has been obtained by velocity discrimination from FMCW-LiDAR data for image data of one frame. Therefore, it is possible to execute the Visual-SLAM processing based on image data of one frame.

The effects described in the present specification are merely examples, and thus, there may be other effects, not limited to the exemplified effects.

Note that the present technology can also have the following configurations.
(1) A perception system comprising:
   a sensor unit including a first sensor and a second sensor, the first sensor configured to output velocity point cloud data including a plurality of points, each point having velocity information and time-point information, the second sensor configured to output inertial measurement data;
   a reception unit configured to receive the velocity point cloud data and the inertial measurement data output from the sensor unit; and
   an output unit configured to output sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.
(2) The perception system according to tha above (1), further comprising a map creation unit configured to update map information based on the velocity point cloud data and the inertial measurement data, wherein
   the output unit
   further outputs the map information.
(3) The perception system according to the above (2), wherein
   the output unit
   outputs the map information at an output rate lower than an output rate of the sensor state information and the moving object state information.
(4) The perception system according to the above (3), wherein
   the output unit
   outputs the sensor state information and the moving object state information at output rates corresponding to each other.
(5) The perception system according to any one of the above (2) to (4), wherein
   the map creation unit,
   when precision of an absolute position of the sensor unit acquired from a fourth sensor is a certain value or more, updates the map information using the velocity point cloud data, the inertial measurement data, and the absolute position.
(6) The perception system according to any one of the above (2) to (5), wherein
   the reception unit
   further receives image data output from a third sensor included in the sensor unit, and
   the map creation unit
   creates and updates the map information based on the image data and the sensor state information.
(7) The perception system according to the above (6), wherein
   the map creation unit
   updates the map information using image data of a partial image extracted from the image data based on the moving object state information.
(8) The perception system according to any one of the above (2) to (7), further comprising
   a correction unit configured to correct a stationary object velocity point cloud that is a velocity point cloud of a stationary object and included in the velocity point cloud data, based on an estimated value at a predetermined time-point given, as at least one predetermined time-point, for each frame of a detection operation performed by the first sensor, wherein
   the map creation unit
   updates the map information using the stationary object velocity point cloud corrected by the correction unit.
(9) The perception system according to the above (8), wherein
   the correction unit further
   corrects a moving object velocity point cloud that is a velocity point cloud of a moving object and included in the velocity point cloud data, based on the estimated value at the predetermined time-point, and
   the output unit
   outputs the moving object state information generated using the moving object velocity point cloud corrected by the correction unit.
(10) The perception system according to any one of the above (1) to (9), wherein
   the reception unit
   further receives image data output from a third sensor included in the sensor unit, and
   the output unit
   further outputs image meta-information obtained by image perception on an image of a region of interest extracted from the image data based on the moving object state information.
(11) The perception system according to any one of the above (1) to (10), wherein
   the output unit
   adds time-point information to the sensor state information and outputs the obtained information, the time-point information being information indicating a time-point at which each of the plurality of points is acquired on the first sensor.
(12) A perception method, being executed by a processor, the method comprising:
   receiving velocity point cloud data and inertial measurement data, the velocity point cloud data being data output from a first sensor included in a sensor unit and including a plurality of points, each point having velocity information and time-point information, the inertial measurement data being data output from a second sensor included in the sensor unit; and
   outputting sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.
(13) A perception apparatus comprising:
   a reception unit configured to receive velocity point cloud data and inertial measurement data, the velocity point cloud data being data output from a first sensor included in a sensor unit and including a plurality of points, each point having velocity information and time-point information, the inertial measurement data being data output from a second sensor included in the sensor unit; and
   an output unit configured to output sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.

### REFERENCE SIGNS LIST

1, 1a, 1b, 1c, 1d, 1e, if PERCEPTION SYSTEM
10, 10a, 10b, 10c SENSOR UNIT
20, 20a, 20b, 20c, 20d, 20e, 20f SIGNAL PROCESSING UNIT
30 INFORMATION PROCESSING UNIT
40 SCANNING LINE
41, 41a, 41b, 41ₛₜ EMISSION POINT
42₁, 42₂, 42_{N} SCANNING LINE
45 ANGULAR RANGE
46 SCANNING RANGE
50a, 50b, 52 OBJECT
60a, 60b, 60c FRAME
61 PIXEL
100 IMU
110 LIGHT DETECTION AND RANGING SENSOR
111 OPTICAL SCAN UNIT
112 LIGHT TRANSMISSION/RECEPTION UNIT
113 RECEPTION SIGNAL PROCESSING UNIT
114 OPTICAL SCAN CONTROLLER
115, 201, 5201 TRANSMISSION UNIT
120 IMAGE SENSOR
130 SYNCHRONIZATION SIGNAL GENERATOR
140 GNSS RECEIVER
200 RECEPTION UNIT
210 SENSOR POSITION/ORIENTATION ESTIMATION UNIT
211 MOVING OBJECT/STATIONARY OBJECT SEPARATION UNIT
212 SENSOR VELOCITY ESTIMATION UNIT
213 STATIONARY OBJECT POINT CLOUD CORRECTION UNIT
214 MOVING OBJECT POINT CLOUD CORRECTION UNIT
220, 220a, 5220 SLAM PROCESSING UNIT
220b Visual-SLAM PROCESSING UNIT
221 MOVING OBJECT STATE ESTIMATION UNIT
222 3D/2D TRANSFORMER
223 ROI EXTRACTION UNIT
224 COMBINING UNIT
225 MOTION PERCEPTION UNIT
226 IMAGE PERCEPTION UNIT
230 CONTROL COMMUNICATION UNIT
231 SCAN CONTROLLER
232 PARAMETER SETTING UNIT
240 MOVING OBJECT/STATIONARY OBJECT IMAGE SEPARATION UNIT
400 SENSOR POSITION/ORIENTATION ESTIMATION PROCESSING
401 STATIONARY OBJECT/MOVING OBJECT DISCRIMINATION PROCESSING
402 SENSOR VELOCITY ESTIMATION PROCESSING
403, 404 POINT CLOUD CORRECTION PROCESSING
405 MOVING OBJECT DETECTION PROCESSING
1000 SENSOR GROUP
1010 FIRMWARE
2000, 3000 PROCESSOR
2010, 3010 LIBRARY SECTION
2020, 3020 APPLICATION SECTION
2030 OS
2040 API CALLING UNIT
2041 API PROCESSING UNIT

1. A perception system comprising:
a sensor unit including a first sensor and a second sensor, the first sensor configured to output velocity point cloud data including a plurality of points, each point having velocity information and time-point information, the second sensor configured to output inertial measurement data;
a reception unit configured to receive the velocity point cloud data and the inertial measurement data output from the sensor unit; and
an output unit configured to output sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.

2. The perception system according to claim 1, further comprising a map creation unit configured to update map information based on the velocity point cloud data and the inertial measurement data, wherein
the output unit
further outputs the map information.

3. The perception system according to claim 2, wherein
the output unit
outputs the map information at an output rate lower than an output rate of the sensor state information and the moving object state information.

4. The perception system according to claim 3, wherein
the output unit
outputs the sensor state information and the moving object state information at output rates corresponding to each other.

5. The perception system according to claim 2, wherein
the map creation unit,
when precision of an absolute position of the sensor unit acquired from a fourth sensor is a certain value or more, updates the map information using the velocity point cloud data, the inertial measurement data, and the absolute position.

6. The perception system according to claim 2, wherein
the reception unit
further receives image data output from a third sensor included in the sensor unit, and
the map creation unit
creates and updates the map information based on the image data and the sensor state information.

7. The perception system according to claim 6, wherein
the map creation unit
updates the map information using image data of a partial image extracted from the image data based on the moving object state information.

8. The perception system according to claim 2, further comprising
a correction unit configured to correct a stationary object velocity point cloud that is a velocity point cloud of a stationary object and included in the velocity point cloud data, based on an estimated value at a predetermined time-point given, as at least one predetermined time-point, for each frame of a detection operation performed by the first sensor, wherein
the map creation unit
updates the map information using the stationary object velocity point cloud corrected by the correction unit.

9. The perception system according to claim 8, wherein
the correction unit further
corrects a moving object velocity point cloud that is a velocity point cloud of a moving object and included in the velocity point cloud data, based on the estimated value at the predetermined time-point, and
the output unit
outputs the moving object state information generated using the moving object velocity point cloud corrected by the correction unit.

10. The perception system according to claim 1, wherein
the reception unit
further receives image data output from a third sensor included in the sensor unit, and
the output unit
further outputs image meta-information obtained by image perception on an image of a region of interest extracted from the image data based on the moving object state information.

11. The perception system according to claim 1, wherein
the output unit
adds time-point information to the sensor state information and outputs the obtained information, the time-point information being information indicating a time-point at which each of the plurality of points is acquired on the first sensor.

12. A perception method, being executed by a processor, the method comprising:
receiving velocity point cloud data and inertial measurement data, the velocity point cloud data being data output from a first sensor included in a sensor unit and including a plurality of points, each point having velocity information and time-point information, the inertial measurement data being data output from a second sensor included in the sensor unit; and
outputting sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.

13. A perception apparatus comprising:
a reception unit configured to receive velocity point cloud data and inertial measurement data, the velocity point cloud data being data output from a first sensor included in a sensor unit and including a plurality of points, each point having velocity information and time-point information, the inertial measurement data being data output from a second sensor included in the sensor unit; and
an output unit configured to output sensor state information and moving object state information, the sensor state information including information indicating a position and orientation of the sensor unit, the moving object state information including information indicating a position, orientation, and velocity of a moving object, the sensor state information and the moving object state information being information generated based on the velocity point cloud data and the inertial measurement data.
